(19) United States
(12) Patent Application Publication
(10) Pub. No.: US 2012/0197540 A1
(43) Pub. Date: Aug. 2, 2012

(54) MARKERS TO PREDICT SURVIVAL OF BREAST CANCER PATIENTS AND USES THEREOF

(75) Inventors: Maria Patrizia SOMMA, Roma (IT); Maurizio GATTI, Monte Porzio Catone (IT); Paolo PROVERO, Cinzano (IT); Ferdinando DI CUNTO, Torino (IT); Christian DAMASCO, Bra (IT); Antonio LEMBO, Savigliano (IT)

(73) Assignee: CONSIGLIO NAZIONALE DELLE RICERCHE, Roma (IT)

(21) Appl. No.: 13/363,578

(22) Filed: Feb. 1, 2012

(30) Foreign Application Priority Data
Feb. 1, 2011 (IT) RM2011A000044

(51) Int. Cl. G06F 19/20; C40B 40/06

(52) U.S. Cl. 702/20; 506/16

(57) ABSTRACT

The present invention relates to a method to predict the mortality risk of a subject (p) affected of breast cancer comprising measuring the expression level of 105 specific genes in a biological sample, obtaining the prognostic score, S(p), that indicates the expression levels of said genes in said subject (p) affected of cancer, and predicting the mortality risk of said subject (p) affected of cancer.

### CROSS-REFERENCE TO RELATED APPLICATION

The present application claims priority of Italian Patent Application No. RM2011A000044, filed Feb. 1, 2011, the contents of which are incorporated herein by reference.

### FIELD OF INVENTION

The present invention relates to the construction of a gene expression signature that is highly predictive of survival in breast cancer.

### BACKGROUND ART

A reliable prediction of the outcome of a breast cancer is extremely valuable information for deciding a therapeutic strategy. The analysis of gene expression profiles obtained with microarrays has allowed identification of gene sets, or genetic “signatures”, that are strongly predictive of poor prognosis (see [1,2] for a recent survey). In the past few years, two types of cancer signatures have been developed commonly designated as “bottom-up” or “top-down”. In top-down (or supervised) signatures, the risk-predicting genes are selected by correlating the tumor's gene expression profiles with the patients' clinical outcome. One of the most powerful top-down signatures is the so-called 70-gene signature, which includes genes regulating cell cycle, invasion, metastasis and angiogenesis [3]. This signature outperforms standard clinical and histological criteria in predicting the likelihood of distant metastases within five years [4]. Although highly predictive of cancer outcome, top-down signatures have the drawback of including different gene types, thereby preventing precise definition of the biological processes altered in the tumor.

Bottom-up (or unsupervised) signatures are developed using sets of genes thought to be involved in specific cancer-related processes and do not rely on patients' gene expression data. Examples of these signatures are the “Wound signature” that includes genes expressed in fibroblasts after serum addition with a pattern reminiscent of the wound healing process [5,6], the “Hypoxia signatures” that contains genes involved in the transcriptional response to hypoxia [7-9], and the “Proliferation signatures” that include genes expressed in actively proliferating cells [10,11]. Other bottom-up signatures are the “ES signature” [12], the proliferation, immune response and RNA splicing modules signature [13] (henceforth abbreviated as “Module signature”) the “invasiveness gene signature” (IGS) [14] and the chromosomal instability signature (CIN) [15]. The “ES signature” is based on the assumption that cells with tumor-initiating capability derive from normal stem cells. This signature reflects the gene expression pattern of embryonic stem cells (ES) and includes genes that are preferentially expressed or repressed in this type of cells [12]. The “Module signature” was generated by selecting gene sets that were enriched in nine pre-existing signatures, and consists of gene modules involved in 11 different processes including the immune response, cell proliferation, RNA splicing, focal adhesion, and apoptosis [13]. The IGS signature includes genes that are differentially expressed in tumorigenic breast cancer cells compared to normal breast-epithelium cells; the 186 genes of this signature are involved in a large variety of cellular functions and processes [14]. The CIN signature has features of both top-down and bottom-up signatures; it was developed by selecting genes with variations in the expression level correlated with the overall chromosomal aneuploidy of tumor samples [15].

Tumors are characterized by frequent mitotic divisions and chromosome instability. The authors thus reasoned that genes required for mitotic cell division and genes involved in the maintenance of chromosome integrity could be used to develop a new cancer signature.

In a recent RNAi-based screen performed in Drosophila S2 cells [16], the authors of the instant invention identified 44 genes required to prevent spontaneous chromosome breakage and 98 genes that control mitotic division. Thus, considering the strong phylogenetic conservation of the mitotic process, rather than relying on functional annotation databases, the authors used the 142 Drosophila genes identified in the screen [16] to develop a new bottom-up signature that includes genes involved in cell division but not yet annotated in the literature. 108 of these 142 Drosophila genes have unambiguous human orthologs [17]. Here the authors show that these 108 human genes constitute an excellent signature to predict breast cancer outcome. This Drosophila mitotic signature, or “DM signature”, has minimal overlap with pre-existing gene signatures and outperforms them in predictive power.

### DESCRIPTION OF THE INVENTION

The classification of patients with breast cancer into risk groups represents a very valuable tool for the identification of subjects who would benefit from an aggressive systemic therapy. The analysis of microarray's data allowed to generate many signatures of gene expression improving the diagnosis and allowing the risk assessment. There is also evidence that specific genes of a proliferative state would have an high predictive value within these signatures.

Thus, the authors thus constructed a gene expression signature (the DM signature) using the human orthologues of 108 Drosophila melanogaster genes required for either the maintenance of chromosome integrity (36 genes) or mitotic division (72 genes). The DM signature has minimal overlap with the extant signatures and is highly predictive of survival in 5 large breast cancer datasets. In addition, the authors show that the DM signature outperforms other widely used cancer signatures in predictive power, and performs comparably to other proliferation-based signatures. For most genes of the DM signature, an increased expression is negatively correlated with patient survival. The genes that provide the highest contribution to the predictive power of the DM signature are those involved in cytokinesis. This finding highlights cytokinesis as an important marker in breast cancer prognosis and as a possible target for antimitotic therapies.
It is therefore, an object of the invention a method to predict the mortality risk of a subject (p) affected of breast cancer comprising:
a) measuring the expression level of the genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT in a biological sample, obtaining the prognostic score, S(p), that indicates the expression levels of said genes in said subject (p) affected of cancer, and b) predicting the mortality risk of said subject (p) affected of cancer comparing said prognostic score, S(p), to a cut off value (cut off threshold).
Preferably the expression level of said genes is measured by means of quantitative detection of the transcript sequences selected from the group SEQ ID No 1 to SEQ ID No. 217.
Still preferably the expression level of said genes is detected by means of microarray.
In a preferred embodiment the biological sample is selected from the group of: blood, tumour cell, frozen or fixed tissue sections, biopsy, biological fluid.
In a still preferred embodiment the mortality risk is assigned as follows:
i) to the class “low risk” if the prognostic score, S(p), is lower than the cut off threshold, or
ii) to the class “high risk” if the prognostic score, S(p), is greater than the cut off threshold, and optionally
iii) to the class “intermediate” if the prognostic score, S(p), is between two cut off threshold values.
   Still preferably the prognostic score, S(p), is calculated according to the following formula:

S(p)=Σ_{g}x(g,p)z(g)

wherein
x(g,p) is the expression level expressed in logarithmic base 2 of the probeset g in the patient p;
z(g) is the z-score of the probeset g calculated in the Pawitan dataset;
wherein the probeset g comprises a group of 217 probes, each one being specific and selective for one of the gene transcript belonging to the group of SEQ ID No. 1 to SEQ ID No. 217.
Yet preferably the z-score for each probe is the one calculated in the Pawitan database reported in table II.
It is a further object of the invention a kit to detect the transcript expression level of genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT, comprising:
for each of said genes, sequence specific amplification means to obtain amplified nucleic acids having sequences comprised in the transcribed region thereof;
quantitative detection means of said amplified nucleic acids;
appropriate reagents.
   Preferably said amplified nucleic acids consist of:
   for C15orf44, SEQ ID No. 145; for CASP7, SEQ ID No. 189; for CNOT3, SEQ ID No. 66 and/or SEQ ID No. 138 and/or SEQ ID No. 167; for CTPS, SEQ ID No. 39; for CUL4B, SEQ ID No. 113 and/or SEQ ID No. 152 and/or SEQ ID No. 165 and/or SEQ ID No. 212; for CWC15, SEQ ID No. 159; for DCAKD, SEQ ID No. 126 and/or SEQ ID No. 140 and/or SEQ ID No. 190; for DDB1, SEQ ID No. 38; for FRG1, SEQ ID No. 195; for MSH6, SEQ ID No. 46 and/or SEQ ID No. 61 and/or SEQ ID No. 153 and/or SEQ ID No. 187; for ORC5L, SEQ ID No. 70 and/or SEQ ID No. 79 and/or SEQ ID No. 109; for PCNA, SEQ ID No. 51; for PIAS1, SEQ ID No. 211 and/or SEQ ID No. 216 and/or SEQ ID No. 217; for POLA1, SEQ ID No. 147; for PRIM2, SEQ ID No. 43 and/or SEQ ID No. 56 and/or SEQ ID No. 88; for PRPF3, SEQ ID No. 170; for RAD54L, SEQ ID No. 75; for RFC2, SEQ ID No. 42 and/or SEQ ID No. 48; for RPA1, SEQ ID No. 64 and/or SEQ ID No. 103; for RRM2, SEQ ID No. 3 and/or SEQ ID No. 9; for SART1, SEQ ID No. 124; for SF3A3, SEQ ID No. 201; for SMC1A, SEQ ID No. 115 and/or SEQ ID No. 179 and/or SEQ ID No. 207; for TAF6, SEQ ID No. 68; for TFDP2, SEQ ID No. 86 and/or SEQ ID No. 118 and/or SEQ ID No. 210; for TK2, SEQ ID No. 37 and/or SEQ ID No. 156 and/or SEQ ID No. 171 and/or SEQ ID No. 172; for TPR, SEQ ID No. 99 and/or SEQ ID No. 108 and/or SEQ ID No. 182 and/or SEQ ID No. 204; for TYMS, SEQ ID No. 32 and/or SEQ ID No. 125; for WBP11, SEQ ID No. 65 and/or SEQ ID No. 67; for WDR46, SEQ ID No. 93; for WDR75, SEQ ID No. 158; for XAB2, SEQ ID No. 180; for XRN2, SEQ ID No. 81 and/or SEQ ID No. 84; for ZMYM4, SEQ ID No. 192 and/or SEQ ID No. 196 and/or SEQ ID No. 213; for MCM3, SEQ ID No. 34; for MCM7, SEQ ID No. 28 and/or SEQ ID No. 52; for SMC3, SEQ ID No. 185 and/or SEQ ID No. 193 and/or SEQ ID No. 209; for NCAPD2, SEQ ID No. 106; for NCAPG, SEQ ID No. 22 and/or SEQ ID No. 24; for SMC4, SEQ ID No. 33 and/or SEQ ID No. 54 and/or SEQ ID No. 141; for SMC2, SEQ ID No. 45 and/or SEQ ID No. 127; for MASTL, SEQ ID No. 11; for ORC2L, SEQ ID No. 104; for TOP2A, SEQ ID No. 20 and/or SEQ ID No. 62 and/or SEQ ID No. 96; for CDT1, SEQ ID No. 2 and/or SEQ ID No. 36; for BUB3, SEQ ID No. 57 and/or SEQ ID No. 139 and/or SEQ ID No. 148 and/or SEQ ID No. 174 and/or SEQ ID No. 178; for KNTC1, SEQ ID No. 35; for ZW10, SEQ ID No. 143; for ASCC3L1, SEQ ID No. 55 and/or SEQ ID No. 135 and/or SEQ ID No. 150; for CCNB1, SEQ ID No. 7 and/or SEQ ID No. 14; for CDC40, SEQ ID No. 100 and/or SEQ ID No. 177; for DHX8, SEQ ID No. 58 and/or SEQ ID No. 120 and/or SEQ ID No. 121; for KIAA1310, SEQ ID No. 160 and/or SEQ ID No. 183 and/or SEQ ID No. 188; for LSM2, SEQ ID No. 137; for PRPF31, SEQ ID No. 60 and/or SEQ ID No. 91 and/or SEQ ID No. 184; for SF3A1, SEQ ID No. 98 and/or SEQ ID No. 119 and/or SEQ ID No. 162 and/or SEQ ID No. 173; for SF3A2, SEQ ID No. 169 and/or SEQ ID No. 176; for SF3B1, SEQ ID No. 194 and/or SEQ ID No. 203 and/or SEQ ID No. 208 and/or SEQ ID No. 214; for SF3B2, SEQ ID No. 77; for SF3B14, SEQ ID No. 10; for SLU7, SEQ ID No. 149 and/or SEQ ID No. 151; for SNRPA1, SEQ ID No. 23 and/or SEQ ID No. 49 and/or SEQ ID No. 71 and/or SEQ ID No. 181; for SNRPE, SEQ ID No. 72 and/or SEQ ID No. 136; for TXNL4A, SEQ ID No. 26 and/or SEQ ID No. 134; for U2AF1, SEQ ID No. 30 and/or SEQ ID No. 82 and/or SEQ ID No. 102 and/or SEQ ID No. 131; for U2AF2, SEQ ID No. 94 and/or SEQ ID No. 146 and/or SEQ ID No. 155 and/or SEQ ID No. 161; for ANAPC5, SEQ ID No. 85 and/or SEQ ID No. 95 and/or SEQ ID No. 97 and/or SEQ ID No. 112 and/or SEQ ID No. 117; for ANAPC10, SEQ ID No. 129; for CDC20, SEQ ID No. 17; for KIN, SEQ ID No. 111 and/or SEQ ID No. 144; for PSMC1, SEQ ID No. 25; for SFRS15, SEQ ID No. 50 and/or SEQ ID No. 63 and/or SEQ ID No. 80 and/or SEQ ID No. 142 and/or SEQ ID No. 197; for CKAP5, SEQ ID No. 21; for EIF3A, SEQ ID No. 175 and/or SEQ ID No. 186 and/or SEQ ID No. 202; for EIF3D, SEQ ID No. 101; for EIF3E, SEQ ID No. 154; for EIF3I, SEQ ID No. 114; for GTF3C3, SEQ ID No. 74 and/or SEQ ID No. 163; for MAPRE3, SEQ ID No. 116 and/or SEQ ID No. 128 and/or SEQ ID No. 130 and/or SEQ ID No. 133; for NOC3L, SEQ ID No. 164; for RRP1B, SEQ ID No. 105 and/or SEQ ID No. 123; for TBK1, SEQ ID No. 198; for THOC2, SEQ ID No. 110 and/or SEQ ID No. 132 and/or SEQ ID No. 199 and/or SEQ ID No. 205; for TUBB2C, SEQ ID No. 4 and/or SEQ ID No. 5; for WDR82, SEQ ID No. 191; for TRRAP, SEQ ID No. 69 and/or SEQ ID No. 73; for TUBGCP4, SEQ ID No. 76 and/or SEQ ID No. 215; for TUBG2, SEQ ID No. 157; for ASPM, SEQ ID No. 6 and/or SEQ ID No. 47 and/or SEQ ID No. 53; for CENPJ, SEQ ID No. 87 and/or SEQ ID No. 92 and/or SEQ ID No. 107; for MKI671P, SEQ ID No. 41 and/or SEQ ID No. 89 and/or SEQ ID No. 200; for PPP1R8, SEQ ID No. 168; for CDC2, SEQ ID No. 15 and/or SEQ ID No. 16 and/or SEQ ID No. 31 and/or SEQ ID No. 206; for KIFC1, SEQ ID No. 19; for KIF11, SEQ ID No. 29; for KIF18A, SEQ ID No. 18; for AURKC, SEQ ID No. 90; for RBBP7, SEQ ID No. 166; for PLK1, SEQ ID No. 27; for ECT2, SEQ ID No. 40 and/or SEQ ID No. 59 and/or SEQ ID No. 83; for KIF23, SEQ ID No. 8 and/or SEQ ID No. 44; for PRC1, SEQ ID No. 13; for RACGAP1, SEQ ID No. 12; for ANLN, SEQ ID No. 1; for CIT, SEQ ID No. 78 and/or SEQ ID No. 122.
   Still preferably, the kit further comprises sequence specific amplification means to obtain amplified nucleic acids having sequences comprised in the transcribed region of genes H3F3A and/or PPAN-P2RY11 and/or KIF4.
   It is a further object of the invention a microarray consisting of:
   a) solid supporting means, and
   b) for each of the genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT, at least one oligonucleotide able to specifically hybridize to a sequence comprised in the transcribed region thereof.
   Preferably wherein the sequences comprised in the transcribed region of said genes consist of: for C15orf44, SEQ ID No. 145; for CASP7, SEQ ID No. 189; for CNOT3, SEQ ID No. 66 and/or SEQ ID No. 138 and/or SEQ ID No. 167; for CTPS, SEQ ID No. 39; for CUL4B, SEQ ID No. 113 and/or SEQ ID No. 152 and/or SEQ ID No. 165 and/or SEQ ID No. 212; for CWC15, SEQ ID No. 159; for DCAKD, SEQ ID No. 126 and/or SEQ ID No. 140 and/or SEQ ID No. 190; for DDB1, SEQ ID No. 38; for FRG1, SEQ ID No. 195; for MSH6, SEQ ID No. 46 and/or SEQ ID No. 61 and/or SEQ ID No. 153 and/or SEQ ID No. 187; for ORC5L, SEQ ID No. 70 and/or SEQ ID No. 79 and/or SEQ ID No. 109; for PCNA, SEQ ID No. 51; for PIAS1, SEQ ID No. 211 and/or SEQ ID No. 216 and/or SEQ ID No. 217; for POLA1, SEQ ID No. 147; for PRIM2, SEQ ID No. 43 and/or SEQ ID No. 56 and/or SEQ ID No. 88; for PRPF3, SEQ ID No. 170; for RAD54L, SEQ ID No. 75; for RFC2, SEQ ID No. 42 and/or SEQ ID No. 48; for RPA1, SEQ ID No. 64 and/or SEQ ID No. 103; for RRM2, SEQ ID No. 3 and/or SEQ ID No. 9; for SART1, SEQ ID No. 124; for SF3A3, SEQ ID No. 201; for SMC1A, SEQ ID No. 115 and/or SEQ ID No. 179 and/or SEQ ID No. 207; for TAF6, SEQ ID No. 68; for TFDP2, SEQ ID No. 86 and/or SEQ ID No. 118 and/or SEQ ID No. 210; for TK2, SEQ ID No. 37 and/or SEQ ID No. 156 and/or SEQ ID No. 171 and/or SEQ ID No. 172; for TPR, SEQ ID No. 99 and/or SEQ ID No. 108 and/or SEQ ID No. 182 and/or SEQ ID No. 204; for TYMS, SEQ ID No. 32 and/or SEQ ID No. 125; for WBP11, SEQ ID No. 65 and/or SEQ ID No. 67; for WDR46, SEQ ID No. 93; for WDR75, SEQ ID No. 158; for XAB2, SEQ ID No. 180; for XRN2, SEQ ID No. 81 and/or SEQ ID No. 84; for ZMYM4, SEQ ID No. 192 and/or SEQ ID No. 196 and/or SEQ ID No. 213; for MCM3, SEQ ID No. 34; for MCM7, SEQ ID No. 28 and/or SEQ ID No. 52; for SMC3, SEQ ID No. 185 and/or SEQ ID No. 193 and/or SEQ ID No. 209; for NCAPD2, SEQ ID No. 106; for NCAPG, SEQ ID No. 22 and/or SEQ ID No. 24; for SMC4, SEQ ID No. 33 and/or SEQ ID No. 54 and/or SEQ ID No. 141; for SMC2, SEQ ID No. 45 and/or SEQ ID No. 127; for MASTL, SEQ ID No. 11; for ORC2L, SEQ ID No. 104; for TOP2A, SEQ ID No. 20 and/or SEQ ID No. 62 and/or SEQ ID No. 96; for CDT1, SEQ ID No. 2 and/or SEQ ID No. 36; for BUB3, SEQ ID No. 57 and/or SEQ ID No. 139 and/or SEQ ID No. 148 and/or SEQ ID No. 174 and/or SEQ ID No. 178; for KNTC1, SEQ ID No. 35; for ZW10, SEQ ID No. 143; for ASCC3L1, SEQ ID No. 55 and/or SEQ ID No. 135 and/or SEQ ID No. 150; for CCNB1, SEQ ID No. 7 and/or SEQ ID No. 14; for CDC40, SEQ ID No. 100 and/or SEQ ID No. 177; for DHX8, SEQ ID No. 58 and/or SEQ ID No. 120 and/or SEQ ID No. 121; for KIAA1310, SEQ ID No. 160 and/or SEQ ID No. 183 and/or SEQ ID No. 188; for LSM2, SEQ ID No. 137; for PRPF31, SEQ ID No. 60 and/or SEQ ID No. 91 and/or SEQ ID No. 184; for SF3A1, SEQ ID No. 98 and/or SEQ ID No. 119 and/or SEQ ID No. 162 and/or SEQ ID No. 173; for SF3A2, SEQ ID No. 169 and/or SEQ ID No. 176; for SF3B1, SEQ ID No. 194 and/or SEQ ID No. 203 and/or SEQ ID No. 208 and/or SEQ ID No. 214; for SF3B2, SEQ ID No. 77; for SF3B14, SEQ ID No. 10; for SLU7, SEQ ID No. 149 and/or SEQ ID No. 151; for SNRPA1, SEQ ID No. 23 and/or SEQ ID No. 49 and/or SEQ ID No. 71 and/or SEQ ID No. 181; for SNRPE, SEQ ID No. 72 and/or SEQ ID No. 136; for TXNL4A, SEQ ID No. 26 and/or SEQ ID No. 134; for U2AF1, SEQ ID No. 30 and/or SEQ ID No. 82 and/or SEQ ID No. 102 and/or SEQ ID No. 131; for U2AF2, SEQ ID No. 94 and/or SEQ ID No. 146 and/or SEQ ID No. 155 and/or SEQ ID No. 161; for ANAPC5, SEQ ID No. 85 and/or SEQ ID No. 95 and/or SEQ ID No. 97 and/or SEQ ID No. 112 and/or SEQ ID No. 117; for ANAPC10, SEQ ID No. 129; for CDC20, SEQ ID No. 17; for KIN, SEQ ID No. 111 and/or SEQ ID No. 144; for PSMC1, SEQ ID No. 25; for SFRS15, SEQ ID No. 50 and/or SEQ ID No. 63 and/or SEQ ID No. 80 and/or SEQ ID No. 142 and/or SEQ ID No. 197; for CKAP5, SEQ ID No. 21; for EIF3A, SEQ ID No. 175 and/or SEQ ID No. 186 and/or SEQ ID No. 202; for EIF3D, SEQ ID No. 101; for EIF3E, SEQ ID No. 154; for EIF3I, SEQ ID No. 114; for GTF3C3, SEQ ID No. 74 and/or SEQ ID No. 163; for MAPRE3, SEQ ID No. 116 and/or SEQ ID No. 128 and/or SEQ ID No. 130 and/or SEQ ID No. 133; for NOC3L, SEQ ID No. 164; for RRP1B, SEQ ID No. 105 and/or SEQ ID No. 123; for TBK1, SEQ ID No. 198; for THOC2, SEQ ID No. 110 and/or SEQ ID No. 132 and/or SEQ ID No. 199 and/or SEQ ID No. 205; for TUBB2C, SEQ ID No. 4 and/or SEQ ID No. 5; for WDR82, SEQ ID No. 191; for TRRAP, SEQ ID No. 69 and/or SEQ ID No. 73; for TUBGCP4, SEQ ID No. 76 and/or SEQ ID No. 215; for TUBG2, SEQ ID No. 157; for ASPM, SEQ ID No. 6 and/or SEQ ID No. 47 and/or SEQ ID No. 53; for CENPJ, SEQ ID No. 87 and/or SEQ ID No. 92 and/or SEQ ID No. 107; for MKI671P, SEQ ID No. 41 and/or SEQ ID No. 89 and/or SEQ ID No. 200; for PPP1R8, SEQ ID No. 168; for CDC2, SEQ ID No. 15 and/or SEQ ID No. 16 and/or SEQ ID No. 31 and/or SEQ ID No. 206; for KIFC1, SEQ ID No. 19; for KIF11, SEQ ID No. 29; for KIF18A, SEQ ID No. 18; for AURKC, SEQ ID No. 90; for RBBP7, SEQ ID No. 166; for PLK1, SEQ ID No. 27; for ECT2, SEQ ID No. 40 and/or SEQ ID No. 59 and/or SEQ ID No. 83; for KIF23, SEQ ID No. 8 and/or SEQ ID No. 44; for PRC1, SEQ ID No. 13; for RACGAP1, SEQ ID No. 12; for ANLN, SEQ ID No. 1; for CIT, SEQ ID No. 78 and/or SEQ ID No. 122.
   Preferably the microarray further comprises at least one oligonucleotide able to specifically hybridize to a sequence comprised in the transcribed region of genes H3F3A and/or PPAN-P2RY11 and/or KIF4.
   In the present invention the method to predict the mortality risk of a subject affected of breast cancer is also a method to predict the survival of a subject affected of breast cancer.
   Further the genes of the DM signature could be merged with those of other signatures to further improve risk stratification.
   In the present invention, 3 cutoff values are provided, corresponding to 90%, 70% and 50% sensitivity on Miller dataset.
   The cut off threshold on the prognostic score were calculated on the Miller dataset (a dataset independent from that used to develop the signature, but built on a consecutive series of patients and therefore representative of the population), and corresponds, on this dataset, to 90%, 70% and 50% sensitivity. Sensitivity is defined as the fraction of high-risk patients correctly identified by the predictor. For each cut off, the specificity is reported. The specificity was calculated on the Miller dataset and is defined as the fraction of low-risk patients correctly identified by the predictor. The cut off of 90% sensitivity=798 (32% specificity), the cut off of 70% sensitivity=921.8 (57% specificity) and the cut off of 50% sensitivity=928.5 (73% specificity). These values are non-limitative example and may vary.

The present invention is illustrated by the following non limiting examples and figures.

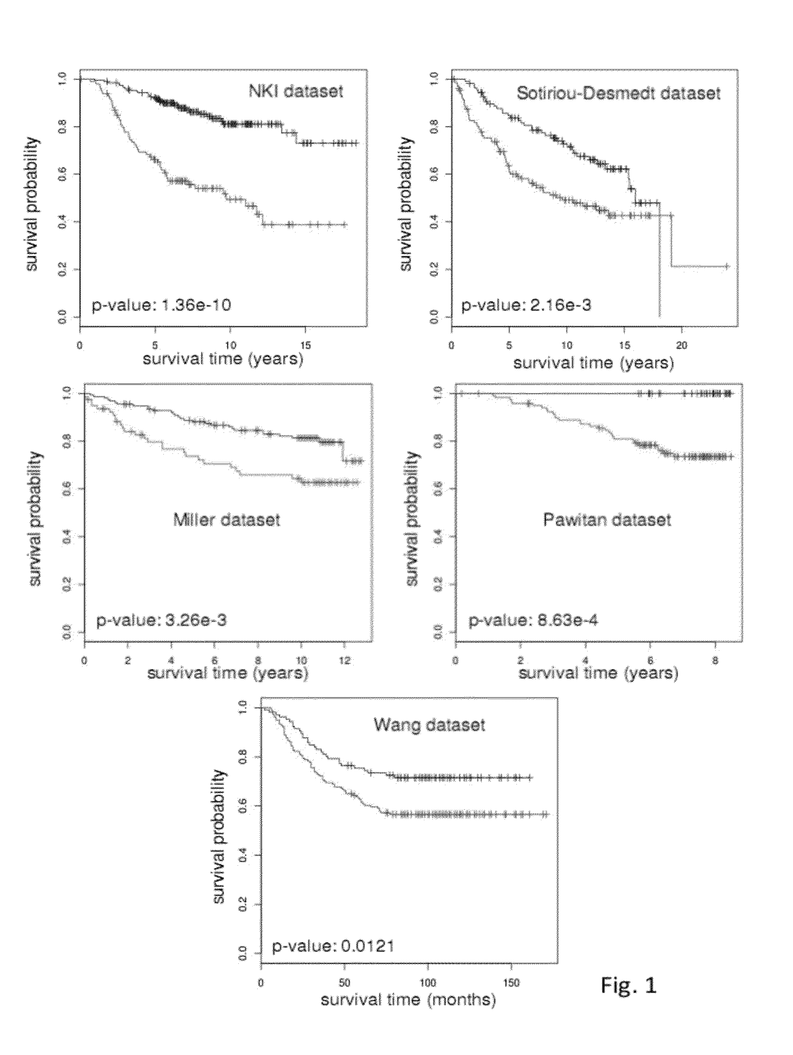

FIG. 1—Predictive power of the DM signature. Kaplan-Meier analysis using the DM signature shows significant differences in survival of patients from five independents breast cancer datasets. The curves represent the cumulative chances of survival of patients classified within two groups by the hierarchic clustering algorithm based on the correlation coefficient: lower curve—high risk patients; top curve—low risk patients.

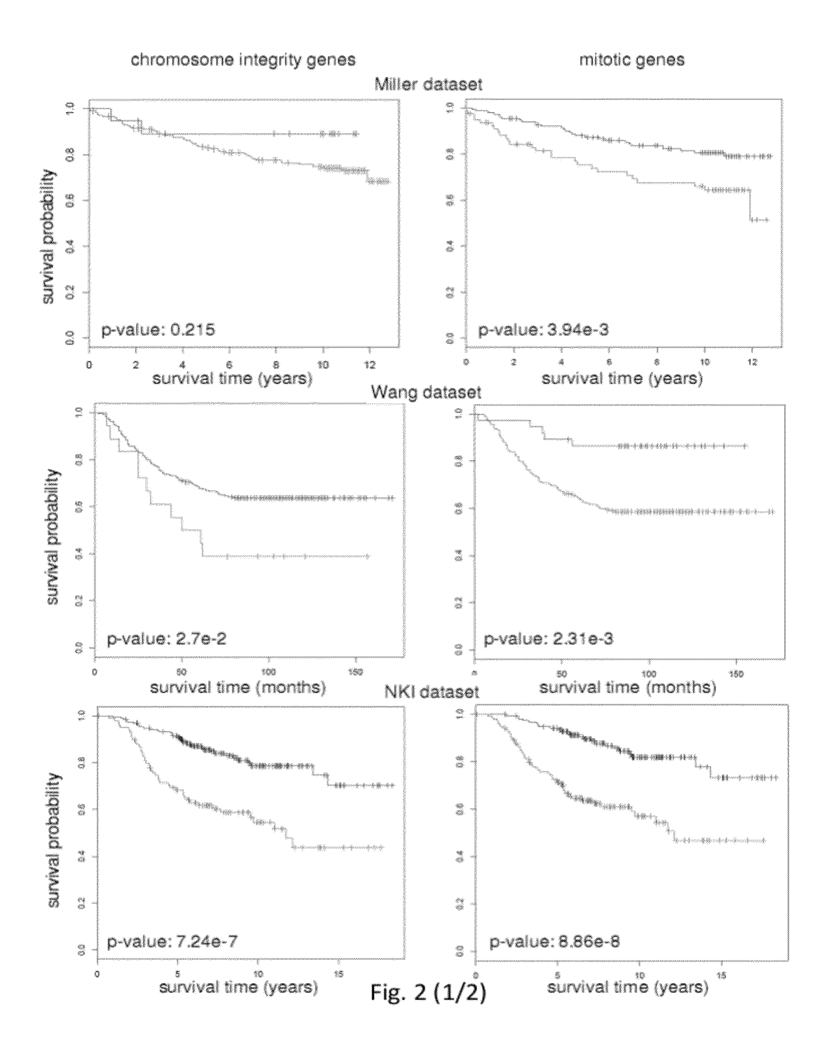

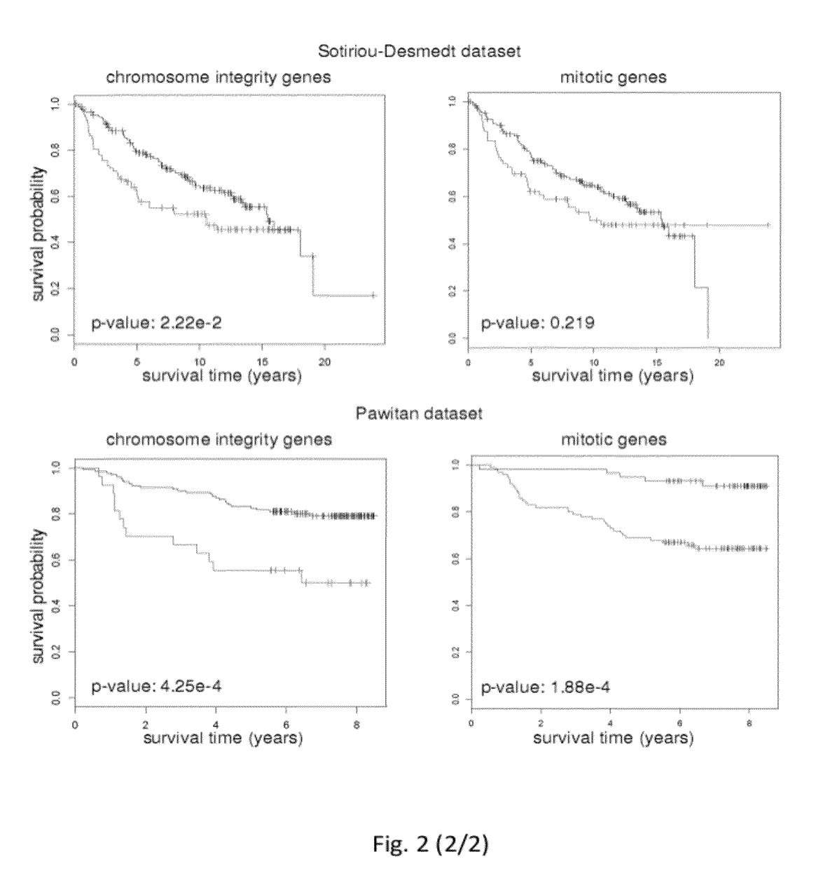

FIG. 2—Predictive power of the mitotic and chromosome-integrity genes of the DM signature. Kaplan-Meier survival analysis was performed on five breast cancer datasets using either the 34 chromosome integrity genes or the 71 mitotic genes of the DM signature represented in the Affymetrix platform. The curves represent the cumulative probabilities of survival of patients classified within two groups by the hierarchic clustering algorithm based on the correlation coefficient: lower curve—high risk patients; top curve—low risk patients.

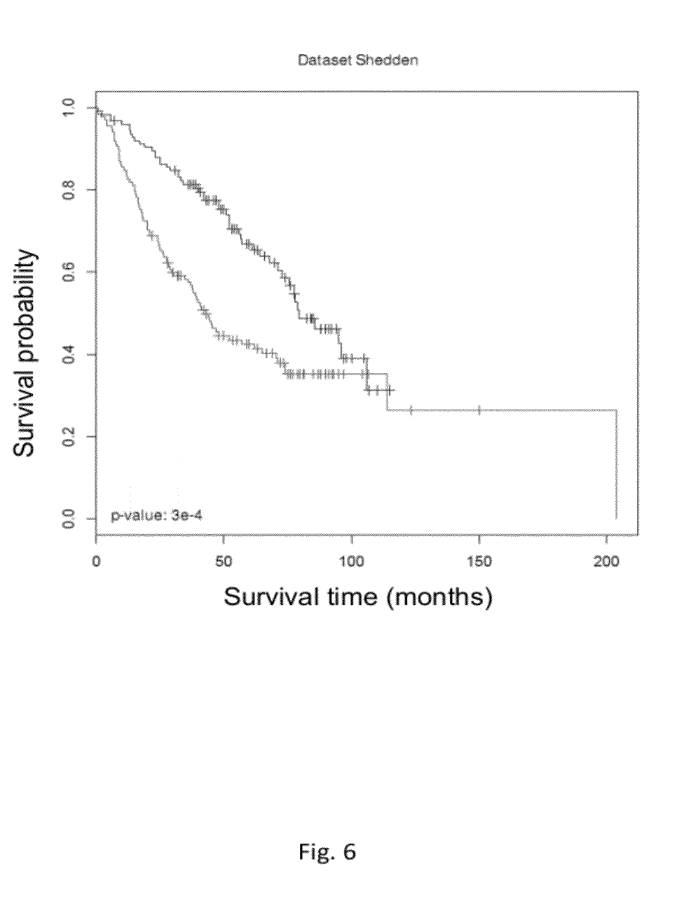

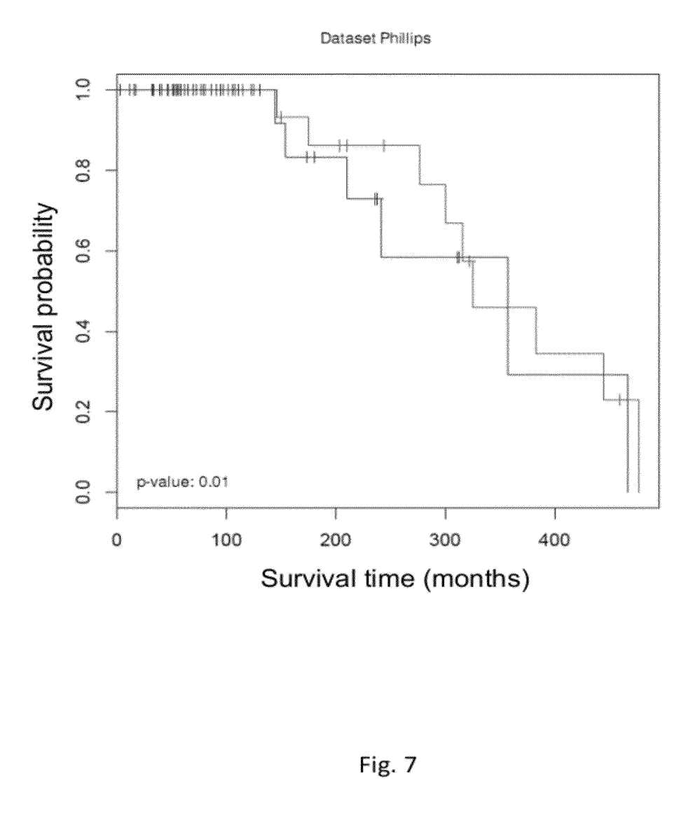

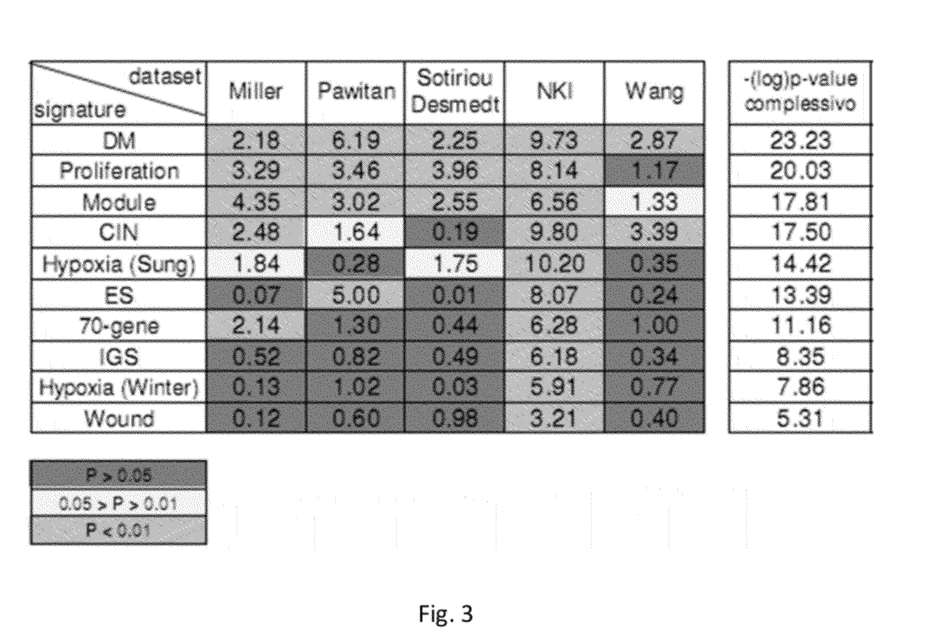

FIG. 3—The DM signature outperforms 9 major signatures in predictive power. The predictive power of signature is expressed with P; P is the P-value of the log-rank test for difference in survival probability of the two groups of patients obtained by hierarchical clustering using the genes of each signature. Colours correspond to the statistical significance: red, P>=0.05; yellow, 0.05>P>=0.01; green, P<0.01. The signatures compared (DM; Proliferation of Starmans et al. [11], Module [13], CIN [15], Hypoxia of Sung et al. [8], Hypoxia of Winter et al. [9], ES [12]; 70-gene [3]; IGS [14]; Wound [5,6] are described in the text.

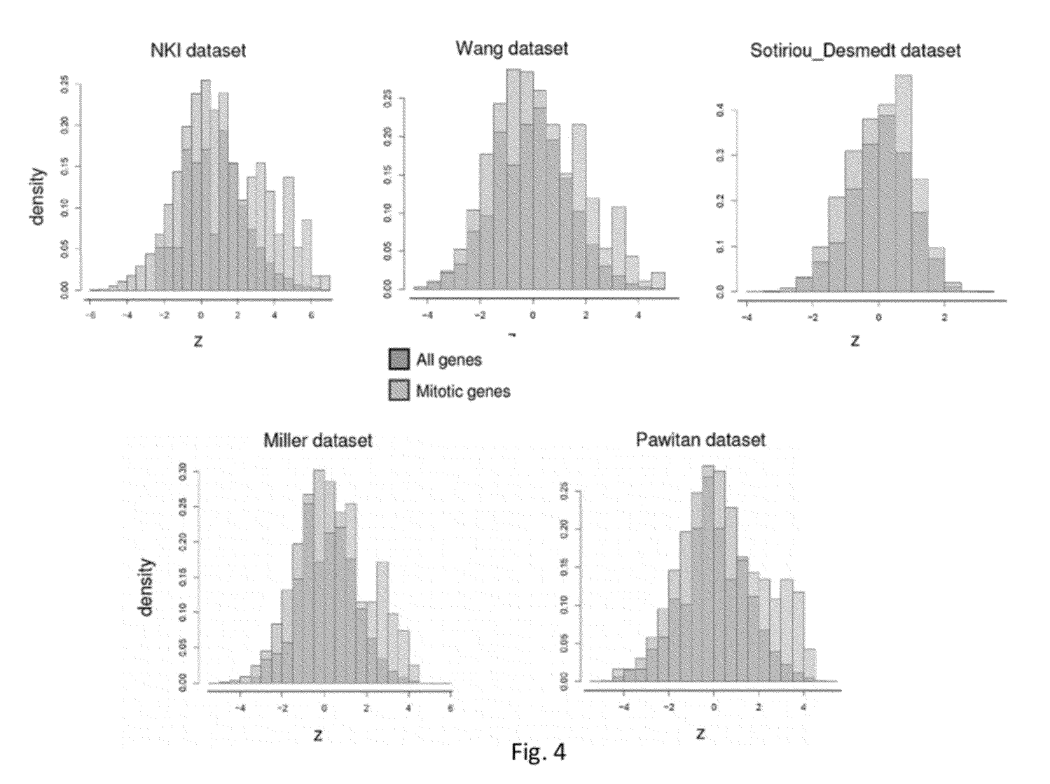

FIG. 4—Distribution of the z-scores of the genes of the DM signature compared to the distribution of z-scores of all genes represented in five breast cancer datasets. Density=ratio between the number of the genes in a given z-score and the total number of genes.

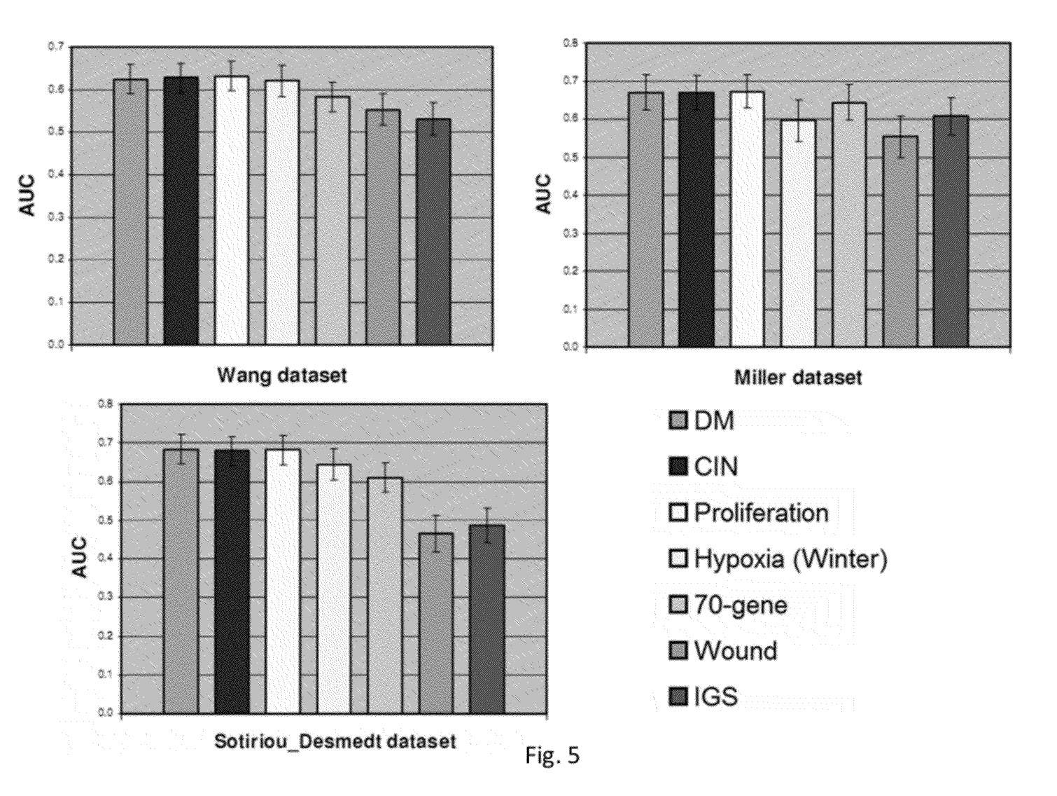

FIG. 5—Comparative evaluation of the prognostic score of the DM signature. The prognostic score of the DM signature is compared to those obtained from the CIN [15], Proliferation [11], IGS [14], Hypoxia [9], 70-gene [3], and Wound [5] signatures in the three datasets not used for training. The scores are used to predict outcome at five years. The bars show the areas under the ROC curves (AUC).

FIG. 6—Predictive power of the DM signature on a dataset of lung cancer [18]: Kaplan-Meier survival analysis. The curves represent the cumulative probabilities of survival of patients classified within two groups by the hierarchic clustering algorithm based on the correlation coefficient: lower curve—high risk patients; top curve—low risk patients.

FIG. 7—Predictive power of the DM signature on a dataset of glioma [19]: Kaplan-Meier survival analysis. The curves represent the cumulative probabilities of survival of patients classified within two groups by the hierarchic clustering algorithm based on the correlation coefficient: lower curve—high risk patients; top curve—low risk patients.

### MATERIALS AND METHODS

### Definition of the DM Signature

The 142 D. melanogaster mitotic genes described in [16] were first converted into Entrez gene ids (file gene_info.gz downloaded from the Entrez Gene ftp site in June 2008). The authors then used Homologene, build 62, to obtain the 108 human orthologues that compose the DM signature. The authors considered only one-to-one orthology relationships reported in Homologene. This criterion led to the exclusion from the DM signature of several human genes that are commonly considered homologous to the Drosophila genes. However, the degree of homology between these human genes and their Drosophila counterparts was not sufficient for inclusion in Homologene.

### Breast Cancer Datasets

The authors used the following publicly available breast cancer datasets: NKI [4]; Pawitan [20]—Gene Expression Omnibus (GEO-) series GSE1456; Miller [21]—GEO series GSE3494; Wang [22]—GEO series GSE2034; Desmedt [23]—GEO series GSE7390; and Sotiriou [24]—GEO series GSE2990. The authors used relapse-free survival times when available, and overall survival times otherwise. Since the Sotiriou, Desmedt and Miller datasets have some patients in common, the authors merged the Sotiriou and Desmedt datasets in a single dataset, from which the authors removed the patients included in the Miller dataset. The authors refer to this combined dataset as the Sotiriou-Desmedt dataset. Normalized expression data and clinical data for the NKI dataset were obtained from http://www.rii.com/publications/2002/nejm.html. For the Affymetrix-based datasets, the authors obtained gene expression values from the raw data, using MAS 5.0 algorithm as implemented in the simpleaffy [25] package of Bioconductor [26]. For all datasets the authors considered only the probesets unambiguously assigned to one Entrez Gene ID in the platform annotation. For the Affymetrix platform, the authors used the annotation provided by the manufacturer, version 25, which allowed them to identify single or multiple probesets for 105 of the 108 DM signature genes. For the NKI dataset the authors used the annotation file provided in the website mentioned above; the correspondence between sequence accession number and Entrez gene was obtained from the Entrez gene ftp site; 98 of the 108 DM genes were thus associated with one or multiple probes.

Dataset of Patients with Lung Glandular Cancer and of Patients with Glioma.

The expression data of patient with lung glandular cancer [18] were obtained from the caArray database, (https://array.nci.nih.gov/caarray) identification “jacobs-00182”. The expression data of patients with glioma [19] were obtained by the GEO database, accession GSE4271. In both cases data were treated as described for the breast cancer dataset on Affymetrix platform.

The Large lung cancer dataset refers to bibliographic reference [18]. Other lung cancer dataset and also ovarian cancer refer to bibliographic reference [27].

### Determination of the Predictive Power of the Genes in the DM Signatures by Clustering Analysis

To determine whether the expression profiles of the genes included in the DM signature are significantly and robustly correlated with the disease outcome the authors used the following procedure on the datasets mentioned above: (a) select the microarray probes unambiguously associated to the signature genes; (b) creating two groups of patients by Pearson correlation-based hierarchical clustering, using only the expression profiles of the probes selected in step a; (c) determining by a standard log-rank test, as implemented in the survival library of R, whether the cumulative probability of survival is significantly different between the two groups.

### Determination of Prognostic Scores

For all datasets the authors divided the patients into two groups (good- and poor-outcome) based on their status at five years. The authors then calculated the prognostic scores for outcome prediction at five years using the following procedures. For the 70-gene signature, the score of a patient is the cosine-correlation of the expression profile of genes with good-prognosis found in http://www.rii.com/publications/2002/nejm.html [4]. The genes in the signature, given at as accession numbers, were translated into Entrez gene IDs and then into Affymetrix probesets using Affymetrix annotation files, version 25. The authors obtained 76 probesets for the HG-U133A platform, and 109 probesets for the HG-U133A and HG-U133B platforms considered together. Probesets corresponding to the same gene were assigned the same coefficient in the good-prognosis profile.

For the Wound and IGS signatures, the score of a patient is given by the Pearson correlation of the expression profile of the signature genes. For the Wound signature the core serum response centroid is available at http://microarray-pubs.stanford.edu/wound [5]. The genes in the signature were translated into Entrez gene ids and then into Affymetrix probesets using the procedure described above. The authors obtained 493 probesets for the HG-U133A platform, and 667 probesets for the HG-U133A and HG-U133B platforms considered together. Probesets corresponding to the same gene were assigned the same expression value in the core serum response centroid. The centroid for the IGS signature is directly given in Affymetrix probesets [14].

For the CIN [15], Proliferation [11] and Hypoxia [9] signatures, the score of a patient is the sum of the logarithmic expression of the signature genes in the patient sample. For the CIN and Proliferation signatures, the gene symbols, were translated first into Entrez gene ids and then into Affymetrix probesets as described above. The Hypoxia signature is directly given in terms of Affymetrix probesets.

For the DM signature, the prognostic score of a patient is given by:

S(p)=Σ_{g}x(g,p)z(g)

where the sum is over all the probesets associated to the signature, z(g) is the z-score of probeset g computed in the Pawitan dataset and x(g,p) is the logarithmic expression level of probeset g in patient p. The Affymetrix probesets that comprise the DM signature together with their z-scores are reported in Table II.

The authors used ROC curves to compare the scalable scores on three datasets (Miller, Wang and Sotiriou-Desmedet). The area under the curves and the related standard error were computed using the Hmisc library and programs available at http://biostat.mc.vanderbilt.edu/s/Hmisc. The Pawitan and NKI datasets were not used in this comparison because they were involved in the training of the DM and 70-gene signatures, respectively.

### Contribution of Specific Gene Classes to the Predictive Power of the Signature

The contribution of each probeset g to the difference in score between poor- and good-prognosis patients is defined as:

Δs(g)=z(g)(P(g)−G(g))

where P(g) (G(g)) is the logarithmic expression of the probeset averaged on all poor (good) prognosis patients and z(g) is the z-score of the probeset. Given a subset of the DM signature (e.g. cytokinesis-related genes), the authors used a Mann-Whitney U test to compare the contribution of the probesets included in the subset to the contribution of all the other probesets.
mRNA Amplification
The methods for obtaining and amplifying mRNA are known in the art and described for example in Sambrook et al., Molecular Cloning—A laboratory manual (2nd Ed.), vols. 1-3, Cold Spring Harbor Laboratory, Cold Spring Harbor, N.Y. (1989) and Ausubel et al. Current Protocols in Molecular Biology vol. 2, Current Protocol Publishing, New York (1994). The RNA can be isolated from samples of tumor tissue, frozen or fixed tumor tissue sections, biopsy, biological fluid or tumor cell.
In the method, the sequence can be in any part of the transcript as indicated in Table II.

### Results

### Generation of the DM Signature

The authors have recently carried out an RNAi-based screen to detect Drosophila genes required for chromosome integrity and for the fidelity of mitotic division [16]. Since these types of genes tend to be transcriptionally co-expressed, the authors first used a co-expression-based bioinformatic procedure to select a group of 1,000 genes highly enriched in mitotic functions. The authors then performed RNAi against each of these genes in Drosophila S2 cultured cells. Phenotypic analysis of dsRNA-treated cells allowed the identification of 142 genes representative of the entire spectrum of functions required for proper transmission of genetic information. 44 of these genes were required to prevent spontaneous chromosome breakage. The remaining 98 genes specified a variety of mitotic functions including those required for spindle assembly, chromosome segregation and cytokinesis [16]. Based on the observed RNAi phenotypes, these 142 genes were subdivided into 18 phenoclusters [16].

To construct the DM signature the authors identified the human homologues of these Drosophila genes, according to Homologene [17]. Both the genes required for chromosome integrity and those involved in the mitotic process turned out to be highly conserved in humans. 36 of the 44 chromosome-integrity genes and 72 of the 98 mitotic genes had clear human orthologues. These 108 human genes, and their classification according to the phenotypes associated with RNAi-mediated silencing of their Drosophila counterparts, are listed in Tables I and II.

TABLE I
Classification of the 108 genes of the DM signature according to the RNAi
phenotypes of their Drosophila orthologues. The phenoclusters, indicated
in bold characters, are described in detail in [16]

| | |
|---|---|
| RNAi phenotypes elicited by the Drosophila | |
| genes | Names of the human orthologues |

Chromosome integrity genes

| | |
|---|---|
| Chromosome aberrations (CA) | C15orf44, CASP7, CNOT3, CTPS, CUL4B, |
| | CWC15, DCAKD, DDB1, FRG1, H3F3A, |
| | MSH6, ORC5L, PCNA, PIAS1, PPAN- |
| | P2RY11, POLA1, PRIM2, PRPF3, RAD54L, |
| | RFC2, RPA1, RRM2, SART1, SF3A3, SMC1A, |
| | TAF6, TFDP2, TK2, TPR, TYMS, WBP11, |
| | WDR46, WDR75, XAB2, XRN2, ZMYM4. |

Mitotic genes

| | |
|---|---|
| Abnormal chromosome structure. CC1, loss | CC1: MCM3, MCM7, SMC3. |
| of sister chromatid cohesion in | CC2: NCAPD2, NCAPG, SMC4, SMC2. |
| heterochromatin; CC2 and CC3, defective | CC3: MASTL, ORC2L, TOP2A. |
| lateral and longitudinal chromosome | |
| condensation, respectively | |
| Abnormal chromosome segregation. CS1, | CS1: CDT1. |
| defective chromosome duplication; CS2, | CS2: BUB3, KNTC1, ZW10. |
| precocious sister chromatid separation; CS3 | CS3 and CS4: ASCC3L1, CCNB1, CDC40, |
| and CS4, lack of sister chromatid separation; | DHX8, KIAA1310, LSM2, PRPF31, SF3A1, |
| CS5, defective chromosome segregation | SF3A2, SF3B1, SF3B2, SF3B14, SLU7, |
| during anaphase | SNRPA1, SNRPE, TXNL4A, U2AF1, U2AF2. |
| | CS5: ANAPC5, ANAPC10, CDC20, KIF4A, |
| | KIN, PSMC1, SFRS15. |
| Abnormal spindle morphology: SA1, short | SA1: CKAP5, EIF3A, EIF3D, EIF3E, EIF3I, |
| spindles; SA2, spindles with a low MT | GTF3C3, MAPRE3, NOC3L, RRP1B, TBK1, |
| density; SA3, poorly focused spindle poles, | THOC2, TUBB2C, WDR82. |
| SA4 miscellaneous spindle defects | SA2: TRRAP, TUBGCP4, TUBG2. |
| | SA3: ASPM, CENPJ, MKI67IP, PPP1R8. |
| | SA4: CDC2, KIFC1, KIF11, KIF18A. |
| Abnormal spindle and chromosome structure: | SC1: AURKC, RBBP7. |
| SC1, defective chromosome condensation | SC2: PLK1. |
| and cytokinesis; SC2, multiple mitotic | |
| defects | |
| Frequent cytokinesis failures: CY1 and CY2, | CY1: ECT2, KIF23, PRC1, RACGAP1. |
| defective in early and late cytokinesis, | CY2: ANLN, CIT. |
| respectively | |

TABLE II
Ranking of the Affymetrix probesets of the DM signature according to their z-scores.

| | | | | | | Tran- | | | | |
|---|---|---|---|---|---|---|---|---|---|---|
| | | | | | | script | Pa- | Contribution to the | | |
| Drosophila | | Human | | Entrez | | se- | witan | difference in score | | |
| gene | | gene | | Gene | | quence | z- | | Sotiriou- | |
| symbol | Phenocluster | symbol | Human Gene name | ID | Probeset | ID No. | score | Miller | Desmedt | Wang |
| scra | CY2 | ANLN | Anillin, actin binding protein | 54443 | 222608_s_at | SEQ ID | 4.39 | 2.35 | — | — |
| | | | | | | No. 1 | | | | |
| dup | CS1 | CDT1 | Chromatin licensing and DNA | 81620 | 228868_x_at | SEQ ID | 4.17 | 2.54 | — | — |
| | | | replication factor 1 | | | No. 2 | | | | |
| RnrS | CA | RRM2 | Ribonucleotide reductase M2 | 6241 | 209773_s_at | SEQ ID | 4.12 | 2.26 | 2.35 | 1.8 |
| | | | polypeptide | | | No. 3 | | | | |
| betaTub56D | SA1 | TUBB2C | Tubulin, beta 2C | 10383 | 213726_x_at | SEQ ID | 4.06 | 0.69 | 0.54 | 0.34 |
| | | | | | | No. 4 | | | | |
| betaTub56D | SA1 | TUBB2C | Tubulin, beta 2C | 10383 | 208977_x_at | SEQ ID | 4.06 | 0.47 | 0.49 | 0.27 |
| | | | | | | No. 5 | | | | |
| asp | SA3 | ASPM | Asp (abnormal spindle) homolog, | 259266 | 219918_s_at | SEQ ID | 3.99 | 2.56 | 1.66 | 1.93 |
| | | | microcephaly associated | | | No. 6 | | | | |
| | | | (Drosophila) | | | | | | | |
| CycB | CS3 & CS4 | CCNB1 | Cyclin B1 | 891 | 214710_s_at | SEQ ID | 3.95 | 2.43 | 2.32 | 1.18 |
| | | | | | | No. 7 | | | | |
| pav | CY1 | KIF23 | Kinesin family member 23 | 9493 | 204709_s_at | SEQ ID | 3.91 | 2.51 | 1.23 | 0.98 |
| | | | | | | No. 8 | | | | |
| RnrS | CA | RRM2 | Ribonucleotide reductase M2 | 6241 | 201890_at | SEQ ID | 3.91 | 2.7 | 2.64 | 1.95 |
| | | | polypeptide | | | No. 9 | | | | |
| CG13298 | CS3 & CS4 | SF3B14 | Splicing factor 3B, 14 kDa | 51639 | 223416_at | SEQ ID | 3.85 | 0.38 | — | — |
| | | | subunit | | | No. 10 | | | | |
| gwl | CC3 | MASTL | Microtubule associated | 84930 | 228468_at | SEQ ID | 3.73 | 0.69 | — | — |
| | | | serine/threonine kinase-like | | | No. 11 | | | | |
| tum | CY1 | RACGAP1 | Rac GTPase activating protein 1 | 29127 | 222077_s_at | SEQ ID | 3.69 | 1.88 | 1.6 | 1.7 |
| | | | | | | No. 12 | | | | |
| feo | CY1 | PRC1 | Protein regulator of cytokinesis 1 | 9055 | 218009_s_at | SEQ ID | 3.68 | 1.65 | 2.11 | 1.45 |
| | | | | | | No. 13 | | | | |
| CycB | CS3 &CS4 | CCNB1 | Cyclin B1 | 891 | 228729_at | SEQ ID | 3.64 | 2.7 | — | — |
| | | | | | | No. 14 | | | | |
| cdc2 | SA4 | CDC2 | Cell division cycle 2, G1 to S and | 983 | 210559_s_at | SEQ ID | 3.57 | 1.76 | 2.08 | 0.77 |
| | | | G2 to M | | | No. 15 | | | | |
| cdc2 | SA4 | CDC2 | Cell division cycle 2, G1 to S and | 983 | 203213_at | SEQ ID | 3.55 | 2.79 | 1.9 | 1.36 |
| | | | G2 to M | | | No. 16 | | | | |
| fzy | CS5 | CDC20 | Cell division cycle 20 homolog | 991 | 202870_s_at | SEQ ID | 3.52 | 2.14 | 2.04 | 1.38 |
| | | | (S. cerevisiae) | | | No. 17 | | | | |
| Klp67A | SA4 | KIF18A | Kinesin family member 18A | 81930 | 221258_s_at | SEQ ID | 3.49 | 2.6 | 0.51 | 0.56 |
| | | | | | | No. 18 | | | | |
| ncd | SA4 | KIFC1 | Kinesin family member C1 | 3833 | 209680_s_at | SEQ ID | 3.43 | 2.36 | 0.54 | 1.08 |
| | | | | | | No. 19 | | | | |
| Top2 | CC3 | TOP2A | Topoisomerase (DNA) II alpha | 7153 | 201292_at | SEQ ID | 3.43 | 1.54 | 1.99 | 1.4 |
| | | | 170 kDa | | | No. 20 | | | | |
| msps | SA1 | CKAP5 | Cytoskeleton associated protein 5 | 9793 | 212832_s_at | SEQ ID | 3.38 | 0.11 | 0.26 | 0.31 |
| | | | | | | No. 21 | | | | |
| CG34438 | CC2 | NCAPG | Non-SMC condensin I complex, | 64151 | 218662_s_at | SEQ ID | 3.37 | 1.54 | 1.79 | 0.72 |
| | | | subunit G | | | No. 22 | | | | |
| U2A | CS3 & CS4 | SNRPA1 | Small nuclear ribonucleoprotein | 6627 | 216977_x_at | SEQ ID | 3.36 | −0.09 | 0.82 | 0.43 |
| | | | polypeptide A′ | | | No. 23 | | | | |
| CG34438 | CC2 | NCAPG | Non-SMC condensin I complex, | 64151 | 218663_at | SEQ ID | 3.36 | 2.03 | 1.57 | 1.06 |
| | | | subunit G | | | No. 24 | | | | |
| Pros26.4 | CS5 | PSMC1 | Proteasome (prosome, | 5700 | 204219_s_at | SEQ ID | 3.35 | 0.36 | 0.37 | 0.18 |
| | | | macropain) 26S subunit, ATPase, 1 | | | No. 25 | | | | |
| CG3058 | CS3 & CS4 | TXNL4A | Thioredoxin-like 4A | 10907 | 202836_s_at | SEQ ID | 3.27 | 0.91 | 0.52 | 0.12 |
| | | | | | | No. 26 | | | | |
| polo | SC2 | PLK1 | Polo-like kinase 1 (Drosophila) | 5347 | 202240_at | SEQ ID | 3.14 | 1.18 | 0.94 | 0.4 |
| | | | | | | No. 27 | | | | |
| Mcm7 | CC1 | MCM7 | Minichromosome maintenance | 4176 | 208795_s_at | SEQ ID | 3.13 | 0.51 | 0.6 | 0.38 |
| | | | complex component 7 | | | No. 28 | | | | |
| Klp61F | SA4 | KIF11 | Kinesin family member 11 | 3832 | 204444_at | SEQ ID | 3.12 | 1.46 | 1.25 | 0.91 |
| | | | | | | No. 29 | | | | |
| U2af38 | CS3 & CS4 | U2AF1 | U2 small nuclear RNA auxiliary | 7307 | 202858_at | SEQ ID | 3.08 | 0.94 | 0.33 | 0.23 |
| | | | factor 1 | | | No. 30 | | | | |
| cdc2 | SA4 | CDC2 | Cell division cycle 2, G1 to S and | 983 | 203214_x_at | SEQ ID | 3.04 | 1.29 | 1.6 | 0.61 |
| | | | G2 to M | | | No. 31 | | | | |
| Ts | CA | TYMS | Thymidylate synthetase | 7298 | 202589_at | SEQ ID | 3.04 | 1.07 | 1.24 | 0.56 |
| | | | | | | No. 32 | | | | |
| glu | CC2 | SMC4 | Structural maintenance of | 10051 | 201663_s_at | SEQ ID | 2.98 | 0.08 | 1.06 | 0.69 |
| | | | chromosomes 4 | | | No. 33 | | | | |
| Mcm3 | CC1 | MCM3 | Minichromosome maintenance | 4172 | 201555_at | SEQ ID | 2.90 | 0.45 | 0.33 | −0.12 |
| | | | complex component 3 | | | No. 34 | | | | |
| rod | CS2 | KNTC1 | Kinetochore associated 1 | 9735 | 206316_s_at | SEQ ID | 2.89 | −0.29 | 0.49 | 0.7 |
| | | | | | | No. 35 | | | | |
| dup | CS1 | CDT1 | Chromatin licensing and DNA | 81620 | 209832_s_at | SEQ ID | 2.87 | 0.64 | 0.62 | 0.24 |
| | | | replication factor 1 | | | No. 36 | | | | |
| dnk | CA | TK2 | Thymidine kinase 2, | 7084 | 204227_s_at | SEQ ID | 2.82 | −0.13 | −0.13 | 0.04 |
| | | | mitochondrial | | | No. 37 | | | | |
| DDB1 | CA | DDB1 | Damage-specific DNA binding | 1642 | 208619_at | SEQ ID | 2.81 | 0.29 | −0.11 | 0.17 |
| | | | protein 1, 127 kDa | | | No. 38 | | | | |
| CG6854 | CA | CTPS | CTP synthase | 1503 | 202613_at | SEQ ID | 2.80 | 0.34 | 0.79 | 0.46 |
| | | | | | | No. 39 | | | | |
| pbl | CY1 | ECT2 | Epithelial cell transforming | 1894 | 234992_x_at | SEQ ID | 2.79 | 1.42 | — | — |
| | | | sequence 2 oncogene | | | No. 40 | | | | |
| CG6937 | SA3 | MKI67IP | MKI67 (FHA domain) | 84365 | 224714_at | SEQ ID | 2.73 | 0.41 | — | — |
| | | | interacting nucleolar | | | No. 41 | | | | |
| | | | phosphoprotein | | | | | | | |
| RfC40 | CA | RFC2 | Replication factor C (activator 1) | 5982 | 203696_s_at | SEQ ID | 2.70 | 0.24 | 0.19 | 0.01 |
| | | | 2, 40 kDa | | | No. 42 | | | | |
| DNAprim | CA | PRIM2 | Primase, DNA, polypeptide 2 | 5558 | 205628_at | SEQ ID | 2.68 | 1 | 0.02 | 0.14 |
| | | | (58 kDa) | | | No. 43 | | | | |
| pav | CY1 | KIF23 | Kinesin family member 23 | 9493 | 244427_at | SEQ ID | 2.49 | 0.31 | — | — |
| | | | | | | No. 44 | | | | |
| SMC2 | CC2 | SMC2 | Structural maintenance of | 10592 | 204240_s_at | SEQ ID | 2.46 | 0.22 | 0.92 | 0.28 |
| | | | chromosomes 2 | | | No. 45 | | | | |
| CG7003 | CA | MSH6 | MutS homolog 6 (E. coli) | 2956 | 202911_at | SEQ ID | 2.38 | 0.24 | 0.64 | 0.29 |
| | | | | | | No. 46 | | | | |
| asp | SA3 | ASPM | Asp (abnormal spindle) homolog, | 259266 | 239002_at | SEQ ID | 2.37 | 1.35 | — | — |
| | | | microcephaly associated | | | No. 47 | | | | |
| | | | (Drosophila) | | | | | | | |
| RfC40 | CA | RFC2 | Replication factor C (activator 1) | 5982 | 1053_at | SEQ ID | 2.33 | 0.11 | 0.22 | −0.28 |
| | | | 2, 40 kDa | | | No. 48 | | | | |
| U2A | CS3 & CS4 | SNRPA1 | Small nuclear ribonucleoprotein | 6627 | 215722_s_at | SEQ ID | 2.33 | 0.13 | 0.57 | 0.12 |
| | | | polypeptide A′ | | | No. 49 | | | | |
| CG4266 | CS5 | SFRS15 | Splicing factor, arginine/serine- | 57466 | 226082_s_at | SEQ ID | 2.27 | 0.28 | — | — |
| | | | rich 15 | | | No. 50 | | | | |
| mus209 | CA | PCNA | Proliferating cell nuclear antigen | 5111 | 201202_at | SEQ ID | 2.27 | 0.38 | 0.67 | 0.64 |
| | | | | | | No. 51 | | | | |
| Mcm7 | CC1 | MCM7 | Minichromosome maintenance | 4176 | 210983_s_at | SEQ ID | 2.25 | 0.18 | 0.52 | −0.07 |
| | | | complex component 7 | | | No. 52 | | | | |
| asp | SA3 | ASPM | Asp (abnormal spindle) homolog, | 259266 | 232238_at | SEQ ID | 2.19 | 1.03 | — | — |
| | | | microcephaly associated | | | No. 53 | | | | |
| | | | (Drosophila) | | | | | | | |
| glu | CC2 | SMC4 | Structural maintenance of | 10051 | 201664_at | SEQ ID | 2.19 | 0.32 | 0.62 | 0.62 |
| | | | chromosomes 4 | | | No. 54 | | | | |
| CG5931 | CS3 & CS4 | ASCC3L1 | Activating signal cointegrator 1 | 23020 | 200058_s_at | SEQ ID | 2.19 | 0.2 | 0.02 | −0.09 |
| | | | complex subunit 3-like 1 | | | No. 55 | | | | |
| DNAprim | CA | PRIM2 | Primase, DNA, polypeptide 2 | 5558 | 215708_s_at | SEQ ID | 2.16 | 0.06 | 0.11 | −0.06 |
| | | | (58 kDa) | | | No. 56 | | | | |
| Bub3 | CS2 | BUB3 | BUB3 budding uninhibited by | 9184 | 201457_x_at | SEQ ID | 2.13 | 0.49 | −0.02 | −0.02 |
| | | | benzimidazoles 3 homolog | | | No. 57 | | | | |
| | | | (yeast) | | | | | | | |
| CG8241 | CS3 & CS4 | DHX8 | DEAH (Asp-Glu-Ala-His) box | 1659 | 231184_at | SEQ ID | 1.94 | −0.05 | — | — |
| | | | polypeptide 8 | | | No. 58 | | | | |
| pbl | CY1 | ECT2 | Epithelial cell transforming | 1894 | 219787_s_at | SEQ ID | 1.94 | 0.73 | 0.55 | 0.48 |
| | | | sequence 2 oncogene | | | No. 59 | | | | |
| CG6876 | CS3 &CS4 | PRPF31 | PRP31 pre-mRNA processing | 26121 | 202407_s_at | SEQ ID | 1.90 | 0.33 | 0.37 | −0.4 |
| | | | factor 31 homolog (S. cerevisiae) | | | No. 60 | | | | |
| CG7003 | CA | MSH6 | MutS homolog 6 (E. coli) | 2956 | 211450_s_at | SEQ ID | 1.88 | 0.29 | 0.61 | −0.12 |
| | | | | | | No. 61 | | | | |
| Top2 | CC3 | TOP2A | Topoisomerase (DNA) II alpha | 7153 | 201291_s_at | SEQ ID | 1.78 | 1.1 | 1.3 | 0.81 |
| | | | 170 kDa | | | No. 62 | | | | |
| CG4266 | CS5 | SFRS15 | Splicing factor, arginine/serine- | 57466 | 233753_at | SEQ ID | 1.76 | 0.33 | — | — |
| | | | rich 15 | | | No. 63 | | | | |
| RpA-70 | CA | RPA1 | Replication protein A1, 70 kDa | 6117 | 201529_s_at | SEQ ID | 1.73 | −0.24 | −0.06 | −0.21 |
| | | | | | | No. 64 | | | | |
| CG2685 | CA | WBP11 | WW domain binding protein 11 | 51729 | 217821_s_at | SEQ ID | 1.72 | −0.43 | 0.05 | −0.24 |
| | | | | | | No. 65 | | | | |
| l(2)NC136 | CA | CNOT3 | CCR4-NOT transcription | 4849 | 211141_s_at | SEQ ID | 1.68 | 0.5 | −0.03 | 0.01 |
| | | | complex, subunit 3 | | | No. 66 | | | | |
| CG2685 | CA | WBP11 | WW domain binding protein 11 | 51729 | 217822_at | SEQ ID | 1.64 | −0.03 | 0.04 | 0.14 |
| | | | | | | No. 67 | | | | |
| Taf6 | CA | TAF6 | TAF6 RNA polymerase II, | 6878 | 203572_s_at | SEQ ID | 1.62 | −0.06 | −0.05 | 0.06 |
| | | | TATA box binding protein | | | No. 68 | | | | |
| | | | (TBP)-associated factor, 80 kDa | | | | | | | |
| Nipped-A | SA2 | TRRAP | Transformation/transcription | 8295 | 202642_s_at | SEQ ID | 1.61 | 0.02 | 0.01 | 0.28 |
| | | | domain-associated protein | | | No. 69 | | | | |
| Orc5 | CA | ORC5L | Origin recognition complex, | 5001 | 211212_s_at | SEQ ID | 1.58 | −0.02 | 0.08 | 0.07 |
| | | | subunit 5-like (yeast) | | | No. 70 | | | | |
| U2A | CS3 & CS4 | SNRPA1 | Small nuclear ribonucleoprotein | 6627 | 206055_s_at | SEQ ID | 1.56 | 0.24 | 0.24 | 0.3 |
| | | | polypeptide A′ | | | No. 71 | | | | |
| CG18591 | CS3 & CS4 | SNRPE | Small nuclear ribonucleoprotein | 6635 | 203316_s_at | SEQ ID | 1.54 | 0.28 | 0.05 | 0.16 |
| | | | polypeptide E | | | No. 72 | | | | |
| Nipped-A | SA2 | TRRAP | Transformation/transcription | 8295 | 214908_s_at | SEQ ID | 1.52 | −0.14 | −0.05 | −0.14 |
| | | | domain-associated protein | | | No. 73 | | | | |
| CG8950 | SA1 | GTF3C3 | General transcription factor IIIC, | 9330 | 218343_s_at | SEQ ID | 1.50 | 0.07 | 0.15 | 0.06 |
| | | | polypeptide 3, 102 kDa | | | No. 74 | | | | |
| okr | CA | RAD54L | RAD54-like (S. cerevisiae) | 8438 | 204558_at | SEQ ID | 1.49 | 0.05 | 0.26 | 0.64 |
| | | | | | | No. 75 | | | | |
| Grip75 | SA2 | TUBGCP4 | Tubulin, gamma complex | 27229 | 211337_s_at | SEQ ID | 1.47 | −0.1 | 0.22 | 0.01 |
| | | | associated protein 4 | | | No. 76 | | | | |
| CG3605 | CS3 &CS4 | SF3B2 | Splicing factor 3b, subunit 2, | 10992 | 200619_at | SEQ ID | 1.44 | 0.07 | 0.05 | 0.07 |
| | | | 145 kDa | | | No. 77 | | | | |
| sti | CY2 | CIT | Citron (rho-interacting, | 11113 | 212801_at | SEQ ID | 1.43 | 0.01 | 0.02 | 0.07 |
| | | | serine/threonine kinase 21) | | | No. 78 | | | | |
| Orc5 | CA | ORC5L | Origin recognition complex, | 5001 | 204957_at | SEQ ID | 1.36 | 0.05 | 0.12 | 0.1 |
| | | | subunit 5-like (yeast) | | | No. 79 | | | | |
| CG4266 | CS5 | SFRS15 | Splicing factor, arginine/serine- | 57466 | 222311_s_at | SEQ ID | 1.36 | −0.1 | 0.12 | 0.02 |
| | | | rich 15 | | | No. 80 | | | | |
| CG10354 | CA | XRN2 | 5′-3′ exoribonuclease 2 | 22803 | 233878_s_at | SEQ ID | 1.30 | −0.08 | — | — |
| | | | | | | No. 81 | | | | |
| U2af38 | CS3 & CS4 | U2AF1 | U2 small nuclear RNA auxiliary | 7307 | 242499_at | SEQ ID | 1.27 | 0.11 | — | — |
| | | | factor 1 | | | No. 82 | | | | |
| pbl | CY1 | ECT2 | Epithelial cell transforming | 1894 | 237241_at | SEQ ID | 1.23 | 0.05 | — | — |
| | | | sequence 2 oncogene | | | No. 83 | | | | |
| CG10354 | CA | XRN2 | 5′-3′ exoribonuclease 2 | 22803 | 223002_s_at | SEQ ID | 1.21 | −0.07 | — | — |
| | | | | | | No. 84 | | | | |
| ida | CS5 | ANAPC5 | Anaphase promoting complex | 51433 | 208721_s_at | SEQ ID | 1.14 | 0.03 | 0.09 | −0.15 |
| | | | subunit 5 | | | No. 85 | | | | |
| Dp | CA | TFDP2 | Transcription factor Dp-2 (E2F | 7029 | 203588_s_at | SEQ ID | 1.14 | 0.16 | 0.24 | −0.13 |
| | | | dimerization partner 2) | | | No. 86 | | | | |
| Sas-4 | SA3 | CENPJ | Centromere protein J | 55835 | 220885_s_at | SEQ ID | 1.12 | 0.03 | 0.05 | −0.05 |
| | | | | | | No. 87 | | | | |
| DNAprim | CA | PRIM2 | Primase, DNA, polypeptide 2 | 5558 | 215709_at | SEQ ID | 1.10 | 0.02 | −0.01 | 0.04 |
| | | | (58 kDa) | | | No. 88 | | | | |
| CG6937 | SA3 | MKI67IP | MKI67 (FHA domain) | 84365 | 224713_at | SEQ ID | 1.04 | 0.06 | — | — |
| | | | interacting nucleolar | | | No. 89 | | | | |
| | | | phosphoprotein | | | | | | | |
| ial | SC1 | AURKC | Aurora kinase C | 6795 | 211107_s_at | SEQ ID | 1.02 | 0.1 | −0.02 | −0.08 |
| | | | | | | No. 90 | | | | |
| CG6876 | CS3 & CS4 | PRPF31 | PRP31 pre-mRNA processing | 26121 | 202408_s_at | SEQ ID | 1.01 | 0.29 | 0.1 | 0.08 |
| | | | factor 31 homolog (S. cerevisiae) | | | No. 91 | | | | |
| Sas-4 | SA3 | CENPJ | Centromere protein J | 55835 | 223513_at | SEQ ID | 0.94 | 0.03 | — | — |
| | | | | | | No. 92 | | | | |
| CG2260 | CA | WDR46 | WD repeat domain 46 | 9277 | 209196_at | SEQ ID | 0.91 | 0.21 | 0.01 | −0.15 |
| | | | | | | No. 93 | | | | |
| U2af50 | CS3 & CS4 | U2AF2 | U2 small nuclear RNA auxiliary | 11338 | 218382_s_at | SEQ ID | 0.82 | 0.07 | 0.02 | −0.21 |
| | | | factor 2 | | | No. 94 | | | | |
| ida | CS5 | ANAPC5 | Anaphase promoting complex | 51433 | 200098_s_at | SEQ ID | 0.82 | 0.01 | 0.02 | 0.09 |
| | | | subunit 5 | | | No. 95 | | | | |
| Top2 | CC3 | TOP2A | Topoisomerase (DNA) II alpha | 7153 | 237469_at | SEQ ID | 0.79 | 0.24 | — | — |
| | | | 170 kDa | | | No. 96 | | | | |
| ida | CS5 | ANAPC5 | Anaphase promoting complex | 51433 | 208722_s_at | SEQ ID | 0.77 | −0.1 | −0.01 | 0.06 |
| | | | subunit 5 | | | No. 97 | | | | |
| CG16941 | CS3 & CS4 | SF3A1 | Splicing factor 3a, subunit 1, | 10291 | 201357_s_at | SEQ ID | 0.71 | −0.09 | −0.01 | −0.11 |
| | | | 120 kDa | | | No. 98 | | | | |
| Mtor | CA | TPR | Translocated promoter region (to | 7175 | 215220_s_at | SEQ ID | 0.68 | −0.16 | −0.02 | −0.12 |
| | | | activated MET oncogene) | | | No. 99 | | | | |
| CG6015 | CS3 &CS4 | CDC40 | Cell division cycle 40 homolog | 51362 | 203377_s_at | SEQ ID | 0.65 | 0.02 | 0 | 0.1 |
| | | | (S. cerevisiae) | | | No. 100 | | | | |
| eIF- | SA1 | EIF3D | Eukaryotic translation initiation | 8664 | 200005_at | SEQ ID | 0.63 | 0.05 | −0.04 | −0.04 |
| 3p66 | | | factor 3, subunit D | | | No. 101 | | | | |
| U2af38 | CS3 & CS4 | U2AF1 | U2 small nuclear RNA auxiliary | 7307 | 232141_at | SEQ ID | 0.58 | 0.03 | — | — |
| | | | factor 1 | | | No. 102 | | | | |
| RpA-70 | CA | RPA1 | Replication protein A1, 70 kDa | 6117 | 201528_at | SEQ ID | 0.57 | −0.03 | 0.01 | 0.07 |
| | | | | | | No. 103 | | | | |
| Orc2 | CC3 | ORC2L | Origin recognition complex, | 4999 | 204853_at | SEQ ID | 0.56 | 0.05 | 0.01 | 0.03 |
| | | | subunit 2-like (yeast) | | | No. 104 | | | | |
| Nnp-1 | SA1 | RRP1B | Ribosomal RNA processing 1 | 23076 | 212844_at | SEQ ID | 0.54 | 0.05 | 0.04 | 0.01 |
| | | | homolog B (S. cerevisiae) | | | No. 105 | | | | |
| CAP-D2 | CC2 | NCAPD2 | Non-SMC condensin I complex, | 9918 | 201774_s_at | SEQ ID | 0.52 | 0.03 | 0.12 | −0.03 |
| | | | subunit D2 | | | No. 106 | | | | |
| Sas-4 | SA3 | CENPJ | Centromere protein J | 55835 | 234023_s_at | SEQ ID | 0.44 | 0.06 | — | — |
| | | | | | | No. 107 | | | | |
| Mtor | CA | TPR | Translocated promoter region (to | 7175 | 201731_s_at | SEQ ID | 0.44 | 0 | −0.07 | 0.01 |
| | | | activated MET oncogene) | | | No. 108 | | | | |
| Orc5 | CA | ORC5L | Origin recognition complex, | 5001 | 211213_at | SEQ ID | 0.44 | 0.09 | 0 | −0.01 |
| | | | subunit 5-like (yeast) | | | No. 109 | | | | |
| tho2 | SA1 | THOC2 | THO complex 2 | 57187 | 226628_at | SEQ ID | 0.40 | 0 | — | — |
| | | | | | | No. 110 | | | | |
| kin17 | CS5 | KIN | KIN, antigenic determinant of | 22944 | 205664_at | SEQ ID | 0.34 | 0.03 | 0.04 | 0.01 |
| | | | recA protein homolog (mouse) | | | No. 111 | | | | |
| ida | CS5 | ANAPC5 | Anaphase promoting complex | 51433 | 211036_x_at | SEQ ID | 0.33 | −0.02 | 0 | 0.06 |
| | | | subunit 5 | | | No. 112 | | | | |
| cul-4 | CA | CUL4B | Cullin 4B | 8450 | 210257_x_at | SEQ ID | 0.29 | −0.03 | 0.03 | 0 |
| | | | | | | No. 113 | | | | |
| Trip1 | SA1 | EIF3I | Eukaryotic translation initiation | 8668 | 208756_at | SEQ ID | 0.26 | 0.01 | −0.01 | −0.04 |
| | | | factor 3, subunit I | | | No. 114 | | | | |
| SMC1 | CA | SMC1A | Structural maintenance of | 8243 | 201589_at | SEQ ID | 0.26 | 0.03 | 0.05 | 0.05 |
| | | | chromosomes 1A | | | No. 115 | | | | |
| Eb1 | SA1 | MAPRE3 | Microtubule-associated protein, | 22924 | 203842_s_at | SEQ ID | 0.25 | −0.01 | 0.01 | −0.02 |
| | | | RP/EB family, member 3 | | | No. 116 | | | | |
| ida | CS5 | ANAPC5 | Anaphase promoting complex | 51433 | 239651_at | SEQ ID | 0.25 | −0.01 | — | — |
| | | | subunit 5 | | | No. 117 | | | | |
| Dp | CA | TFDP2 | Transcription factor Dp-2 (E2F | 7029 | 203589_s_at | SEQ ID | 0.25 | −0.03 | 0.01 | −0.01 |
| | | | dimerization partner 2) | | | No. 118 | | | | |
| CG16941 | CS3 & CS4 | SF3A1 | Splicing factor 3a, subunit 1, | 10291 | 227516_at | SEQ ID | 0.19 | −0.06 | — | — |
| | | | 120 kDa | | | No. 119 | | | | |
| CG8241 | CS3 &CS4 | DHX8 | DEAH (Asp-Glu-Ala-His) box | 1659 | 227079_at | SEQ ID | 0.15 | 0 | — | — |
| | | | polypeptide 8 | | | No. 120 | | | | |
| CG8241 | CS3 & CS4 | DHX8 | DEAH (Asp-Glu-Ala-His) box | 1659 | 203334_at | SEQ ID | 0.08 | −0.03 | 0 | 0 |
| | | | polypeptide 8 | | | No. 121 | | | | |
| sti | CY2 | CIT | Citron (rho-interacting, | 11113 | 242872_at | SEQ ID | 0.07 | 0.02 | — | — |
| | | | serine/threonine kinase 21) | | | No. 122 | | | | |
| Nnp-1 | SA1 | RRP1B | Ribosomal RNA processing 1 | 23076 | 212846_at | SEQ ID | 0.06 | 0.02 | 0.01 | 0.01 |
| | | | homolog B (S. cerevisiae) | | | No. 123 | | | | |
| CG6686 | CA | SART1 | Squamous cell carcinoma antigen | 9092 | 200051_at | SEQ ID | 0.02 | 0 | 0 | 0 |
| | | | recognized by T cells | | | No. 124 | | | | |
| Ts | CA | TYMS | Thymidylate synthetase | 7298 | 217684_at | SEQ ID | 0.01 | 0 | 0 | 0 |
| | | | | | | No. 125 | | | | |
| CG1939 | CA | DCAKD | Dephospho-CoA kinase domain | 79877 | 221225_at | SEQ ID | 0.01 | 0 | 2.29E−05 | 0 |
| | | | containing | | | No. 126 | | | | |
| SMC2 | CC2 | SMC2 | Structural maintenance of | 10592 | 213253_at | SEQ ID | −0.03 | −0.01 | −0.01 | 0 |
| | | | chromosomes 2 | | | No. 127 | | | | |
| Eb1 | SA1 | MAPRE3 | Microtubule-associated protein, | 22924 | 214270_s_at | SEQ ID | −0.05 | 0.01 | 0 | 0 |
| | | | RP/EB family, member 3 | | | No. 128 | | | | |
| CG11419 | CS5 | ANAPC10 | Anaphase promoting complex | 10393 | 207845_s_at | SEQ ID | −0.07 | 0 | −0.01 | −0.01 |
| | | | subunit 10 | | | No. 129 | | | | |
| Eb1 | SA1 | MAPRE3 | Microtubule-associated protein, | 22924 | 203841_x_at | SEQ ID | −0.08 | 0.01 | 0 | 0 |
| | | | RP/EB family, member 3 | | | No. 130 | | | | |
| U2af38 | CS3 & CS4 | U2AF1 | U2 small nuclear RNA auxiliary | 7307 | 231904_at | SEQ ID | −0.10 | −0.01 | — | — |
| | | | factor 1 | | | No. 131 | | | | |
| tho2 | SA1 | THOC2 | THO complex 2 | 57187 | 226626_at | SEQ ID | −0.11 | 0 | — | — |
| | | | | | | No. 132 | | | | |
| Eb1 | SA1 | MAPRE3 | Microtubule-associated protein, | 22924 | 229682_at | SEQ ID | −0.13 | −0.03 | — | — |
| | | | RP/EB family, member 3 | | | No. 133 | | | | |
| CG3058 | CS3 & CS4 | TXNL4A | Thioredoxin-like 4A | 10907 | 202835_at | SEQ ID | −0.13 | −0.02 | −0.01 | −0.01 |
| | | | | | | No. 134 | | | | |
| CG5931 | CS3 & CS4 | ASCC3L1 | Activating signal cointegrator 1 | 23020 | 232931_at | SEQ ID | −0.15 | −0.02 | — | — |
| | | | complex subunit 3-like 1 | | | No. 135 | | | | |
| CG18591 | CS3 & CS4 | SNRPE | Small nuclear ribonucleoprotein | 6635 | 231112_at | SEQ ID | −0.15 | 0.03 | — | — |
| | | | polypeptide E | | | No. 136 | | | | |
| CG10418 | CS3 & CS4 | LSM2 | LSM2 homolog, U6 small | 57819 | 209449_at | SEQ ID | −0.19 | −0.01 | −0.01 | 0.01 |
| | | | nuclear RNA associated | | | No. 137 | | | | |
| | | | (S. cerevisiae) | | | | | | | |
| l(2)NC136 | CA | CNOT3 | CCR4-NOT transcription | 4849 | 203239_s_at | SEQ ID | −0.20 | −0.03 | 0.01 | 0.01 |
| | | | complex, subunit 3 | | | No. 138 | | | | |
| Bub3 | CS2 | BUB3 | BUB3 budding uninhibited by | 9184 | 209974_s_at | SEQ ID | −0.21 | −0.05 | 0.01 | −0.03 |
| | | | benzimidazoles 3 homolog | | | No. 139 | | | | |
| | | | (yeast) | | | | | | | |
| CG1939 | CA | DCAKD | Dephospho-CoA kinase domain | 79877 | 221224_s_at | SEQ ID | −0.24 | 0.06 | −0.01 | 0.09 |
| | | | containing | | | No. 140 | | | | |
| glu | CC2 | SMC4 | Structural maintenance of | 10051 | 215623_x_at | SEQ ID | −0.24 | −0.02 | −0.03 | −0.05 |
| | | | chromosomes 4 | | | No. 141 | | | | |
| CG4266 | CS5 | SFRS15 | Splicing factor, arginine/serine- | 57466 | 243759_at | SEQ ID | −0.28 | −0.02 | — | — |
| | | | rich 15 | | | No. 142 | | | | |
| mit(1)15 | CS2 | ZW10 | ZW10, kinetochore associated, | 9183 | 204812_at | SEQ ID | −0.32 | 0.01 | 0.01 | 0 |
| | | | homolog (Drosophila) | | | No. 143 | | | | |
| kin17 | CS5 | KIN | KIN, antigenic determinant of | 22944 | 236887_at | SEQ ID | −0.34 | 0.03 | — | — |
| | | | recA protein homolog (mouse) | | | No. 144 | | | | |
| CG4785 | CA | C15orf44 | Chromosome 15 open reading | 81556 | 221265_s_at | SEQ ID | −0.34 | −0.02 | 0 | 0 |
| | | | frame 44 | | | No. 145 | | | | |
| U2af50 | CS3 & CS4 | U2AF2 | U2 small nuclear RNA auxiliary | 11338 | 229508_at | SEQ ID | −0.35 | −0.08 | — | — |
| | | | factor 2 | | | No. 146 | | | | |
| DNApol- | CA | POLA1 | Polymerase (DNA directed), | 5422 | 204835_at | SEQ ID | −0.37 | 0.05 | −0.03 | −0.01 |
| alpha180 | | | alpha 1, catalytic subunit | | | No. 147 | | | | |
| Bub3 | CS2 | BUB3 | BUB3 budding uninhibited by | 9184 | 229827_at | SEQ ID | −0.37 | −0.09 | — | — |
| | | | benzimidazoles 3 homolog | | | No. 148 | | | | |
| | | | (yeast) | | | | | | | |
| CG1420 | CS3 & CS4 | SLU7 | SLU7 splicing factor homolog | 10569 | 231718_at | SEQ ID | −0.38 | −0.02 | — | — |
| | | | (S. cerevisiae) | | | No. 149 | | | | |
| CG5931 | CS3 & CS4 | ASCC3L1 | Activating signal cointegrator 1 | 23020 | 214982_at | SEQ ID | −0.38 | 0.1 | −0.01 | −0.02 |
| | | | complex subunit 3-like 1 | | | No. 150 | | | | |
| CG1420 | CS3 & CS4 | SLU7 | SLU7 splicing factor homolog | 10569 | 227990_at | SEQ ID | −0.41 | 0.03 | — | — |
| | | | (S. cerevisiae) | | | No. 151 | | | | |
| cul-4 | CA | CUL4B | Cullin 4B | 8450 | 202213_s_at | SEQ ID | −0.43 | 0.03 | −0.02 | 0.01 |
| | | | | | | No. 152 | | | | |
| CG7003 | CA | MSH6 | MutS homolog 6 (E. coli) | 2956 | 240148_at | SEQ ID | −0.45 | −0.05 | — | — |
| | | | | | | No. 153 | | | | |
| Int6 | SA1 | EIF3E | Eukaryotic translation initiation | 3646 | 208697_s_at | SEQ ID | −0.45 | −0.03 | −0.03 | −0.03 |
| | | | factor 3, subunit E | | | No. 154 | | | | |
| U2af50 | CS3 & CS4 | U2AF2 | U2 small nuclear RNA auxiliary | 11338 | 214171_s_at | SEQ ID | −0.48 | 0.05 | −0.01 | 0.02 |
| | | | factor 2 | | | No. 155 | | | | |
| dnk | CA | TK2 | Thymidine kinase 2, | 7084 | 204277_s_at | SEQ ID | −0.49 | 0.11 | 0.01 | 0.07 |
| | | | mitochondrial | | | No. 156 | | | | |
| gamma | SA2 | TUBG2 | Tubulin, gamma 2 | 27175 | 203894_at | SEQ ID | −0.53 | 0.02 | 0 | 0.01 |
| Tub23C | | | | | | No. 157 | | | | |
| CG12050 | CA | WDR75 | WD repeat domain 75 | 84128 | 224721_at | SEQ ID | −0.54 | −0.02 | — | — |
| | | | | | | No. 158 | | | | |
| C12.1 | CA | CWC15 | CWC15 homolog (S. cerevisiae) | 51503 | 223067_at | SEQ ID | −0.55 | −0.03 | — | — |
| | | | | | | No. 159 | | | | |
| CG8233 | CS3 & CS4 | KIAA1310 | KIAA1310 | 55683 | 224318_s_at | SEQ ID | −0.56 | 0.05 | — | — |
| | | | | | | No. 160 | | | | |
| U2af50 | CS3 & CS4 | U2AF2 | U2 small nuclear RNA auxiliary | 11338 | 218381_s_at | SEQ ID | −0.56 | −0.14 | 0 | −0.08 |
| | | | factor 2 | | | No. 161 | | | | |
| CG16941 | CS3 & CS4 | SF3A1 | Splicing factor 3a, subunit 1, | 10291 | 216457_s_at | SEQ ID | −0.56 | 0.05 | 0 | −0.01 |
| | | | 120 kDa | | | No. 162 | | | | |
| CG8950 | SA1 | GTF3C3 | General transcription factor IIIC, | 9330 | 222604_at | SEQ ID | −0.57 | 0.01 | — | — |
| | | | polypeptide 3, 102 kDa | | | No. 163 | | | | |
| CG1234 | SA1 | NOC3L | Nucleolar complex associated 3 | 64318 | 218889_at | SEQ ID | −0.57 | −0.04 | −0.02 | 0.03 |
| | | | homolog (S. cerevisiae) | | | No. 164 | | | | |
| cul-4 | CA | CUL4B | Cullin 4B | 8450 | 215997_s_at | SEQ ID | −0.63 | 0 | −0.01 | 0 |
| | | | | | | No. 165 | | | | |
| Caf1 | SC1 | RBBP7 | Retinoblastoma binding protein 7 | 5931 | 201092_at | SEQ ID | −0.64 | −0.08 | −0.07 | −0.06 |
| | | | | | | No. 166 | | | | |
| l(2)NC136 | CA | CNOT3 | CCR4-NOT transcription | 4849 | 229143_at | SEQ ID | −0.71 | −0.07 | — | — |
| | | | complex, subunit 3 | | | No. 167 | | | | |
| NiPp1 | SA3 | PPP1R8 | Protein phosphatase 1, regulatory | 5511 | 207830_s_at | SEQ ID | −0.71 | 0.02 | 0 | 0 |
| | | | (inhibitor) subunit 8 | | | No. 168 | | | | |
| CG10754 | CS3 & CS4 | SF3A2 | Splicing factor 3a, subunit 2, | 8175 | 209381_x_at | SEQ ID | −0.73 | −0.14 | 0.06 | 0.07 |
| | | | 66 kDa | | | No. 169 | | | | |
| CG7757 | CA | PRPF3 | PRP3 pre-mRNA processing | 9129 | 202251_at | SEQ ID | −0.74 | 0.13 | −0.04 | −0.11 |
| | | | factor 3 homolog (S. cerevisiae) | | | No. 170 | | | | |
| dnk | CA | TK2 | Thymidine kinase 2, | 7084 | 240300_at | SEQ ID | −0.76 | −0.04 | — | — |
| | | | mitochondrial | | | No. 171 | | | | |
| dnk | CA | TK2 | Thymidine kinase 2, | 7084 | 204276_at | SEQ ID | −0.76 | 0.17 | 0.02 | 0.05 |
| | | | mitochondrial | | | No. 172 | | | | |
| CG16941 | CS3 & CS4 | SF3A1 | Splicing factor 3a, subunit 1, | 10291 | 201356_at | SEQ ID | −0.77 | 0.11 | −0.01 | 0.04 |
| | | | 120 kDa | | | No. 173 | | | | |
| Bub3 | CS2 | BUB3 | BUB3 budding uninhibited by | 9184 | 201458_s_at | SEQ ID | −0.83 | −0.06 | 0.04 | −0.08 |
| | | | benzimidazoles 3 homolog | | | No. 174 | | | | |
| | | | (yeast) | | | | | | | |
| eIF3- | SA1 | EIF3A | Eukaryotic translation initiation | 8661 | 200595_s_at | SEQ ID | −0.84 | 0 | 0.04 | 0 |
| S10 | | | factor 3, subunit A | | | No. 175 | | | | |
| CG10754 | CS3 &CS4 | SF3A2 | Splicing factor 3a, subunit 2, | 8175 | 37462_i_at | SEQ ID | −0.84 | −0.09 | 0.1 | 0.02 |
| | | | 66 kDa | | | No. 176 | | | | |
| CG6015 | CS3 &CS4 | CDC40 | Cell division cycle 40 homolog | 51362 | 203376_at | SEQ ID | −0.93 | 0 | 0.09 | −0.09 |
| | | | (S. cerevisiae) | | | No. 177 | | | | |
| Bub3 | CS2 | BUB3 | BUB3 budding uninhibited by | 9184 | 201456_s_at | SEQ ID | −0.96 | −0.03 | 0.1 | −0.08 |
| | | | benzimidazoles 3 homolog | | | No. 178 | | | | |
| | | | (yeast) | | | | | | | |
| SMC1 | CA | SMC1A | Structural maintenance of | 8243 | 239688_at | SEQ ID | −1.01 | −0.21 | — | — |
| | | | chromosomes 1A | | | No. 179 | | | | |
| CG6197 | CA | XAB2 | XPA binding protein 2 | 56949 | 218110_at | SEQ ID | −1.05 | −0.1 | 0.12 | 0.11 |
| | | | | | | No. 180 | | | | |
| U2A | CS3 & CS4 | SNRPA1 | Small nuclear ribonucleoprotein | 6627 | 242146_at | SEQ ID | −1.11 | 0.06 | — | — |
| | | | polypeptide A′ | | | No. 181 | | | | |
| Mtor | CA | TPR | Translocated promoter region (to | 7175 | 228709_at | SEQ ID | −1.16 | −0.03 | — | — |
| | | | activated MET oncogene) | | | No. 182 | | | | |
| CG8233 | CS3 & CS4 | KIAA1310 | KIAA1310 | 55683 | 220950_s_at | SEQ ID | −1.18 | −0.18 | 0.09 | 0.09 |
| | | | | | | No. 183 | | | | |
| CG6876 | CS3 & CS4 | PRPF31 | PRP31 pre-mRNA processing | 26121 | 214380_at | SEQ ID | −1.19 | 0.17 | −0.04 | 0.01 |
| | | | factor 31 homolog (S. cerevisiae) | | | No. 184 | | | | |
| Cap | CC1 | SMC3 | Structural maintenance of | 9126 | 209259_s_at | SEQ ID | −1.26 | −0.04 | −0.09 | −0.09 |
| | | | chromosomes 3 | | | No. 185 | | | | |
| eIF3- | SA1 | EIF3A | Eukaryotic translation initiation | 8661 | 200597_at | SEQ ID | −1.36 | 0.06 | 0.14 | −0.03 |
| S10 | | | factor 3, subunit A | | | No. 186 | | | | |
| CG7003 | CA | MSH6 | MutS homolog 6 (E. coli) | 2956 | 211449_at | SEQ ID | −1.38 | −0.2 | 0.01 | 0.02 |
| | | | | | | No. 187 | | | | |
| CG8233 | CS3 & CS4 | KIAA1310 | KIAA1310 | 55683 | 223756_at | SEQ ID | −1.39 | −0.27 | — | — |
| | | | | | | No. 188 | | | | |
| Dcp-1 | CA | CASP7 | Caspase 7, apoptosis-related | 840 | 207181_s_at | SEQ ID | −1.47 | −0.11 | 0.15 | 0.14 |
| | | | cysteine peptidase | | | No. 189 | | | | |
| CG1939 | CA | DCAKD | Dephospho-CoA kinase domain | 79877 | 224522_s_at | SEQ ID | −1.54 | 0.17 | — | — |
| | | | containing | | | No. 190 | | | | |
| CG17293 | SA1 | WDR82 | WD repeat domain 82 | 80335 | 201934_at | SEQ ID | −1.55 | −0.1 | 0.24 | 0.02 |
| | | | | | | No. 191 | | | | |
| woc | CA | ZMYM4 | Zinc finger, MYM-type 4 | 9202 | 202049_s_at | SEQ ID | −1.58 | 0.01 | 0.1 | 0.1 |
| | | | | | | No. 192 | | | | |
| Cap | CC1 | SMC3 | Structural maintenance of | 9126 | 209257_s_at | SEQ ID | −1.62 | 0.18 | −0.1 | 0.04 |
| | | | chromosomes 3 | | | No. 193 | | | | |
| CG2807 | CS3 & CS4 | SF3B1 | Splicing factor 3b, subunit 1, | 23451 | 201071_x_at | SEQ ID | −1.63 | 0.16 | 0.03 | −0.02 |
| | | | 155 kDa | | | No. 194 | | | | |
| CG6480 | CA | FRG1 | FSHD region gene 1 | 2483 | 204145_at | SEQ ID | −1.69 | −0.19 | −0.13 | −0.01 |
| | | | | | | No. 195 | | | | |
| woc | CA | ZMYM4 | Zinc finger, MYM-type 4 | 9202 | 202050_s_at | SEQ ID | −1.69 | 0.14 | 0.15 | −0.03 |
| | | | | | | No. 196 | | | | |
| CG4266 | CS5 | SFRS15 | Splicing factor, arginine/serine- | 57466 | 222310_at | SEQ ID | −1.71 | −0.14 | −0.09 | −0.15 |
| | | | rich 15 | | | No. 197 | | | | |
| ik2 | SA1 | TBK1 | TANK-binding kinase 1 | 29110 | 218520_at | SEQ ID | −1.71 | 0.15 | −0.22 | −0.1 |
| | | | | | | No. 198 | | | | |
| tho2 | SA1 | THOC2 | THO complex 2 | 57187 | 212994_at | SEQ ID | −1.75 | −0.01 | −0.1 | 0.29 |
| | | | | | | No. 199 | | | | |
| CG6937 | SA3 | MKI67IP | MKI67 (FHA domain) | 84365 | 234167_at | SEQ ID | −1.76 | 0.44 | — | — |
| | | | interacting nucleolar | | | No. 200 | | | | |
| | | | phosphoprotein | | | | | | | |
| noi | CA | SF3A3 | Splicing factor 3a, subunit 3, | 10946 | 203818_s_at | SEQ ID | −1.92 | 0.02 | −0.03 | 0.17 |
| | | | 60 kDa | | | No. 201 | | | | |
| eIF3- | SA1 | EIF3A | Eukaryotic translation initiation | 8661 | 200596_s_at | SEQ ID | −1.95 | −0.09 | 0.09 | 0.34 |
| S10 | | | factor 3, subunit A | | | No. 202 | | | | |
| CG2807 | CS3 & CS4 | SF3B1 | Splicing factor 3b, subunit 1, | 23451 | 214305_s_at | SEQ ID | −2.14 | 0.13 | 0.1 | 0.11 |
| | | | 155 kDa | | | No. 203 | | | | |
| Mtor | CA | TPR | Translocated promoter region (to | 7175 | 201730_s_at | SEQ ID | −2.29 | −0.01 | 0.13 | −0.02 |
| | | | activated MET oncogene) | | | No. 204 | | | | |
| tho2 | SA1 | THOC2 | THO complex 2 | 57187 | 222122_s_at | SEQ ID | −2.29 | 0.06 | −0.23 | −0.03 |
| | | | | | | No. 205 | | | | |
| cdc2 | SA4 | CDC2 | Cell division cycle 2, G1 to S and | 983 | 231534_at | SEQ ID | −2.31 | −0.02 | — | — |
| | | | G2 to M | | | No. 206 | | | | |
| SMC1 | CA | SMC1A | Structural maintenance of | 8243 | 217555_at | SEQ ID | −2.31 | −0.11 | −0.05 | 0.06 |
| | | | chromosomes 1A | | | No. 207 | | | | |
| CG2807 | CS3 & CS4 | SF3B1 | Splicing factor 3b, subunit 1, | 23451 | 211185_s_at | SEQ ID | −2.57 | 0.08 | 0.06 | −0.03 |
| | | | 155 kDa | | | No. 208 | | | | |
| Cap | CC1 | SMC3 | Structural maintenance of | 9126 | 209258_s_at | SEQ ID | −2.62 | −0.09 | −0.2 | 0.26 |
| | | | chromosomes 3 | | | No. 209 | | | | |
| Dp | CA | TFDP2 | Transcription factor Dp-2 (E2F | 7029 | 226157_at | SEQ ID | −2.67 | 0.5 | — | — |
| | | | dimerization partner 2) | | | No. 210 | | | | |
| Su(var)2- | CA | PIAS1 | Protein inhibitor of activated | 8554 | 217864_s_at | SEQ ID | −2.71 | 0.13 | 0.05 | 0.36 |
| 10 | | | STAT, 1 | | | No. 211 | | | | |
| cul-4 | CA | CUL4B | Cullin 4B | 8450 | 202214_s_at | SEQ ID | −2.96 | 0.29 | −0.17 | 0.27 |
| | | | | | | No. 212 | | | | |
| woc | CA | ZMYM4 | Zinc finger, MYM-type 4 | 9202 | 202051_s_at | SEQ ID | −3.10 | −0.04 | 0.22 | −0.09 |
| | | | | | | No. 213 | | | | |
| CG2807 | CS3 &CS4 | SF3B1 | Splicing factor 3b, subunit 1, | 23451 | 201070_x_at | SEQ ID | −3.46 | 0.27 | 0.04 | 0.22 |
| | | | 155 kDa | | | No. 214 | | | | |
| Grip75 | SA2 | TUBGCP4 | Tubulin, gamma complex | 27229 | 213266_at | SEQ ID | −3.56 | 0.68 | 0.52 | −0.01 |
| | | | associated protein 4 | | | No. 215 | | | | |
| Su(var)2- | CA | PIAS1 | Protein inhibitor of activated | 8554 | 217862_at | SEQ ID | −3.84 | 0.45 | 0.09 | 0.35 |
| 10 | | | STAT, 1 | | | No. 216 | | | | |
| Su(var)2- | CA | PIAS1 | Protein inhibitor of activated | 8554 | 217863_at | SEQ ID | −4.30 | 0.2 | 0 | −0.15 |
| 10 | | | STAT, 1 | | | No. 217 | | | | |

The Affymetrix probesets associated with the DM signature genes are ranked according to their Cox z-score computed on the training dataset (Pawitan).
The contribution to the difference in score between poor and good prognosis patients in the other datesets is also reported.
The phenoclusters associated with the Drosophila genes [16] are abbreviated as follows:
CA, chromosome aberrations;
CC1, loss of sister chromatid cohesion in heterochromatin;
CC2 aberrant lateral chromosome condensation;
CC3, aberrant longitudinal chromosome condensation;
CS1, defective chromosome duplication;
CS2, precocious sister chromatid separation;
CS3 and CS4, lack of sister chromatid separation;
CS5, defective chromosome segregation during anaphase;
SA1, short spindles;
SA2, spindles with a low MT density;
SA3, poorly focused spindle poles;
SA4 miscellaneous spindle defects;
SC1, defective chromosome condensation and cytokinesis;
SC2, multiple mitotic defects;
SC1, defective in early cytokinesis;
SC2, defective in late cytokinesis.
The relative transcripts of the gene of the DM signature are also indicated according to their SEQ ID No.

Collectively, the genes in Table I constitute the DM signature. The remaining 34 Drosophila genes identified in the screen [16] were not included in the DM signature because they did not have an unambiguous human homologue in Homologene (Release 62).

The DM signature shares very few genes with pre-existing signatures. We considered the top-down 70-gene signature [3] and several bottom-up signatures based on various aspects of cancer biology: the Wound signature [5,6]: the ES signature [12]; the IGS signature [14] the Hypoxia signatures of Sung et al. [8] and Winter et al. [9]; the Proliferation signature of Starmans et al. [11]; the proliferation/immune response/RNA splicing (Module) signature [13] and the chromosomal instability (CIN) signature [15]. The number of genes that the DM signature shares with the 70-gene, ES, IGS, Wound and Hypoxia signatures is extremely small. The overlap is higher with the Module, Proliferation and CIN signatures, but none of these signatures shares more that 20% of its genes with the DM signature (Table III).

TABLE III
The DM signature shares very few genes
with other major cancer signatures

| | # of genes in | Genes in common |
|---|---|---|
| | the | with the DM |
| Signature | signature | signature |
| Module | 261 | 18 (6.9%) |
| CIN | 71 | 14 (19.7) |
| ES | 1029 | 14 (1.4%) |
| Wound | 371 | 6 (1.6%) |
| Proliferation | 52 | 6 (11.5%) |
| 70-gene | 61 | 2 (3.3%) |
| Hypoxia (Winter) | 92 | 2 (2.2%) |
| IGS | 175 | 2 (1.1%) |
| Hypoxia (Sung) | 126 | 1 (0.8%) |

Of the 108 human genes, 25 are included in the list of genes periodically expressed during the cell cycle in HeLa cells {pmid:12058064}, compared to 5.8 expected by chance (P=2.2E-10): therefore, as expected, the human orthologs of genes that display a mitotic phenotype in the fly tend to be regulated by the cell cycle also in human.

For each dataset and each signature the same analysis as the one shown in FIG. 1 was performed and the value of P log-rank was compared to that calculated for the DM signature. In agreement with previous studies, the vast majority of the signatures show a good predictive value in the majority of the datasets (FIG. 3). The signature DM has a higher performance (in terms of P-value in the log-rank test) when compared to all other signatures in the majority of datasets (FIG. 3). Further, the DM signature has a statistically significant predictive power in all datasets and the lower overall P-value.

### The Prognostic Value of the DM Signature

For assessment of the predictive power and robustness of the DM signature the authors used six publicly available breast cancer datasets: (i) NKI, which contains expression data from primary breast tumors for 295 consecutive, relatively young (age <52 yrs) patients [4]; (ii) Pawitan, which includes data from 159 consecutive breast cancer patients [20]; (iii) Miller, with data from 251 patients selected from a consecutive series based on the quality of the material [21]; (iv) Desmedt and (v) Wang, which contains expression data from 198 and 286 lymph-node negative, systemically untreated patients, respectively [22,23]; (vi) Sotiriou, which includes 189 invasive breast carcinomas [24]. Due to the presence of common samples, the authors merged the Desmedt and Sotiriou datasets into a single one and removed from it the patients that were also included in the Miller dataset. All datasets contain both ER-positive and ER-negative samples.

Although most of these gene expression data were generated using the same microarray platform, and could in principle be merged in a single dataset as recently described [13], the authors evaluated the DM signature on the individual datasets. The authors chose this approach because the robustness of a gene signature on independent datasets is an important criterion for validation of its predictive power. In the authors' prognostic power analysis, they used relapse-free survival times when available, or overall survival times otherwise. Because three genes of the DM signature (H3F3A, PPAN-P2RY11 and KIF4) were not represented in the Affymetrix platform, the authors performed their analyses on 105 genes. For each dataset, patients were divided into two groups based on the expression profiles of the genes in the DM signature using hierarchical clustering. Differences in survival probability between the two groups were then evaluated with a standard log-rank test on Kaplan-Meier curves. FIG. 1 shows that the differences in survival are statistically significant for all datasets considered.

As mentioned above, the DM signature contains two broad classes of genes, namely 72 mitotic genes (71 in platform) and 36 genes required for the maintenance of chromosome integrity (34 in platform). To determine the relative contribution of these two gene classes to the predictive power of the DM signature, the authors performed the analysis using the two categories of genes separately. Both gene groups turned out to be independently predictive of survival (FIG. 2). However the predictive power of the global signature was higher in all cases.

The authors also asked whether the DM signature is predictive of survival in other tumors besides breast cancer. Using the hierarchical clustering approach described above, the authors found that the DM signature is predictive of survival in a large lung cancer dataset [18] (P=3e-6, FIG. 6) and in a glioma dataset [19] (P=0.0170, FIG. 7). However, the DM signature is not significantly predictive in other lung cancer [27] and glioma [28] datasets, or in renal [29] and ovarian [27] cancer datasets. The p-values of the log-rank tests for non-breast datasets are reported in Table IV.

TABLE IV
Predictive power of the DM signature in cancers other than breast.
The p-values obtained from the log-rank test when comparing the
cumulative probability of survival of clusters of patients
in other types of cancer.

| dataset | Log (p-value) |
|---|---|
| Glioma (Freije) | 1.77** |
| Glioma (Phillips) | 0.27* |
| Lung (Bild) | 0.21* |
| Lung (Shedden) | 3.52*** |
| Ovarian (Bild) | 0.57* |
| Renal (Zhao) | 1.12* |

*P > 0.05
**0.05 > P > 0.01
***P < 0.01

### Evaluation of a Prognostic Score for the DM Signature

Subdivision of patients into risk groups using the unsupervised clustering-based approach described above allows assessment of the predictive power of a gene signature, but does not allow specificity (fraction of low-risk patients correctly classified) and sensitivity (fraction of high-risk patients correctly classified) to be tuned according to specific requirements. However, such tuning is important in clinical applications, because the misclassification of a high-risk patient is potentially more harmful than the misclassification of a low-risk patient. Indeed, the 70-gene signature [3], which is used in clinical practice, assigns a risk score to each patient; patients are then classified based on a score threshold that can be tuned to obtain the desired compromise between specificity and sensitivity. Scalable prognostic scores, each computed from gene expression data with a specific algorithm, have been previously defined also for the Wound [6], IGS [14], Proliferation [11], CIN [15] and Hypoxia [9] signatures.

The authors determined a scalable prognostic score for the DM signature, using a procedure similar to that employed by Wang and co-workers [22]. The authors define the DM prognostic score as the sum of the logarithmic expression values of the signature genes, each multiplied by its z-score. The Cox z-score measures the correlation between the expression pattern of a gene and survival of the patient. A positive (negative) z-score indicates negative (positive) correlation between the gene expression level and patient's survival time.

The authors used the Pawitan dataset as training set and computed the Cox z-scores for the Affymetrix probesets associated to the DM signature (the z-scores of all probesets are shown in Table II). The distribution of these z-scores is consistently shifted towards positive values compared to the distribution of the z-scores of all genes represented on the microarrays (P-values between 1.1e-6 and 3.3e-15 from one-sided Mann-Whitney U test) (FIG. 4). Thus, as expected for proliferation-related genes, for most genes in the DM signature an increased expression level is negatively correlated with survival.

The authors then compared the DM signature score with the scores of 6 other scalable signatures for performance in predicting cancer outcome at 5 years. For this analysis the authors used ROC curves generated with the Affymetrix datasets not employed for training (Miller, Sotiriou-Desmedt and Wang). The scores of the CIN [15], Proliferation [11], 70-gene [3], Wound [6], IGS [14], and Hypoxia [9] signatures were computed as described in the respective references, after mapping the genes to the Affymetrix platform (see Methods for details). As shown in FIG. 5, the predictive power of the 3 proliferation-based signatures (DM, CIN and Proliferation), measured by the Area Under ROC Curves (AUC), is very similar in all datasets and systematically higher than that of the 70-gene, Wound, IGS, or Hypoxia signature.

Since the DM signature and the two other proliferation-based signatures perform similarly in predicting outcome at 5 years, as shown by the AUC values in FIG. 5, the authors compared their performance in greater detail at three values of the sensitivity (percentage of poor-outcome patients that are classified correctly by the signature). The results are shown in Tab. V.

TABLE V
Comparison of the performance of the proliferation-based signatures

| | DM | | CIN | | Proliferation | |
|---|---|---|---|---|---|---|
| | P value | Spec. | P value | Spec. | P value | Spec. |
| 90% sensitivity | | | | | | |
| Miller | 2.26E−04 | 0.318 | 5.44E−04 | 0.352 | 4.89E−04 | 0.352 |
| Sotiriou- | 4.44E−03 | 0.335 | 0.0312 | 0.329 | 0.0124 | 0.329 |
| Desmedt | | | | | | |
| Wang | 4.08E−03 | 0.226 | 0.0114 | 0.260 | 0.015 | 0.227 |
| 70% sensitivity | | | | | | |
| Miller | 1.77E−04 | 0.614 | 7.63E−03 | 0.523 | 3.02E−03 | 0.562 |
| Sotiriou- | 4.51E−04 | 0.613 | 4.25E−04 | 0.600 | 1.24E−03 | 0.574 |
| Desmedt | | | | | | |
| Wang | 4.25E−04 | 0.547 | 5.58E−04 | 0.547 | 1.19E−03 | 0.536 |
| 50% sensitivity | | | | | | |
| Miller | 3.91E−04 | 0.733 | 8.81E−04 | 0.705 | 1.42E−03 | 0.716 |
| Sotiriou- | 0.138 | 0.697 | 0.134 | 0.722 | 0.161 | 0.690 |
| Desmedt | | | | | | |
| Wang | 6.85E−03 | 0.669 | 2.41E−03 | 0.691 | 0.022 | 0.641 |

Tab. V reports for each signature and each dataset the specificity (percentage of correct classifications among patients classified as poor-outcome), and the P-value of the log-rank test between the two groups of patients. These two parameters have different interpretations: while the specificity refers to the ability of the signature to predict the outcome specifically at the 5-years endpoint, the P-value takes into account the complete survival data, and thus measures the ability to stratify the patients over the whole time range.

The results show that the DM and CIN signatures tend to perform better than the Proliferation one at all tested sensitivity values. DM performs slightly better than CIN at higher sensitivities, especially in terms of P-value. These differences in performance between the three signatures are driven by percentages of discordantly classified patients ranging from ˜2% to ˜10%. The number of discordantly classified patients in the three datasets is reported in Table VI.

TABLE VI
Cox multivariate analysis for various breast cancer datasets.
The DM score is a predictor of survival independent of clinical
and histological parameters commonly used in patient
stratification. The table shows the odd-ratio and P-value
obtained from a Cox multivariate analysis of survival including
the DM score and several other predictors of survival as covariates.

| | | |
|---|---|---|
| | Odd ratio | |
| Covariate | (95% C.I.) | P-value |

NKI dataset

| | | |
|---|---|---|
| DM score (range 0-10) | 1.27 (1.13-1.43) | 9.84E−005 |
| ER (pos = 1, neg = 0) | 0.56 (0.33-0.96) | 0.036 |
| St Gallen (1 = low risk, 0-high risk) | 0.33 (0.04-2.51) | 0.28 |
| LN (positive = 1, negative = 0) | 0.84 (0.53-1.32) | 0.45 |
| NIH (1 = low risk, 0-high risk) | 0.60 (0.08-4.52) | 0.62 |

Sotiriou-Desmedt dataset

| | | |
|---|---|---|
| DM score (range 0-10) | 1.25 (1.08-1.46) | 3.00E−003 |
| Size (cm) | 1.23 (0.97-1.57) | 0.093 |
| Grade (1-3) | 0.79 (0.56-1.09) | 0.15 |
| ER (pos = 1, neg = 0) | 1.16 (0.67-2.00) | 0.58 |
| Age (years) | 1.00 (0.97-1.02) | 0.72 |
| LN (positive = 1, negative = 0) | 1.13 (0.34-3.74) | 0.84 |

Wang dataset

| | | |
|---|---|---|
| DM score (range 0-10) | 1.23 (1.09-1.38) | 9.80E−004 |
| ER (pos = 1, neg = 0) | 1.31 (0.81-2.11) | 0.27 |

The authors also performed multivariate Cox analysis to ascertain whether the DM score predicts survival independently of other molecular and histological tumor markers. In all datasets, the DM score is a predictor independent of the available clinical parameters. The results for the Miller dataset, which is the richest in clinical annotation, are reported in Table VII, and the ones for the other datasets in Tables VIII.

TABLE VII
Multivariate Cox analysis for Miller dataset

| Covariate | Odd ratio (95% C.I.) | P-value |
|---|---|---|
| LN (positive = 1, negative = 0) | 2.82 (1.53-5.21) | 8.95E−04 |
| DM score (range 0-10) | 1.32 (1.08-1.60) | 0.0057 |
| Size (mm) | 1.04 (1.01-1.06) | 0.0065 |
| ER (positive = 1, negative = 0) | 3.34 (1.11-10.00) | 0.031 |
| Age (years) | 1.02 (1.00-1.04) | 0.057 |
| PGR (positive = 1, negative = 0) | 0.53 (0.23-1.23)) | 0.14 |
| P53 (mutant = 1, wt = 0) | 0.97 (0.49-1.95)) | 0.95 |
| Grade (1-3) | 0.99 (0.56-1.75) | 0.96 |

Multivariate Cox analysis for the Miller dataset shows that the DM score is predictive of survival independently of several other predictors.

TABLE VIII
Number of patients discordantly classified by the three
proliferation-based signatures. For each dataset and pair
of proliferation-based signatures, the authors report the
number of patients classified in different outcome groups,
using score cutoffs corresponding to the same sensitivity.

| | | |
|---|---|---|
| DM | CIN | Proliferation |

90% sensitivity

| | | | |
|---|---|---|---|
| DM | 0 | 20 (7.25%) | 24 (8.7%) |
| CIN | | 0 | 14 (5.1%) |
| Proliferation | | | 0 |

70% sensitivity

| | | | |
|---|---|---|---|
| DM | 0 | 24 (8.7%) | 30 (10.9%) |
| CIN | | 0 | 24 (8.7%) |
| Proliferation | | | 0 |

50% sensitivity

| | | | |
|---|---|---|---|
| DM | 0 | 10 (3.62%) | 23 (8.33%) |
| CIN | | 0 | 21 (7.61%) |
| Proliferation | | | 0 |

Multivariate Cox analysis on the Miller dataset using the other proliferation-based signatures gives very similar results, shown in Table IX.

TABLE IX
Cox multivariate analysis for other proliferation-based signatures.
For the CIN and proliferation signature we report the results of the
Cox multivariate analysis using the signature score and various
other predictors of survival as covariates.

| | | |
|---|---|---|
| Covariate | Odd ratio (95% C.I.) | P-value |

CIN signature

| | | |
|---|---|---|
| LN | 2.86 (1.54-5.29) | 8.64E−004 |
| Size | 1.04 (1.01-1.06) | 5.09E−003 |
| CIN score | 1.26 (1.07-1.49) | 6.29E−003 |
| ER | 3.26 (1.09-9.74) | 0.034 |
| Age | 1.02 (1.00-1.04) | 0.055 |
| PGR | 0.54 (0.23-1.26) | 0.16 |
| Grade | 1.01 (0.57-1.79) | 0.98 |
| P53 | 1.00 (0.51-1.99) | 0.99 |

Proliferation signature

| | | |
|---|---|---|
| LN | 2.78 (1.51-5.15) | 1.08E−003 |
| Size | 1.04 (1.01-1.07) | 5.00E−003 |
| Proliferation score | 1.28 (1.07-1.53) | 6.65E−003 |
| ER | 3.39 (1.13-10.19) | 0.03 |
| Age | 1.02 (1.00-1.04) | 0.072 |
| PGR | 0.53 (0.23-1.24) | 0.14 |
| P53 | 0.97 (0.49-1.93) | 0.93 |
| Grade | 0.98 (0.55-1.75) | 0.95 |

Lymph-node negative patients are a group of particular clinical significance: therefore the authors computed the AUC under ROC curves for the DM signature as a predictor of 5-year survival in the Miller and Sotiriou-Desmedt datasets limited to this subgroup. In both cases the authors find AUC values similar to the ones found for the entire dataset (AUC resp. 0.616 and 0.678). The Wang dataset includes lymph-node negative patients only.

### Contribution of Specific Genes and Gene Classes to the Predictive Power of the DM Signature.

The authors next asked whether any of the phenotypic class identified by the RNAi screen (chromosome condensation, chromosome integrity, chromosome segregation, spindle assembly and cytokinesis) [6] is especially relevant in separating poor- from good-prognosis patients. The authors computed the contribution of each probeset in the DM signature to the difference in score between poor- and good-outcome patients (see Methods); the authors then compared the contribution of specific gene classes to the total score of the 105 genes of the DM signature. For the three Affymetrix datasets not used as training, the cytokinesis genes (ANLN, CIT, ECT2, KIF23, PRC1, RACGAP1) turned out to contribute, as a group, significantly more than other genes to the difference in score (P-values between 0.0025 and 0.012, two-sided Mann-Whitney U test). The function of these genes is highly conserved, as they are required for cytokinesis in both Drosophila and humans (reviewed in [30]). Interestingly, high z-scores were also observed for ASPM, KIF18A and PLK1 (respectively, 3.99, 3.49 and 3.14). The Drosophila homologues of these genes (asp, Klp67 and polo) play role in multiple mitotic stages and are required for cytokinesis [30]. In addition there is evidence that ASPM and PLK1 are involved in human cell cytokinesis [30]. Thus, it appears that cytokinesis genes have higher prognostic value than other mitotic genes and genes required for chromosome integrity.

In the DM signature, there are a few genes whose reduced expression is negatively correlated with survival (Table II). The gene with the most negative z-score is PIAS1 (z=−4.07, averaged on two probesets), an E3 ligase involved in sumoylation of DNA repair proteins including BRCA1 [31]. Remarkably, the expression of this gene is substantially reduced in colon cancers [32].

The authors have shown that the DM signature is highly predictive of survival in five major breast cancer datasets. The DM signature contains two classes of genes required for cell proliferation: genes that maintain the integrity of mitotic chromosomes and genes that mediate mitotic division. Cell proliferation-associated genes have been previously used to construct several unsupervised signatures, and large subsets of this type of genes are included in most supervised signatures [33]. Thus, it has been suggested that genes required for cell proliferation may underlie the prognostic power of many cancer signatures [33].

In agreement with such expectations the authors found that the DM signature has a predictive power for breast cancer outcome similar to two other proliferation-based signatures (the CIN signature [15] and the Proliferation signature of Starmans et al. [11]), and outperforms 4 additional published signatures that contain different proportions of proliferation-related genes, including the supervised 70-gene signature, which is currently used in clinical practice for breast cancer patients [3]. Altogether, these results indicate that signatures enriched in proliferation genes are the most powerful predictors of breast cancer outcome.

High performance of the DM signature may reflect its specifically high content in genes truly involved in cell proliferation. The proliferation-associated genes in the other signatures have been selected on the basis of their periodic expression pattern during the cell cycle and include several genes that, although periodically expressed, are not involved in basic cell cycle processes [10,33]. In contrast, genes underlying either the maintenance of chromosome integrity or mitosis are expected to play essential roles in cell cycle progression and cell proliferation. Thus the DM signature is a strong predictor of survival in breast cancer because it contains a relatively undiluted sample of genes essential for cell proliferation. The expression of these genes should therefore reflect the cell proliferation rate within a cancer better than the gene sets of the other signatures. Consistent with this idea, the authors have shown that most of the DM signature genes with a high predictive power of poor outcome in patients display increased expression (FIG. 4).

The frequency of mitotic cells is one of the criteria used to classify breast cancers in low versus high grade. However, cytological analysis of mitosis proved to be a rather subjective assay with significant inter-observer variations [34]. The analysis of gene expression using the DM signature provides reliable quantitative information on cell proliferation within a breast cancer sample, allowing risk assessments in individual patients.

The authors have shown that a group of genes required for cytokinesis (ANLN, CIT, ECT2, KIF23, PRC1, RACGAP1, ASPM, KIF18A and PLK1) contributes to the predictive power of the DM signature significantly more than the other genes in the signature. All cytokinesis genes display high positive z-scores, indicating that an increased expression level of these genes is negatively correlated with survival. Strikingly, there is evidence that ANLN, ECT2, PRC1, RACGAP1, ASPM, and PLK1 are upregulated in a variety of human cancers and that the overexpression levels of these genes often correlate with poor outcomes in patients (see for example [35-43] and references therein). In addition, it has been shown that two of these cytokinesis genes, ETC2 and ANLN, are amplified in cancer cells [38,44]. These findings raise the questions of why cytokinesis genes have a higher prognostic value and tend to be more upregulated in cancers compared to other mitotic genes. It is possible that overexpression of cytokinesis genes is an oncogenic factor per se. However, the finding that PRC1 overexpression does not result in cell growth enhancement [41] argues against this possibility. Another possibility is that cytokinesis proteins are limited in amount or stability compared to other mitotic proteins. That is, when cell proliferation is strongly enhanced, normal levels of gene transcription and translation would not be sufficient to produce the amounts of cytokinesis proteins required for proper execution of the process. As a result, cancers cell clones overexpressing cytokinesis genes would be favoured over clones in which these genes are normally expressed.

In conclusion, the present invention indicates that the DM signature improves risk stratification for breast cancer patients compared to the major extant signatures. In addition, the identification of new cancer prognostic genes with well-defined biological functions, such as those of the DM signature, provides new prognostic tools based on gene expression. For example, according to a previous approach [6,11,13] the genes of the DM signature could be merged with those of other signatures to further improve risk stratification. Finally, the authors' finding that cytokinesis genes tend to be overexpressed in patients with poor prognosis sets forth this class of genes and their protein products as targets for antimitotic therapies.

### REFERENCES

1. Dupuy A, Simon R M (2007) J Natl Cancer Inst 99: 147-157.
2. Wirapati P, et al. (2008) Breast Cancer Res 10: R65.
3. van't Veer L J, et al. (2002) Nature 415: 530-536.
4. van de Vijver M J, et al. (2002) N Engl J Med 347: 1999-2009.
5. Chang H Y, et al. (2004) PLoS Biol 2: E7.
6. Chang H Y, et al. (2005) Proc Natl Acad Sci USA 102: 3738-3743.
7. Chi J T, et al. (2006) PLoS Med 3: e47.
8. Sung F L, et al. (2007) Cancer Lett 253: 74-88.
9. Winter S C, et al. (2007) Cancer Res 67: 3441-3449.
10. Whitfield M L, et al. (2002) Mol Biol Cell 13: 1977-2000.
11. Starmans M H, et al. (2008) Br J Cancer 99: 1884-1890.
12. Ben-Porath I, et al. (2008) Nat Genet 40: 499-507.
13. Reyal F, et al. (2008) Breast Cancer Res 10: R93.
14. Liu R, et al. (2007) N Engl J Med 356: 217-226.
15. Carter S L, et al. (2006) Nat Genet 38: 1043-1048.
16. Somma M P, et al. (2008) PLoS Genet 4: e1000126.
17. Sayers E W, et al. (2010) Nucleic Acids Res 38: D5-16.
18. Shedden K, et al. (2008) Nat Med 14: 822-827.
19. Phillips H S, et al. (2006) Cancer Cell 9: 157-173.
20. Pawitan Y, et al. (2005) Breast Cancer Res 7: R953-964.
21. Miller L D, et al. (2005) Proc Natl Acad Sci USA 102: 13550-13555.
22. Wang Y, et al. (2005) Lancet 365: 671-679.
23. Desmedt C, et al. (2007) Clin Cancer Res 13: 3207-3214.
24. Sotiriou C, et al. (2006) JNatl Cancer Inst 98: 262-272.
25. Wilson C L, Miller C J (2005) Bioinformatics 21: 3683-3685.
26. Gentleman R C, et al. (2004) Genome Biol 5: R80.
27. Bild A H, et al. (2006) Nature 439: 353-357.
28. Freije W A, et al. (2004) Cancer Res 64: 6503-6510.
29. Zhao H, et al. (2006) PLoS Med 3: e13.
30. Eggert U S, Mitchison T J, Field C M (2006) Annu Rev Biochem 75: 543-566.
31. Galanty Y, et al. (2009) Nature 462: 935-939.
32. Coppola D, et al. (2009) J Cancer Res Clin Oncol 135: 1287-1291.
33. Whitfield M L, George L K, Grant G D, Perou C M (2006) Nat Rev Cancer 6: 99-106.
34. Paik S, et al. (2004) N Engl J Med 351: 2817-2826.
35. Suzuki C, et al. (2005) Cancer Res 65: 11314-11325.
36. Tamura K, et al. (2007) Cancer Res 67: 5117-5125.
37. Skrzypski M, et al. (2008) Clin Cancer Res 14: 4794-4799.
38. Fields A P, Justilien V (2009) Adv Enzyme Regul.
39. Horvath S, et al. (2006) Proc Natl Acad Sci USA 103: 17402-17407.
40. Lin S Y, et al. (2008) Clin Cancer Res 14: 4814-4820.
41. Shimo A, et al. (2007) Cancer Sci 98: 174-181.
42. Pellegrino R, et al. (2009) Hepatology.
43. Schmit T L, et al. (2009) J Invest Dermatol 129: 2843-2853.
44. Shimizu S, et al. (2007) Oncol Rep 18: 1489-1497.

1. A method to predict the mortality risk of a subject (p) affected of breast cancer comprising:
a) measuring the expression level of the genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT in a biological sample, obtaining the prognostic score, S(p), that indicates the expression levels of said genes in said subject (p) affected of cancer, and
b) predicting the mortality risk of said subject (p) affected of cancer comparing said prognostic score, S(p), to a cut off value (cut off threshold).

2. The method according to claim 1 wherein the expression level of said genes is measured by means of quantitative detection of the transcript sequences selected from the group consisting of SEQ ID No 1 to SEQ ID No. 217.

3. The method according to claim 1 wherein the expression level of said genes is detected by means of microarray.

4. The method according to claim 1 wherein the biological sample is selected from the group consisting of blood, tumour cell, frozen or fixed tissue sections, biopsy, and biological fluids.

5. The method according to claim 1 wherein the mortality risk is assigned as follows:
i) to the class “low risk” if the prognostic score, S(p), is lower than the cut off threshold, or
ii) to the class “high risk” if the prognostic score, S(p), is greater than the cut off threshold, and optionally
iii) to the class “intermediate” if the prognostic score, S(p), is between two cut off threshold values.

6. The method according to claim 1 wherein the prognostic score, S(p), is calculated according to the following formula:
S(p)=Σ_{g}x(g,p)z(g)
wherein
x(g,p) is the expression level expressed in logarithmic base 2 of the probeset gin the patient p;
z(g) is the z-score of the probeset g calculated in the Pawitan dataset;
wherein the probeset g comprises a group of 217 probes, each one being specific and selective for one of the gene transcript belonging to the group consisting of SEQ ID No. 1 to SEQ ID No. 217.

7. The method according to claim 6 wherein the z-score for each probe is the one calculated in the Pawitan database reported in table II.

8. A kit to detect the transcript expression level of genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT,
comprising:
for each of said genes, sequence specific amplification means to obtain amplified nucleic acids having sequences comprised in the transcribed region thereof;
quantitative detection means of said amplified nucleic acids; and
appropriate reagents.

9. The kit according to claim 8 wherein said amplified nucleic acids consist of:
for C15orf44, SEQ ID No. 145; for CASP7, SEQ ID No. 189; for CNOT3, SEQ ID No. 66 and/or SEQ ID No. 138 and/or SEQ ID No. 167; for CTPS, SEQ ID No. 39; for CUL4B, SEQ ID No. 113 and/or SEQ ID No. 152 and/or SEQ ID No. 165 and/or SEQ ID No. 212; for CWC15, SEQ ID No. 159; for DCAKD, SEQ ID No. 126 and/or SEQ ID No. 140 and/or SEQ ID No. 190; for DDB1, SEQ ID No. 38; for FRG1, SEQ ID No. 195; for MSH6, SEQ ID No. 46 and/or SEQ ID No. 61 and/or SEQ ID No. 153 and/or SEQ ID No. 187; for ORC5L, SEQ ID No. 70 and/or SEQ ID No. 79 and/or SEQ ID No. 109; for PCNA, SEQ ID No. 51; for PIAS1, SEQ ID No. 211 and/or SEQ ID No. 216 and/or SEQ ID No. 217; for POLA1, SEQ ID No. 147; for PRIM2, SEQ ID No. 43 and/or SEQ ID No. 56 and/or SEQ ID No. 88; for PRPF3, SEQ ID No. 170; for RAD54L, SEQ ID No. 75; for RFC2, SEQ ID No. 42 and/or SEQ ID No. 48; for RPA1, SEQ ID No. 64 and/or SEQ ID No. 103; for RRM2, SEQ ID No. 3 and/or SEQ ID No. 9; for SART1, SEQ ID No. 124; for SF3A3, SEQ ID No. 201; for SMC1A, SEQ ID No. 115 and/or SEQ ID No. 179 and/or SEQ ID No. 207; for TAF6, SEQ ID No. 68;
for TFDP2, SEQ ID No. 86 and/or SEQ ID No. 118 and/or SEQ ID No. 210; for TK2, SEQ ID No. 37 and/or SEQ ID No. 156 and/or SEQ ID No. 171 and/or SEQ ID No. 172; for TPR, SEQ ID No. 99 and/or SEQ ID No. 108 and/or SEQ ID No. 182 and/or SEQ ID No. 204; for TYMS, SEQ ID No. 32 and/or SEQ ID No. 125; for WBP11, SEQ ID No. 65 and/or SEQ ID No. 67; for WDR46, SEQ ID No. 93; for WDR75, SEQ ID No. 158; for XAB2, SEQ ID No. 180; for XRN2, SEQ ID No. 81 and/or SEQ ID No. 84; for ZMYM4, SEQ ID No. 192 and/or SEQ ID No. 196 and/or SEQ ID No. 213; for MCM3, SEQ ID No. 34; for MCM7, SEQ ID No. 28 and/or SEQ ID No. 52; for SMC3, SEQ ID No. 185 and/or SEQ ID No. 193 and/or SEQ ID No. 209; for NCAPD2, SEQ ID No. 106; for NCAPG, SEQ ID No. 22 and/or SEQ ID No. 24; for SMC4, SEQ ID No. 33 and/or SEQ ID No. 54 and/or SEQ ID No. 141; for SMC2, SEQ ID No. 45 and/or SEQ ID No. 127; for MASTL, SEQ ID No. 11; for ORC2L, SEQ ID No. 104; for TOP2A, SEQ ID No. 20 and/or SEQ ID No. 62 and/or SEQ ID No. 96; for CDT1, SEQ ID No. 2 and/or SEQ ID No. 36; for BUB3, SEQ ID No. 57 and/or SEQ ID No. 139 and/or SEQ ID No. 148 and/or SEQ ID No. 174 and/or SEQ ID No. 178; for KNTC1, SEQ ID No. 35; for ZW10, SEQ ID No. 143; for ASCC3L1, SEQ ID No. 55 and/or SEQ ID No. 135 and/or SEQ ID No. 150; for CCNB1, SEQ ID No. 7 and/or SEQ ID No. 14; for CDC40, SEQ ID No. 100 and/or SEQ ID No. 177; for DHX8, SEQ ID No. 58 and/or SEQ ID No. 120 and/or SEQ ID No. 121; for KIAA1310, SEQ ID No. 160 and/or SEQ ID No. 183 and/or SEQ ID No. 188; for LSM2, SEQ ID No. 137; for PRPF31, SEQ ID No. 60 and/or SEQ ID No. 91 and/or SEQ ID No. 184; for SF3A1, SEQ ID No. 98 and/or SEQ ID No. 119 and/or SEQ ID No. 162 and/or SEQ ID No. 173; for SF3A2, SEQ ID No. 169 and/or SEQ ID No. 176; for SF3B1, SEQ ID No. 194 and/or SEQ ID No. 203 and/or SEQ ID No. 208 and/or SEQ ID No. 214; for SF3B2, SEQ ID No. 77; for SF3B14, SEQ ID No. 10; for SLU7, SEQ ID No. 149 and/or SEQ ID No. 151; for SNRPA1, SEQ ID No. 23 and/or SEQ ID No. 49 and/or SEQ ID No. 71 and/or SEQ ID No. 181; for SNRPE, SEQ ID No. 72 and/or SEQ ID No. 136; for TXNL4A, SEQ ID No. 26 and/or SEQ ID No. 134; for U2AF1, SEQ ID No. 30 and/or SEQ ID No. 82 and/or SEQ ID No. 102 and/or SEQ ID No. 131; for U2AF2, SEQ ID No. 94 and/or SEQ ID No. 146 and/or SEQ ID No. 155 and/or SEQ ID No. 161; for ANAPC5, SEQ ID No. 85 and/or SEQ ID No. 95 and/or SEQ ID No. 97 and/or SEQ ID No. 112 and/or SEQ ID No. 117; for ANAPC10, SEQ ID No. 129; for CDC20, SEQ ID No. 17; for KIN, SEQ ID No. 111 and/or SEQ ID No. 144; for PSMC1, SEQ ID No. 25; for SFRS15, SEQ ID No. 50 and/or SEQ ID No. 63 and/or SEQ ID No. 80 and/or SEQ ID No. 142 and/or SEQ ID No. 197; for CKAP5, SEQ ID No. 21; for EIF3A, SEQ ID No. 175 and/or SEQ ID No. 186 and/or SEQ ID No. 202; for EIF3D, SEQ ID No. 101; for EIF3E, SEQ ID No. 154; for EIF3I, SEQ ID No. 114; for GTF3C3, SEQ ID No. 74 and/or SEQ ID No. 163; for MAPRE3, SEQ ID No. 116 and/or SEQ ID No. 128 and/or SEQ ID No. 130 and/or SEQ ID No. 133; for NOC3L, SEQ ID No. 164; for RRP1B, SEQ ID No. 105 and/or SEQ ID No. 123; for TBK1, SEQ ID No. 198; for THOC2, SEQ ID No. 110 and/or SEQ ID No. 132 and/or SEQ ID No. 199 and/or SEQ ID No. 205; for TUBB2C, SEQ ID No. 4 and/or SEQ ID No. 5; for WDR82, SEQ ID No. 191; for TRRAP, SEQ ID No. 69 and/or SEQ ID No. 73; for TUBGCP4, SEQ ID No. 76 and/or SEQ ID No. 215; for TUBG2, SEQ ID No. 157; for ASPM, SEQ ID No. 6 and/or SEQ ID No. 47 and/or SEQ ID No. 53; for CENPJ, SEQ ID No. 87 and/or SEQ ID No. 92 and/or SEQ ID No. 107; for MKI671P, SEQ ID No. 41 and/or SEQ ID No. 89 and/or SEQ ID No. 200; for PPP1R8, SEQ ID No. 168; for CDC2, SEQ ID No. 15 and/or SEQ ID No. 16 and/or SEQ ID No. 31 and/or SEQ ID No. 206; for KIFC1, SEQ ID No. 19; for KIF11, SEQ ID No. 29; for KIF18A, SEQ ID No. 18; for AURKC, SEQ ID No. 90; for RBBP7, SEQ ID No. 166; for PLK1, SEQ ID No. 27; for ECT2, SEQ ID No. 40 and/or SEQ ID No. 59 and/or SEQ ID No. 83; for KIF23, SEQ ID No. 8 and/or SEQ ID No. 44; for PRC1, SEQ ID No. 13; for RACGAP1, SEQ ID No. 12; for ANLN, SEQ ID No. 1; for CIT, SEQ ID No. 78 and/or SEQ ID No. 122.

10. The kit according to claim 8 further comprising sequence specific amplification means to obtain amplified nucleic acids having sequences in the transcribed region of genes H3F3A and/or PPAN-P2RY11 and/or KIF4.

11. A microarray consisting of:
a) solid supporting means, and
b) for each of the genes C15orf44, CASP7, CNOT3, CTPS, CUL4B, CWC15, DCAKD, DDB1, FRG1, MSH6, ORC5L, PCNA, PIAS1, POLA1, PRIM2, PRPF3, RAD54L, RFC2, RPA1, RRM2, SART1, SF3A3, SMC1A, TAF6, TFDP2, TK2, TPR, TYMS, WBP11, WDR46, WDR75, XAB2, XRN2, ZMYM4, MCM3, MCM7, SMC3, NCAPD2, NCAPG, SMC4, SMC2, MASTL, ORC2L, TOP2A, CDT1, BUB3, KNTC1, ZW10, ASCC3L1, CCNB1, CDC40, DHX8, KIAA1310, LSM2, PRPF31, SF3A1, SF3A2, SF3B1, SF3B2, SF3B14, SLU7, SNRPA1, SNRPE, TXNL4A, U2AF1, U2AF2, ANAPC5, ANAPC10, CDC20, KIN, PSMC1, SFRS15. CKAP5, EIF3A, EIF3D, EIF3E, EIF3I, GTF3C3, MAPRE3, NOC3L, RRP1B, TBK1, THOC2, TUBB2C, WDR82, TRRAP, TUBGCP4, TUBG2, ASPM, CENPJ, MKI671P, PPP1R8, CDC2, KIFC1, KIF11, KIF18A, AURKC, RBBP7, PLK1, ECT2, KIF23, PRC1, RACGAP1, ANLN, CIT, at least one oligonucleotide able to specifically hybridize to a sequence in the transcribed region thereof.

12. The microarray according to claim 11 wherein the sequences comprised in the transcribed region of said genes consist of: for C15orf44, SEQ ID No. 145; for CASP7, SEQ ID No. 189; for CNOT3, SEQ ID No. 66 and/or SEQ ID No. 138 and/or SEQ ID No. 167; for CTPS, SEQ ID No. 39; for CUL4B, SEQ ID No. 113 and/or SEQ ID No. 152 and/or SEQ ID No. 165 and/or SEQ ID No. 212; for CWC15, SEQ ID No. 159; for DCAKD, SEQ ID No. 126 and/or SEQ ID No. 140 and/or SEQ ID No. 190; for DDB1, SEQ ID No. 38; for FRG1, SEQ ID No. 195; for MSH6, SEQ ID No. 46 and/or SEQ ID No. 61 and/or SEQ ID No. 153 and/or SEQ ID No. 187; for ORC5L, SEQ ID No. 70 and/or SEQ ID No. 79 and/or SEQ ID No. 109; for PCNA, SEQ ID No. 51; for PIAS1, SEQ ID No. 211 and/or SEQ ID No. 216 and/or SEQ ID No. 217; for POLA1, SEQ ID No. 147; for PRIM2, SEQ ID No. 43 and/or SEQ ID No. 56 and/or SEQ ID No. 88; for PRPF3, SEQ ID No. 170; for RAD54L, SEQ ID No. 75; for RFC2, SEQ ID No. 42 and/or SEQ ID No. 48; for RPA1, SEQ ID No. 64 and/or SEQ ID No. 103; for RRM2, SEQ ID No. 3 and/or SEQ ID No. 9; for SART1, SEQ ID No. 124; for SF3A3, SEQ ID No. 201; for SMC1A, SEQ ID No. 115 and/or SEQ ID No. 179 and/or SEQ ID No. 207; for TAF6, SEQ ID No. 68; for TFDP2, SEQ ID No. 86 and/or SEQ ID No. 118 and/or SEQ ID No. 210; for TK2, SEQ ID No. 37 and/or SEQ ID No. 156 and/or SEQ ID No. 171 and/or SEQ ID No. 172; for TPR, SEQ ID No. 99 and/or SEQ ID No. 108 and/or SEQ ID No. 182 and/or SEQ ID No. 204; for TYMS, SEQ ID No. 32 and/or SEQ ID No. 125; for WBP11, SEQ ID No. 65 and/or SEQ ID No. 67; for WDR46, SEQ ID No. 93; for WDR75, SEQ ID No. 158; for XAB2, SEQ ID No. 180; for XRN2, SEQ ID No. 81 and/or SEQ ID No. 84; for ZMYM4, SEQ ID No. 192 and/or SEQ ID No. 196 and/or SEQ ID No. 213; for MCM3, SEQ ID No. 34; for MCM7, SEQ ID No. 28 and/or SEQ ID No. 52; for SMC3, SEQ ID No. 185 and/or SEQ ID No. 193 and/or SEQ ID No. 209; for NCAPD2, SEQ ID No. 106; for NCAPG, SEQ ID No. 22 and/or SEQ ID No. 24; for SMC4, SEQ ID No. 33 and/or SEQ ID No. 54 and/or SEQ ID No. 141; for SMC2, SEQ ID No. 45 and/or SEQ ID No. 127; for MASTL, SEQ ID No. 11; for ORC2L, SEQ ID No. 104; for TOP2A, SEQ ID No. 20 and/or SEQ ID No. 62 and/or SEQ ID No. 96; for CDT1, SEQ ID No. 2 and/or SEQ ID No. 36; for BUB3, SEQ ID No. 57 and/or SEQ ID No. 139 and/or SEQ ID No. 148 and/or SEQ ID No. 174 and/or SEQ ID No. 178; for KNTC1, SEQ ID No. 35; for ZW10, SEQ ID No. 143; for ASCC3L1, SEQ ID No. 55 and/or SEQ ID No. 135 and/or SEQ ID No. 150; for CCNB1, SEQ ID No. 7 and/or SEQ ID No. 14; for CDC40, SEQ ID No. 100 and/or SEQ ID No. 177; for DHX8, SEQ ID No. 58 and/or SEQ ID No. 120 and/or SEQ ID No. 121; for KIAA1310, SEQ ID No. 160 and/or SEQ ID No. 183 and/or SEQ ID No. 188; for LSM2, SEQ ID No. 137; for PRPF31, SEQ ID No. 60 and/or SEQ ID No. 91 and/or SEQ ID No. 184; for SF3A1, SEQ ID No. 98 and/or SEQ ID No. 119 and/or SEQ ID No. 162 and/or SEQ ID No. 173; for SF3A2, SEQ ID No. 169 and/or SEQ ID No. 176; for SF3B1, SEQ ID No. 194 and/or SEQ ID No. 203 and/or SEQ ID No. 208 and/or SEQ ID No. 214; for SF3B2, SEQ ID No. 77; for SF3B14, SEQ ID No. 10; for SLU7, SEQ ID No. 149 and/or SEQ ID No. 151; for SNRPA1, SEQ ID No. 23 and/or SEQ ID No. 49 and/or SEQ ID No. 71 and/or SEQ ID No. 181; for SNRPE, SEQ ID No. 72 and/or SEQ ID No. 136; for TXNL4A, SEQ ID No. 26 and/or SEQ ID No. 134; for U2AF1, SEQ ID No. 30 and/or SEQ ID No. 82 and/or SEQ ID No. 102 and/or SEQ ID No. 131; for U2AF2, SEQ ID No. 94 and/or SEQ ID No. 146 and/or SEQ ID No. 155 and/or SEQ ID No. 161; for ANAPC5, SEQ ID No. 85 and/or SEQ ID No. 95 and/or SEQ ID No. 97 and/or SEQ ID No. 112 and/or SEQ ID No. 117; for ANAPC10, SEQ ID No. 129; for CDC20, SEQ ID No. 17; for KIN, SEQ ID No. 111 and/or SEQ ID No. 144; for PSMC1, SEQ ID No. 25; for SFRS15, SEQ ID No. 50 and/or SEQ ID No. 63 and/or SEQ ID No. 80 and/or SEQ ID No. 142 and/or SEQ ID No. 197; for CKAP5, SEQ ID No. 21; for EIF3A, SEQ ID No. 175 and/or SEQ ID No. 186 and/or SEQ ID No. 202; for EIF3D, SEQ ID No. 101; for EIF3E, SEQ ID No. 154; for EIF3I, SEQ ID No. 114; for GTF3C3, SEQ ID No. 74 and/or SEQ ID No. 163; for MAPRE3, SEQ ID No. 116 and/or SEQ ID No. 128 and/or SEQ ID No. 130 and/or SEQ ID No. 133; for NOC3L, SEQ ID No. 164; for RRP1B, SEQ ID No. 105 and/or SEQ ID No. 123; for TBK1, SEQ ID No. 198; for THOC2, SEQ ID No. 110 and/or SEQ ID No. 132 and/or SEQ ID No. 199 and/or SEQ ID No. 205; for TUBB2C, SEQ ID No. 4 and/or SEQ ID No. 5; for WDR82, SEQ ID No. 191; for TRRAP, SEQ ID No. 69 and/or SEQ ID No. 73; for TUBGCP4, SEQ ID No. 76 and/or SEQ ID No. 215; for TUBG2, SEQ ID No. 157; for ASPM, SEQ ID No. 6 and/or SEQ ID No. 47 and/or SEQ ID No. 53; for CENPJ, SEQ ID No. 87 and/or SEQ ID No. 92 and/or SEQ ID No. 107; for MKI671P, SEQ ID No. 41 and/or SEQ ID No. 89 and/or SEQ ID No. 200; for PPP1R8, SEQ ID No. 168; for CDC2, SEQ ID No. 15 and/or SEQ ID No. 16 and/or SEQ ID No. 31 and/or SEQ ID No. 206; for KIFC1, SEQ ID No. 19; for KIF11, SEQ ID No. 29; for KIF18A, SEQ ID No. 18; for AURKC, SEQ ID No. 90; for RBBP7, SEQ ID No. 166; for PLK1, SEQ ID No. 27; for ECT2, SEQ ID No. 40 and/or SEQ ID No. 59 and/or SEQ ID No. 83; for KIF23, SEQ ID No. 8 and/or SEQ ID No. 44; for PRC1, SEQ ID No. 13; for RACGAP1, SEQ ID No. 12; for ANLN, SEQ ID No. 1; for CIT, SEQ ID No. 78 and/or SEQ ID No. 122.

13. The microarray according to claim 11 further comprising at least one oligonucleotide able to specifically hybridize to a sequence in the transcribed region of genes H3F3A and/or PPAN-P2RY11 and/or KIF4.


SEQUENCE LISTING (217 sequences)

SEQ ID NO: 1 - DNA, 457 bp, Homo sapiens
  misc_feature (87)..(87): n is a, c, g, or t
catggtttacatttactcagctactatatatgcagtgtggtgcacattttcacagaattctggcttcattaagatcattatttttgnctgcgtagcttacagacttagcatattagttttttctactcctacaagtgtaaattgaaaaatctttatattaaaaaagtaaactgttatgaagctgctatgtactaataatactttgcttgccaaagtgtttgggttttgttgttgtttgtttgtttgtttgtttttggttcatgaacaacagtgtctagaaacccattttgaaagtggaaaattattaagtcacctatcacctttaaacgcctttttttaaaattataaaatattgtaaagcagggtctcaacttttaaatacactttgaacttcttctctgaattattaaagttctttatgacctcatttataaacactaaattctgtcacctcctg

SEQ ID NO: 2 - DNA, 115 bp, Homo sapiens
gccgcctactactactatacggctgcgagaagacgacagaagggactggcctctgcccacaccttgacttcagtatttctgacctcctaaactctaataaagtcatgcttacagc

SEQ ID NO: 3 - DNA, 375 bp, Homo sapiens
ttttaccttggatgctgacttctaaatgaactgaagatgtgcccttacttggctgattttttttttccatctcataagaaaaatcagctgaagtgttaccaactagccacaccatgaattgtccgtaatgttcattaacagcatctttaaaactgtgtagctacctcacaaccagtcctgtctgtttatagtgctggtagtatcaccttttgccagaaggcctggctggctgtgacttaccatagcagtgacaatggcagtcttggctttaaagtgaggggtgaccctttagtgagcttagcacagcgggattaaacagtcctttaaccagcacagccagttaaaagatgcagcctcactgcttcaacgcagatt

SEQ ID NO: 4 - DNA, 387 bp, Homo sapiens
  misc_feature (166)..(166): n is a, c, g, or t
ccaccttcattggcaacagcacggccatccaggagctgttcaagcgcatctccgagcagttcacggccatgttccggcgcaaggccttcctgcactggtacacgggcgagggcatggacgagatggagttcaccgaggccgagagcaacatgaatgacctggtgtncgagtaccagcagtaccaggatgccacagccgaggaggagggcgagttcgaggaggaggctgaggaggaggtggcctagagccttcagtcactggggaaagcagggaagcagtgtgaactctttattcactcccagcctgtcctgtggcctgtcccactgtgtgcacttgctgttttccctgtccacatccatgctgtacagacaccaccattaaagcatt

SEQ ID NO: 5 - DNA, 523 bp, Homo sapiens
ttcaggggccgcatgtccatgaaggaggtggatgagcaaatgcttaatgtccaaaacaaaaacagcagctattttgttgagtggatccccaacaatgtgaaaacggctgtctgtgacatcccacctcgggggctaaaaatgtccgccaccttcattggcaacagcacggccatccaggagctgttcaagcgcatctccgagcagttcacggccatgttccggcgcaaggccttcctgcactggtacacgggcgagggcatggacgagatggagttcaccgaggccgagagcaacatgaatgacctggtgtccgagtaccagcagtaccaggatgccacagccgaggaggagggcgagttcgaggaggaggctgaggaggaggtggcctagagccttcagtcactggggaaagcagggaagcagtgtgaactctttattcactcccagcctgtcctgtggcctgtcccactgtgtgcacttgctgttttccctgtccacatccatgctgtacagacaccaccat

SEQ ID NO: 6 - DNA, 516 bp, Homo sapiens
gttgtaatcgcagtattccttgtatggaagtcatcagatatgctgtgcaagtcttgcttaatgtatctaagtatgagaaaactacttcagcagtttatgatgtagaaaattgtatagatatactattggagcttttgcagatataccgagaaaagcctggtaataaagttgcagacaaaggcggaagcatttttacaaaaacttgttgtttgttggctattttactgaagacaacaaatagagcctctgatgtacgaagtaggtccaaagttgttgaccgtatttacagtctctacaaacttacagctcataaacataaaatgaatactgaaagaatactttacaagcaaaagaagaattcttctataagcattccttttatcccagaaacacctgtaaggaccagaatagtttcaagacttaagccagattgggttttgagaagagataacatggaagaaatcacaaatcccctgcaagctattcaaatggtgatggatacgcttggcattcctt

SEQ ID NO: 7 - DNA, 463 bp, Homo sapiens
  misc_feature (61)..(61): n is a, c, g, or t
tttgcacttccttcggagagcatctaagattggagaggttgatgtcgagcaacatactttngccaaatacctgatggaactaactatgttggactatgacatggtgcactttcctccttctcaaattgcagcaggagctttttgcttagcactgaaaattctggataatggtgaatggacaccaactctacaacattacctgtcatatactgaagaatctcttcttccagttatgcagcacctggctaagaatgtagtcatggtaaatcaaggacttacaaagcacatgactgtcaagaacaagtatgccacatcgaagcatgctaagatcagcactctaccacagctgaattctgcactagttcaagatttagccaaggctgtggcaaaggtgtaacttgtaaacttgagttggagtactatatttacaaataaaattggcaccatgtgccatctgtacata

SEQ ID NO: 8 - DNA, 487 bp, Homo sapiens
gatgatttctcgaaagccatgccagaagcagtcttccaggtcatcttgtagaactccagctttgttgaaaatcacggacctcagctacatcatacactgacccagagcaaagctttccctatggttcaaagacaactagtattcaacaaaccttgtatagtgtatgttttgccatatttaatattaatagcagaggaagactccttttttcatcactgtatgaattttttataatgtttttttaaaatatatttcatgtatacttataaactaattcacacaagtgtttgtcttagatgattaaggaagactatatctagatcatgtctgattttttattgtgacttctccagccctggtctgaatttcttaaggttttataaacaaatgctgctatttattagctgcaagaatgcactttagaactatttgacaattcagactttcaaaataaagatgtaaatgactggccaataataaccatttt

SEQ ID NO: 9 - DNA, 378 bp, Homo sapiens
gctactttgaattaatctgcctttatgtttgggagaagaaagctgagacattgcatgaaagatgatgagagataaatgttgatcttttggccccatttgttaattgtattcagtatttgaacgtcgtcctgtttattgttagttttcttcatcatttattgtatagacaatttttaaatctctgtaatatgatacattttcctatcttttaagttattgttacctaaagttaatccagattatatggtccttatatgtgtacaacattaaaatgaaaggctttgtcttgcattgtgaggtacaggcggaagttggaatcaggttttaggattctgtctctcattagctgaataatgtgaggattaacttctgccagct

SEQ ID NO: 10 - DNA, 538 bp, Homo sapiens
tgctacggtaacttcatcagcccgccaagatggcgatgcaagcggccaagagggcgaacattcgacttccacctgaagtaaatcggatattgtatataagaaatttgccatacaaaatcacagctgaagaaatgtatgatatatttgggaaatatggacctattcgtcaaatcagagtggggaacacacctgaaactagaggaacagcttatgtggtctatgaggacatctttgatgccaagaatgcatgtgatcacctatcgggattcaatgtttgtaacagataccttgtggttttgtactataatgccaacagggcatttcagaagatggacacaaagaagaaggaggaacagttgaagcttctcaaggagaaatatggcatcaacacagatccaccaaaataaatgttttctacattttcatttggactaaatcccacgaatgacaactaccacctttttttcctttttaattaatactaaatattgtgatttcttatttgaggttcaaaatgacctgcttgaaactttgatac

SEQ ID NO: 11 - DNA, 357 bp, Homo sapiens
  misc_feature (142)..(142): n is a, c, g, or t
gaaagagctaaaacgtcatcctctcttcagtgatgtggactgggaaaatctgcagcatcagactatgcctttcatcccccagccagatgatgaaacagatacctcctattttgaagccaggaatactgctcagcacctgacngtatctggatttagtctgtagcacaaaaattttccttttagtctagcctngtgttatagaatgaacttgcataattatatactccttaatactagattgatctaagggggaaagatcattatttaacctagttcaatgtgcttttaatgtacgttacagctttcacagagttaaaaggctgaaaggaatatagtcagtaatttatcttaacctca

SEQ ID NO: 12 - DNA, 420 bp, Homo sapiens
  misc_feature (81)..(81): n is a, c, g, or t
gtacaactcgtatttatctctgatgtgccgctgctgaactttgggttcatttggggtcaaagccagtttttcttttaaaanttgaanttcantcntgatgcttggcccccatacccccnaaccttgtccnagtggagcccaacttctaaaggtcaatatatcatcctttggcatcccaactaacnatnaagnagtaggctataagggaagattgtcaatattttgtggtaagaaaagctacagtcattttttctttgcactttggatgctgaaatttttcccatggaacatagccacatctagatagatgtgagctttttcttctgttaaaattattcttaatgtctgtaaaaacgattttcttctgtagaatgtttgacttcgtattgacccttatctgtaaaacacctatttgggata

SEQ ID NO: 13 - DNA, 501 bp, Homo sapiens
gtgtccgaagttgagatggcctgccctactggcaaagaggtgacaggaaggctgggagcagctttgttaaattgtgttcagttctgttacacagtgcattgccctttgttgggggtatgcatgtatgaacacacatgcttgtcggaacgctttctcggcgtttgtcccttggctctcatctcccccattcctgtgcctactttgcctgagttcttctacccccgcagttgccagccagattgggagtctgtttgttccaatgggttgagctgtctttgtcgtggagatctggaactttgcacatgtcactactggggaggtgttcctgctctagcttccacgatgaggcgccctctttacctatcctctcaatcactactcttcttgaagcactattatttattcttccgctgtctgcctgcagcagtactactgtcaacatagtgtaaatggttctcaaaagcttaccagtgtggacttggtgttagccacgctgtttac

SEQ ID NO: 14 - DNA, 444 bp, Homo sapiens
tttgaatgtggttacttcctactgtagggtagcggaaaagttgtcttaaaaggtatggtggggatatttttaaaaactccttttggtttacctggggatccaattgatgtatatgtttatatactgggttcttgttttatatacctggcttttactttattaatatgagttactgaaggtgatggaggtatttgaaaattttacttccataggacatactgcatgtaagccaagtcatggagaatctgctgcatagctctattttaaagtaaaagtctaccaccgaatccctagtccccctgttttctgtttcttcttgtgattgctgccataattctaagttatttacttttaccactatttaagttatcaactttagctagtatcttcaaactttcactttgaaaaatgagaattttatattctaagccagttttcattttg

SEQ ID NO: 15 - DNA, 372 bp, Homo sapiens
gtaacactctggtacagatctccagaagtattgctggggtcagctcgttactcaactccagttgacatttggagtataggcaccatatttgctgaactagcaactaagaaaccacttttccatggggattcagaaattgatcaactcttcaggattttcagagctttgggcactcccaataatgaagtgtggccagaagtggaatctttacaggactataagaatacatttcccaaatggaaaccaggaagcctagcatcccatgtcaaaaacttggatgaaaatggcttggatttgctctcgaaaatgttaatctatgatccagccaaacgaatttctggcaaaatggcactgaatcatccatattttaat

SEQ ID NO: 16 - DNA, 468 bp, Homo sapiens
  misc_feature (399)..(399): n is a, c, g, or t
tgctaagttcaagtttcgtaatgctttgaagtatttttatgctctgaatgtttaaatgttctcatcagtttcttgccatgttgttaactatacaacctggctaaagatgaatatttttctactggtattttaatttttgacctaaatgtttaagcattcggaatgagaaaactatacagatttgagaaatgatgctaaatttataggagttttcagtaacttaaaaagctaacatgagagcatgccaaaatttgctaagtcttacaaagatcaagggctgtccgcaacagggaagaacagttttgaaaatttatgaactatcttatttttaggtaggttttgaaagctttttgtctaagtgaattcttatgccttggtcagagtaataactgaaggagntgcttatcttggctttcgagtctgagtttaaaactacacattttgacatagtgtttattagcagccatc

SEQ ID NO: 17 - DNA, 462 bp, Homo sapiens
ctgtcaaggccgtagcatggtgtccctggcagtccaatgtcctggcaacaggagggggcaccagtgatcgacacattcgcatctggaatgtgtgctctggggcctgtctgagtgccgtggatgcccattcccaggtgtgctccatcctctggtctccccattacaaggagctcatctcaggccatggctttgcacagaaccagctagttatttggaagtacccaaccatggccaaggtggctgaactcaaaggtcacacatcccgggtcctgagtctgaccatgagcccagatggggccacagtggcatccgcagcagcagatgagaccctgaggctatggcgctgttttgagttggaccctgcgcggcggcgggagcgggagaaggccagtgcagccaaaagcagcctcatccaccaaggcatccgctgaagaccaacccatcacctcagttgttttttat

SEQ ID NO: 18 - DNA, 518 bp, Homo sapiens
gtgaagacatcaagagctcgaagtgtaaattacccgaacaagaatcactaccaaatgataacaaagacattttacaacggcttgatccttcttcattctcaactaagcattctatgcctgtaccaagcatggtgccatcctacatggcaatgactactgctgccaaaaggaaacggaaattaacaagttctacatcaaacagttcgttaactgcagacgtaaattctggatttgccaaacgtgttcgacaagataattcaagtgagaagcacttacaagaaaacaaaccaacaatggaacataaaagaaacatctgtaaaataaatccaagcatggttagaaaatttggaagaaatatttcaaaaggaaatctaagataaatcacttcaaaaccaagcaaaatgaagttgatcaaatctgcttttcaaagtttatcaataccctttcaaaaatatatttaaaatctttgaaagaagacccatcttaaagctaagtttacccaagtactttcagcaagc

SEQ ID NO: 19 - DNA, 547 bp, Homo sapiens
cagatttctggggagcactccagccgaggcctgcagtgtggggcccccctcagtcttgtggacctggccgggagtgagcgacttgaccccggcttagccctcggccccggggagcgggaacgccttcgggaaacacaggccattaacagcagcctgtccacgctggggctggttatcatggccctgagcaacaaggagtcccacgtgccttaccggaacagcaaactgacctacctgctgcagaactctctgggtggtagtgctaagatgctcatgtttgtgaacatttctccactggaagagaacgtctccgagtccctcaactctctacgctttgcctccaaggtgaaccagtgtgttattggtactgctcaggccaacaggaagtgaagacggatccagatctgtgtgtgtgtgtgtgtgtgtgtgtgtgtgtgtgtgtgtgtgtgtgtgtgtgtccctatgtctatgtatcgggtgaggggtgggagggttgctggagggtgctttattgggtggagggcaccatgtcccagggctatcaaat

SEQ ID NO: 20 - DNA, 407 bp, Homo sapiens
tacagatactctactacactcagcctcttatgtgccaagtttttctttaagcaatgagaaattgctcatgttcttcatcttctcaaatcatcagaggccgaagaaaaacactttggctgtgtctataacttgacacagtcaatagaatgaagaaaattagagtagttatgtgattatttcagctcttgacctgtcccctctggctgcctctgagtctgaatctcccaaagagagaaaccaatttctaagaggactggattgcagaagactcggggacaacatttgatccaagatcttaaatgttatattgataaccatgctcagcaatgagctattagattcattttgggaaatctccataatttcaatttgtaaactttgttaagacctgtctacattgttatatg

SEQ ID NO: 21 - DNA, 479 bp, Homo sapiens
  misc_feature (352)..(356): n is a, c, g, or t
cctcctccacagctaacatagacgacttgaaaaaaagactggagagaataaagagcagtcgcaaatgaagctgccccactcccccggcaccctgcagctttagtttactaaactagaagtcctcatagtttaaaatggcctcagcaggcctagtgtatacaaactggttgtatgtatcatgccgtggagctagggggaggagtcattgtggcacaagtatttgtacatactctgcttctctctgtcagcgtcctgctgctctagaagactgtccgtggatgagtttagtgtacagacttgtaaacagctgccccctctctgctcagtctagttcccagatccttttcttttnnnnntaattgctcatttgtaaaattgtcctaatctttcctagctttttaatagttaatattagaaactctttaatagttttcctttcagtttgtgagctcttctctgtcgccctgaagggtcactgt

SEQ ID NO: 22 - DNA, 220 bp, Homo sapiens
ggacgaacaggaggtgtcagactgctgaagccgactctgaaagtgatcatgaagttccagaaccagaatcagaaatgaagatgagactaccaagacgagccaaaaccgcagcactagaaaaaagtaaacttaaccttgcccaatttctcaatgaagatctaagttaggaaagacgatggaggtggaatcctttaagattatgtccagttatttgctttaa

SEQ ID NO: 23 - DNA, 408 bp, Homo sapiens
agctgacggcggagctgatcgagcaggcggcgcagtacaccaacgcggtgcgcgaccgggagctggacctccgggggtgatctgaaccctctggcatctctcaaatcgctgacttacctaagtatcctaagaaatccggtaaccaataagaagcattacagattgtatgtgatttataaggttccgcaagtcagagtactggatttccagaaagtgaaactaaaattttaatccaggtgctggtttgccaactgacaaaaagaaaggtgggccatctccaggggatgtagaagcaatcaagaatgccatagcaaatgcttcaactctggctgaagtggagaggctgaaggggttgctgcagtctggtcagatccctggcagagaacgcagatcagggcccactgatga

SEQ ID NO: 24 - DNA, 353 bp, Homo sapiens
aattcgagtctatacaaaagccttgagttctttagaactcagtagccatcttgcaaaagatcttctggttctattgaatgagattctggagcaagtaaaagataggacatgtctgagagctttggagaaaatcaagattcagttagaaaaaggaaataaagaatttggtgaccaagctgaagcagcacaggatgccaccttgactacaactactttccaaaatgaagatgaaaagaataaagaagtatatatgactccactcaggggtgtaaaagcaacccaagcatcaaagtctactcagctaaagactaacagaggacagagaaaagtgacagtttcagctaggacgaaca

SEQ ID NO: 25 - DNA, 481 bp, Homo sapiens
tggatccagcacttatcagaccaggccgcattgacaggaagattgagttccccctgcctgatgaaaagacgaagaagcgcatctttcagattcacacaagcaggatgacgctggctgatgatgtaaccctggacgacctgatcatggctaaagatgacctctctggtgctgacatcaaggcaatctgtacagaagctggtctgatggccttaagagaacgtagaatgaaagtaacaaatgaagacttcaaaaaatctaaagaaaatgttctttataagaaacaggaaggcacccctgaggggctgtatctctaatgaaccatggctgtcatcaggaaaatggttgggagatttctcaatccctgaaagggatgaggttgggggagttgcccagaggaatccctgttcccactgatttttattagcaaaacatcctgtgtcttttggagtacgatgtgtaagtgcccattgggtggcctgtt

SEQ ID NO: 26 - DNA, 563 bp, Homo sapiens
atggacgaggtcctgtacagcatcgccgagaaggttaaaaattttgcagttatttatcttgtggatattacagaagtgcctgacttcaacaaaatgtatgagttatacgatccatgtactgtcatgtttttcttcaggaacaagcacatcatgattgacttggggactggcaacaacaacaagattaactgggccatggaggacaagcaggagatggtggacatcatcgagacggtgtaccgcggggcccgcaaaggccgcggcctggtggtgtcccccaaggactactccaccaagtaccgctactgaggcgccctcagtctgcgcggataaatgtcgtggagccctttttgtatggaaacgttttaagctatttaaagcctttggaaaatacaggaagctccagggctggagcacctctgagatggaattgataacatggtcttaactcaccgaaataaacaagcacgtggtgagaggagcaggcctacttgtttgttctcaggaaacttaatgaatagattactgattttcctagtcaaagttaattcttacccttggag

SEQ ID NO: 27 - DNA, 524 bp, Homo sapiens
acgccgcgcgaaggtgatgagctcgcccggctgccctacctacggacctggttccgcacccgcagcgccatcatcctgcacctcagcaacggcagcgtgcagatcaacttcttccaggatcacaccaagctcatcttgtgcccactgatggcagccgtgacctacatcgacgagaagcgggacttccgcacataccgcctgagtctcctggaggagtacggctgctgcaaggagctggccagccggctccgctacgcccgcactatggtggacaagctgctgagctcacgctcggccagcaaccgtctcaaggcctcctaatagctgccctcccctccggactggtgccctcctcactcccacctgcatctggggcccatactggttggctcccgcggtgccatgtctgcagtgtgccccccagccccggtggctgggcagagctgcatcatccttgcaggtgggggttgctgtataagttatttttgtacatgttcgggtgtgggttctacagacttgtcccc

SEQ ID NO: 28 - DNA, 282 bp, Homo sapiens
gaatgaagccatcaggctaatggagatgtcaaaggactctcttctaggagacaaggggcagacagctaggactcagagaccagcagatgtgatatttgccaccgtccgtgaactggtctcagggggccgaagtgtccggttctctgaggcagagcagcgctgtgtatctcgtggcttcacacccgcccagttccaggcggctctggatgaatatgaggagctcaatgtctggcaggtcaatgcttcccggacacggatcacttttgtctgattccagcctgc

SEQ ID NO: 29 - DNA, 406 bp, Homo sapiens
aagcccactttagagtatacattgctattatgggagaccacccagacatctgactaatggctctgtgccacactccaagacctgtgccttttagagaagctcacaatgatttaaggactgtttgaaacttccaattatgtctataatttatattcttttgtttacatgatgaaactttttgttgttgcttgtttgtatataatacaatgtgtacatgtatctttttctcgattcaaatcttaacccttaggactctggtatttttgatctggcaaccatatttctggaagttgagatgtttcagcttgaagaaccaaaacagaaggaatatgtacaaagaataaattttctgctcacgatgagtttagtgtgtaaagtttagagacatctgactttgatagctaaa

SEQ ID NO: 30 - DNA, 451 bp, Homo sapiens
tgaacgtctgtgacaacctgggagaccacctggtggggaacgtgtacgtcaagtttcgccgtgaggaagatgcggaaaaggctgtgattgacttgaataaccgttggtttaatggacagccgatccacgccgagctgtcacccgtgacggacttcagagaagcctgctgccgtcagtatgagatgggagaatgcacacgaggcggcttctgcaacttcatgcatttgaagcccatttccagagagctgcggcgggagctgtatggccgccgtcgcaagaagcatagatcaagatcccgatcccgggagcgtcgttctcggtctagagaccgtggtcgtggcggtggcggtggcggtggtggaggtggcggcggacgggagcgtgacaggaggcggtcgagagatcgtgaaagatctgggcgattctgagccatgccatttttaccttatgt

SEQ ID NO: 31 - DNA, 458 bp, Homo sapiens
ggggattgtgttttgtcactctagaagagttcttcacagagacttaaaacctcaaaatctcttgattgatgacaaaggaacaattaaactggctgattttggccttgccagagcttttggaatacctatcagagtatatacacatgaggtagtaacactctggtacagatctccagaagtattgctggggtcagctcgttactcaactccagttgacatttggagtataggcaccatatttgctgaactagcaactaagaaaccacttttccatggggattcagaaattgatcaactcttcaggattttcagagctttgggcactcccaataatgaagtgtggccagaagtggaatctttacaggactataagaatacatttcccaaatggaaaccaggaagcctagcatcccatgtcaaaaacttggatgaaaatggcttggatttgctctcgaaaa

SEQ ID NO: 32 - DNA, 532 bp, Homo sapiens
aaagctcaggattcttcgaaaagttgagaaaattgatgacttcaaagctgaagactttcagattgaagggtacaatccgcatccaactattaaaatggaaatggctgtttagggtgctttcaaaggagcttgaaggatattgtcagtctttaggggttgggctggatgccgaggtaaaagttctttttgctctaaaagaaaaaggaactaggtcaaaaatctgtccgtgacctatcagttattaatttttaaggatgttgccactggcaaatgtaactgtgccagttctttccataataaaaggctttgagttaactcactgagggtatctgacaatgctgaggttatgaacaaagtgaggagaatgaaatgtatgtgctcttagcaaaaacatgtatgtgcatttcaatcccacgtacttataaagaaggttggtgaatttcacaagctatttttggaatatttttagaatattttaagaatttcacaagctattccctcaaatctgagggagctgagtaacaccatcgat

SEQ ID NO: 33 - DNA, 401 bp, Homo sapiens
ggacgccgaactcgagcttgtagacagcttggatcctttctctgaaggaatcatgttcagtgttcgaccacctaagaaaagttggaaaaagatcttcaacctttcgggaggagagaaaacacttagttcattggctttagtatttgctcttcaccactacaagcccactcccctttacttcatggatgagattgatgcagcccttgattttaaaaatgtgtccattgttgcattttatatatatgaacaaacaaaaaatgcacagttcataataatttctcttcgaaataatatgtttgagatttcggatagacttattggaatttacaagacatacaacataacaaaaagtgttgctgtaaatccaaaagaaattgcatctaagggactttgttgaactt

SEQ ID NO: 34 - DNA, 460 bp, Homo sapiens
tcatctgaggaggcctcgtctctgaacttgggttgtgccgagagagtttgttctgtgtttcccaccctctccctgacccaagtctttgcctctactcccttaacagtgttgaattcaactgaaggcgaggaatgttggtgatgaagctgagttcaggactcggtggaccctttgggaatgggtcatgaaagctgccatggggtgaggaaagaggagacagtgggagaggacaatgactattgcatcttcattgcaaaagcactggctcatccgccctacttcccatcccacacaaacccaattgtaaataacatatgacttctgagtacttttgggggcacaactgttttctgtttgctgtttttttgttttgttttttttctccagagcactttggtctagactaggctttgggtggttccaattggtggagagaagctctgaggcacgtcatgcaggt

SEQ ID NO: 35 - DNA, 511 bp, Homo sapiens
gagtcgccaggcagtatatccagttagaacttccggcttttgcattagcttgtctgatgctcatgccccactcagagaaaagacaccagcaaattaagaattttctgggttcctgtgaccctcaggttattttaaagcaattggaagagcatatgaacacgggccagctagcaggattttcacatcaaattagaagtctgattttgaataatatcatcaataagaaggagtttgggattttggcaaagaccaaatactttcaaatgttgaagatgcatgcgatgaataccaacaatatcactgagctagtgaactatttggcaaatgacttaagtttagatgaagcttcagtcttgataactgaatattcaaagcactgcgggaaacctgtgcctccagacactgctccctgtgaaattctgaagatgtttcttagtggattatcgtaaatcactgaacctttttttcaagaaggacaagaattttggagtctgctattaatggaccatat

SEQ ID NO: 36 - DNA, 420 bp, Homo sapiens
gctggcacagatgacgcggtgcccggagcaggagcagcggctgcagcgcttagaacggctgcctgagctggcccgcgtgctgcggagcgtctttgtgtccgaacgcaagcctgcgctcagcatggaggtggcctgtgccaggatggtgggcagctgttgtactatcatgagccctggggaaatggagaagcacctgctgctcctctccgagctgctgccggactggctcagcctccaccgcatccgcaccgacacctacgtcaagctggacaaggccgcggacctggcccacatcactgcacgcctggcccaccagacacgtgctgaggaggggctgtgagcctgggggccactgtggacagacgtgggcttcagaagctcgctggcctgggcccaccagcattttcttttatgaacatg

SEQ ID NO: 37 - DNA, 523 bp, Homo sapiens
ttatgctgcatttggctggagcccggtgttcagtggtttccctgcccgaggtcgctgcagccccatctaccacatcttcatgtggacattgagattcacatgctggctcctgaagggtgctcagtctccttggtgattaaggtcctgcttgaactgctgccaactccatgtcagggaagtcgcttttggtgcctggctggtttgcccagagccaagctggggcaaggggcagccagccctggcttccaaggctcccgtactgtctgtgtccttgtataaggagctttgctcttggaattactgaaagtctgtggccctaagagagagacacaagtggccttaagtctttttgaagtgttatttcatccagggaaatgcctcgagccatagagcctgaaatcatctttgttggctcagaaaataccttagcttcactcagctggactgcattgaaggcgaggctgccccttggatcaagcagaaaacaagagaaagaaagaacgttccctttggggatagtctg

SEQ ID NO: 38 - DNA, 446 bp, Homo sapiens
agccacagttcccctatgtggaagtggggcgggcttcatagagacttgggaatgagctgaaggtgaaacattttctccctggatttttaccagtctcacatgattccagccatcaccttagaccaccaagccttgattggtgttgccagttgtcctcttccgggaagatttgcagttctttggctgaaggaagctgtgcgtgtgtgtgtgtgtatgttgtgggtatgtgtatctcacactcatgcattgtcctctttttatttagattggcagtgtagggagttgtgggtagtggggaagagggttaggagggtttcattgtctgtgaagtgagaccttccttttacttttcttctattgcctctgagagcatagctagaggcctgactgccaagccatgggtagcctgggtgtaaaacctggagatggtggatgatccccacgcc

SEQ ID NO: 39 - DNA, 565 bp, Homo sapiens
cattgcagatcgtagcgcgttgcctgtcgctttcccttggatacctagaccgttataaagtgtgccacatggacttaccgagcatggagagaggattttagctaggatttgaacacttggtgctgggaacctcagggtattgcttgccactaagccatgaaaccagagacaaaatctctatactgccctgagttggggggaattctcagtgccaactgtggctggtcctcattcaaagggacggtcagtttggtgtcaacatgaaacaccaagatgtctgtctctgaagcgtgattttaaaatccccatgcctgtgcgtgcgcttcctatttctagggctgggaaacactccttgcatcaaggggtcacttacagaacaaagaatcttttgggggaaacttcctctaaaaccctctcatatatagacagctttgactggagggtccatttttcttccaggatggtgttactgcagttgaagggcaatatgaagttactttcttaatgtgacctagcaataggcatagctacgtggcactatattctggccagactcgatgtgtac

SEQ ID NO: 40 - DNA, 562 bp, Homo sapiens
  misc_feature (112)..(112): n is a, c, g, or t
acttcttatccgaccagtacagaggttacccagtgttgcattacttttaaatgatcttaagaagcatacagctgatgaaaatccagacaaaagcactttagaaaaagctatnggatcactgaaggaagtaatgacgcatattaatgaggataagagaaaaacagaagctcaaaagcaaattttngatgtngtttatgaagtagatggatgcccagctaatcttttatcttctcaccgaagcttagtacagcgggttgaaacaatttctctaggtgagcacccctgtgacagaggagaacaagtaactctctncctcnttcaatgatngcctagagatnagcnaagaanaancggcncangnttatnggcactttnaggangtcctnnatggnncnaacccgnannccccannnttntnttnanagncatattcancctaatgcctnnttntnagattanagaaggtatcggcaccatacagagagacagaaagatgccataatggctttgccttgctttgtgaggccaccaaacagagcaggcaatgtgctactcagtttcc

SEQ ID NO: 41 - DNA, 512 bp, Homo sapiens
  misc_feature (152)..(153): n is a, c, g, or t
tggagtgtcattttatgccacctgaaaaagtacataaagaactctttaaagactggaatattccatttaagcagccatcatatccatcagtgaaacggtataatcggaatcggacactaacacaaaagctacggatggaggagcgatttaannaaangaaagaaagattactcaggaagaaattagctaaaaaaggaattgactatgattttccttctttgattttacagaaaacggaaagtatttcaaaaactaatcgtcagacgtctacaaaaggccaggttttacgtaagaagaagaannnaaaagtttcaggtactcttgacactcctgagaagactgtggatagccagggccccacaccagtttgtacaccaacatttttggagaggcgaaaatctcaagtggctgaactgaatgatgatgataaagatgatgaaatagttttcaaacagcccatatcctgtgtaaaagaagaaatacaagagactcaaacacctacacattcacgg

SEQ ID NO: 42 - DNA, 233 bp, Homo sapiens
gagtgtgtaaaactttccaaatggcagaatacctgaaactggagtttatcaaggaaattggatacactcacatgaaaatagcggaaggagtgaactctcttttgcagatggcaggcctcctggcaaggctgtgtcagaagacaatggccccggtggccagttagagcagagacttcactgactgacttacaggtgccctattctgaggtacaggagccgcggctttctgatgg

SEQ ID NO: 43 - DNA, 557 bp, Homo sapiens
gacacaattacagctgattgcagccttgaccttcccagctcaagtgatcctcctacctcagcctcccaagtagttaggacacacaggtgtgcacctcatatccagataatttttttcaatttttttttgtagaggtggggggtctccctatgttgcccaggcagatctcagactcctgggctcaagcgatcctcacacctcagcgtcccagagtgctgggattacagttgtgagccactgtgcctggcctttttttttttttaaccttttcgtttaacttctctcttcactgcatcccaatccatctacaggcatgcacacttattaggaaaggaggtttgaggtaacaacagagactttcactatattttgctttgacagaaggaaagaggaggagtttctattaaaatctgtcacttgagtgatgtcatttaagtcctattttaggagataaaaacagctttggggactggttaaagtcccccagaaactacaataaagaacaacttttgttttaactcttaatcactttgtaattttgactcaatccttttctg

SEQ ID NO: 44 - DNA, 406 bp, Homo sapiens
acaaaagtccatttgtcctgctactcctttggtgacacacaggtagtgtcaactggaacatcagtaggtatttgatataacctttttgttagcagaaaattagtcactgcttaggttttaagtctgccaaactgggactaagtatgctttaaataggtatagattcttcggtttcttagaattctagatccatgatgtactttaattttttaatgactgtatatttagttttaaccactacttaaagtaatctaagcaaagaattcctattgctctccatcagttcaagataaaaaaacaaaaacaaaacaaaacgaaacctatgttaaaatttgacccgtcaaaattactcagtattgagctgcctaaagccgttttccagaaagagacttgcctgactatagaa

SEQ ID NO: 45 - DNA, 530 bp, Homo sapiens
tggatctttctcatacccaaaacattggacagatgctgcgtactcatttcacacattctcagttcattgtggtgtcactaaaagaaggtatgttcaacaatgcaaacgttcttttcaaaaccaagtttgtggatggtgtttctacagtagccagatttactcaatgtcaaaatggaaagatttcaaaggaagcaaaatccaaggcaaaaccacccaaaggagcacatgtggaagtttaaactacaaagttatttcttcatcttgacctgtttttttaaatgtaaacttttaaggacttgagataactaatttgtttatatacaaaaattaatgttactgtgttacttaacccatgttttctctttatataatcacttatcgcttacaaatgagcatatattcctcatctcttaactagtctaattatggtccaattattgtggttgtgattttatgcatatccatcaaaatgttttttttcttatgcgggtcttttatatattagggatcctgagatacccgattctata

SEQ ID NO: 46 - DNA, 524 bp, Homo sapiens
gtgaaactgccagcatactcatgcatgcaacagcacattctctggtgcttgtggatgaattaggaagaggtactgcaacatttgatgggacggcaatagcaaatgcagttgttaaagaacttgctgagactataaaatgtcgtacattattttcaactcactaccattcattagtagaagattattctcaaaatgttgctgtgcgcctaggacatatggcatgcatggtagaaaatgaatgtgaagaccccagccaggagactattacgttcctctataaattcattaagggagcttgtcctaaaagctatggctttaatgcagcaaggcttgctaatctcccagaggaagttattcaaaagggacatagaaaagcaagagaatttgagaagatgaatcagtcactacgattatttcgggaagtttgcctggctagtgaaaggtcaactgtagatgctgaagctgtccataaattgctgactttgattaaggaattatagactgactacattggaagctttgag

SEQ ID NO: 47 - DNA, 395 bp, Homo sapiens
  misc_feature (65)..(66): n is a, c, g, or t
gccctagacaaccctaacgaggaggtggcagaagtgaagatctcccacttcccggccgcggaccnnggcttcagtgtgtcgcagcgctgtttcgtgttgcagcctaaagagaaaattgttatttctgttaactggacaccactcaaagaaggccgagtaagagagattatgacatttcttgtaaatgatgttctgaaacaccaagctatattactaggaaatgcagaagagcanaaaaagaaaaagaggagtctttgggataccattaaaaagaagaaaatttcagcctctacaagtcacaacagaagggtttcaaatattcagaatgttaataaaacatttagtgtttcccaaaaagttgacagagttaggagcccactacaagcttgtgaaaa

SEQ ID NO: 48 - DNA, 331 bp, Homo sapiens
tcaccagaagatatcattggcaacatctttcgagtgtgtaaaactttccaaatggcagaatacctgaaactggagtttatcaaggaaattggatacactcacatgaaaatagcggaaggagtgaactctcttttgcagatggcaggcctcctggcaaggctgtgtcagaagacaatggccccggtggccagttagagcagagacttcactgactgacttacaggtgccctattctgaggtacaggagccgcggctttctgatgggggaaaatgcgccttaggctgagccaacatgactgtcccccaaactccagtggctggccaggcgcgg

SEQ ID NO: 49 - DNA, 334 bp, Homo sapiens
  misc_feature (40)..(42): n is a, c, g, or t
tgatcgagcaggcggcgcagtacaccaacgcggtgcgcgnnngnnnnnnnnnnnncnnngtatcctaagaaatccggtaaccaataagaagcattacagattgtatgtgatttataaagttccgcaagtcagagtactggatttccagaaagtgaaactaaaattttaatccaggtgctggttngccaactgacaaaaagaaaggtgggccatctccaggggatgtagaagcaatcaagaatgccatagcaaatgcttcaactctggctgaagtggagaggctgaaggggttgctgcagtctggtcagatccctggcagagaacgcagatcagg

SEQ ID NO: 50 - DNA, 496 bp, Homo sapiens
  misc_feature (458)..(458): n is a, c, g, or t
ttgaacctcccattagccaagtgggaaatgtagacactgcttcagaacttgagaagggggtgtctgaggctgcagtcctaaagccttctgaagagttacctgctgaggctacctcatccgttgaacccgaaaaggattctggctcagcagcagaggctcctcgttagagactggaatttgtgaaaatgtgacagtgacacttcctggagtgtagagcttgaggtgtacagatgctgtattatatccgctcccgctgtactgcagccccgcgccagctggtggggaactgtaagcaatttgattgcttcccttctatttaaaaatagccacaaaataacaaaaaatactgaaaatatgaataaatattaccctttttgctgtaactttttaaaagttttgactttaaaaagtttacaaatcgtaattagaagtgctctctatttttttttttttttttnaatttaagacaaggtaacggtgaaagctcctcaaaaca

SEQ ID NO: 51 - DNA, 356 bp, Homo sapiens
ctctcttcaacggtgacactcagtatgtctgcagatgtaccccttgttgtagagtataaaattgcggatatgggacacttaaaatactacttggctcccaagatcgaggatgaagaaggatcttaggcattcttaaaattcaagaaaataaaactaagctctttgagaactgcttctaagatgccagcatatactgaagtcttttctgtcaccaaatttgtacctctaagtacatatgtagatattgttttctgtaaataacctattttttttctctattctctccaatttgtttaaagaataaagtccaaagtctgatctggtctagttaacctagaagtatttttgtctcttag

SEQ ID NO: 52 - DNA, 360 bp, Homo sapiens
gcagaacatacagctacctgctgcactgctctcccggtttgacctcctctggctgattcaggaccggcccgaccgagacaatgacctacggttggcccagcacattacctatgtgcaccagcacagccggcagcccccctcccagtttgaacctctggacatgaagctcatgaggcgttacatagccatgtgccgcgagaagcagcccatggtgccagagtctctggctgactacatcacagcagcatacgtggagatgaggcgagaggcttgggctagtaaggatgccacctatacttctgcccggaccctgctggctattctgcgccttttcactgctctggcacgtctgagaatggt

SEQ ID NO: 53 - DNA, 541 bp, Homo sapiens
  misc_feature (136)..(136): n is a, c, g, or t
gagttaatgcagcactcgtcattcagaaatattggcgaagagtcttagcacagagaaaattattaatgttaaaaaaggaaaagctggaaaaagttcaaaataaagcagcatcacttattcagggatattggagaanatatnccactngacaaagatttncngaaatngaaanattattcantcatccngcnaatntaggataagaatgataattgctgtnacatcttataaacgatatctttgggctacagttacaattncagaggcattggcgtgcttatttaagaagaaaacaagatcaacaaagatatgaaatgctaaaatcatcaactcttataatccaatctatgttcagaaaatggaagcaacgtaaaatgcaatcacaagtaaaagctacagtaatattgcaaagagcttttagagaatggcatttaagaaaacaagctaaagaagaaaattctgctattatcatacaatcatggtatagaatgcataaagaattacggaantatatttatattagatcttgtgttgttatcat

SEQ ID NO: 54 - DNA, 483 bp, Homo sapiens
ggacagtgtttcaacaagcctaggctatctcgtaagttgaaaaatatcccactatagttgcttcatgagtatgaagtaagatggcctctgatttacactggttcaatttacaaattttcaactttatgataggtttatccgggtactaaatgcatttcaacttgatagtttcaacttatgataggtttaccaggatgtagtcccactgttgaggagcatctatttaggggttaattactttagtaataagtggaaagtaagataccttgagtaatgtttgcctataaaattgtcagcgtatttttacactattggctcaagaatgttataatgctaagggacataagttggcaaccacttggtttttggaaggactttcggtattgtattagaagtctgccctagctgttaaatttctgggtatttatcctaaggaattaattaaagagttaattgttcctttcttcagtgggccattgtttt

SEQ ID NO: 55 - DNA, 531 bp, Homo sapiens
gaagtcacaggccctgtcattgcgcctctcttcccgcagaaacgtgaagagggctggtgggtggtgattggagatgccaagtccaatagcctcatctccatcaagaggctgaccttgcagcagaaggccaaggtgaagttggactttgtggccccagccactggtgcccacaactacactctgtacttcatgagtgacgcttacatgggatgtgaccaggagtacaaattcagcgtggatgtgaaagaagctgagacagacagtgattcagattgagtcctgaggcatttacttttgggtaaaggagagttgagcctgaattaggaatgtgtacattgtaggaatcctggttgtggggaccaggtctgtgggcctcaggtctggccagccagggctggtgctgtccccgcctacctccacttcctttcccttgctcactctggatccagtgacagcaggtgtcatgggtcaagcataaatcatatatagcattttcaggcatgttcctggtagttcttttgagtctgacat

SEQ ID NO: 56 - DNA, 141 bp, Homo sapiens
ataagatcccttttgctgatgctctggatttgtttcgaggaaggaaagtctatttggaagatggctttgcttacgtaccacttaaggacattgtggcaatcatcctgaatgaatttagagccaaactgtccaaggctttgg

SEQ ID NO: 57 - DNA, 432 bp, Homo sapiens
ttggacccaagccctgaggtacagaagaagaagtatgccttcaaatgtcacagactaaaagaaaataatattgagcagatttacccagtcaatgccatttcttttcacaatatccacaatacatttgccacaggtggttctgatggctttgtaaatatttgggatccatttaacaaaaagcgactgtgccaattccatcggtaccccacgagcatcgcatcacttgccttcagtaatgatgggactacgcttgcaatagcgtcatcatatatgtatgaaatggatgacacagaacatcctgaagatggtatcttcattcgccaagtgacagatgcagaaacaaaacccaagtcaccatgtacttgacaagatttcatttacttaagtgccatgttgatgataataaaacaattcgtactccccaatggtgga

SEQ ID NO: 58 - DNA, 381 bp, Homo sapiens
gacagccagaatgggacctctactcacggttttctgaatggaaatcaggaacaaactgctcatcactgtctggtacctgagctgcagagagaagtcagagccccaccagcgacaccctcaggccccaccaaaacgcactgaagaatccaaccaggaaacctcctgaacacaccacttccccatcagacccagccacggacccagccacggaccccaccccagccagctcacagctaactccccagcacacaggaaggggggaatttgcctggaggcagaggtattcaagcgggatggaagagggaggaacacttgctattagaattacaatcaaggctatttggggagggagccctgggctctctgtgccaaaggactgcc

SEQ ID NO: 59 - DNA, 491 bp, Homo sapiens
tagctgtttcagagagagtacggtatatttatggtaattttatccactagcaaatcttgatttagtttgatagtgtgtggaattttattttgaaggataagaccatgggaaaattgtggtaaagactgtttgtacccttcatgaaataattctgaagttgccatcagttttactaatcttctgtgaaatgcatagatatgcgcatgttcaactttttattgtggtcttataattaaatgtaaaattgaaaattcatttgctgtttcaaagtgtgatatctttcacaatagcctttttatagtcagtaattcagaataatcaagttcatatggataaatgcatttttatttcctatttctttagggagtgctacaaatgtttgtcacttaaatttcaagtttctgttttaatagttaactgactatagattgttttctatgccatgtatgtgccacttctgagagtagtaaatgactctttgctacatttta

SEQ ID NO: 60 - DNA, 349 bp, Homo sapiens
  misc_feature (31)..(32): n is a, c, g, or t
ccaagcaccgcatctacgagtatgtggagtnncccggatgtccnttcatcgcacccaacctgtccatcattantcggggcatnccacggccgccaagatcatgggtgtggccggcggcctgaccaacctctccaagatgcccgcctgcaacatcatgctgctcggggcccagcgcaagacgctgtcgggcttctcgtctacctcagtgctgccccacaccggctacatctaccacagtgacatcgtgcagtccctgccaccggatctgcggcggaaagcggcccggctggtggccgccaagtgcacactggcagcccgtgtggacagtttccacgagagcacagaaggg

SEQ ID NO: 61 - DNA, 396 bp, Homo sapiens
gactggacttattactcccaaagcaggctttgactctgattatgaccaagctcttgctgacataagagaaaatgaacagagcctcctggaatacctagagaaacagcgcaacagaattggctgtaggaccatagtctattgggggattggtaggaaccgttaccagctggaaattcctgagaatttcaccactcgcaatttgccagaagaatacgagttgaaatctaccaagaagggctgtaaacgatactggaccaaaactattgaaaagaagttggctaatctcataaatgctgaagaacggagggatgtatcattgaaggactgcatgcggcgactgttctataactttgataaaaattacaaggactggcagtctgctgtagagtgtatcgc

SEQ ID NO: 62 - DNA, 524 bp, Homo sapiens
gagacttttttgaactcagacttaaatattatggattaagaaaagaatggctcctaggaatgcttggtgctgaatctgctaaactgaataatcaggctcgctttatcttagagaaaatagatggcaaaataatcattgaaaataagcctaagaaagaattaattaaagttctgattcagaggggatatgattcggatcctgtgaaggcctggaaagaagcccagcaaaaggttccagatgaagaagaaaatgaagagagtgacaacgaaaaggaaactgaaaagagtgactccgtaacagattctggaccaaccttcaactatcttcttgatatgcccctttggtatttaaccaaggaaaagaaagatgaactctgcaggctaagaaatgaaaaagaacaagagctggacacattaaaaagaaagagtccatcagatttgtggaaagaagacttggctacatttattgaagaattggaggctgttgaagccaaggaaaaacaagatgaacaagtcggacttcct

SEQ ID NO: 63 - DNA, 445 bp, Homo sapiens
cactctcagtttacttggctggagtttatctgttgtactttttacccacaacttcaatactgtgatcaagggcgatgtgacttagatcttttacatctttaagcaggcttactcttgcctgcttaagttatgaataaatacatcacatgcttgttacagtagaccatcttttaaattaacaaattgttgtatttgaagtggtattgccaaatataattaacacttgaatcccctaactggaagttaatatcttgagagtattacagtgttctagtcctgtgagcccatagtatttttcaaaggtatatgcatatgcctgtttgctttcataatctgagttgttttaggaaagaacctattgattacctctgagatgtaggactgtgagacattggtttgtaatggaggacttttacttttcacctatgctattcagtactgttgg

SEQ ID NO: 64 - DNA, 487 bp, Homo sapiens
gtgaagcccgtggactacagagagtatggccgaaggctggtcatgagcatcaggagaagtgcattgatgtgagaggagcagtgccaatcgggcagaagtttgcaaataggcagaatggaatcgatttcctcccacctccgtgtgacgatcccatgttagctacacagtgcagaggctcttgatggtggactaagcaattcctccctcgtgcgcatctcagaacccatcggtaggcaaaggaaaatacgctcaggtggttgtggtgtagactgtgtcaggcctacggagtcagccagtggctagcgcaagaccagtcactccctctgccttcaggcttctgtcaatttcattatcatcaagcaggaattatgtcgtaagtcactgaccctaactgcagaccatgaagtaaattatgtaactaggtttttgcttctccagtggtgaccacccccccccatccccgctcacaacttgggttcttctcagc

SEQ ID NO: 65 - DNA, 361 bp, Homo sapiens
acccaacttgattcagcgacccaaggcggatgatacaagtgcagccaccattgagaagaaagccacagcaaccatcagtgccaagccacagatcactaatcccaaggcagagattactcgatttgtgcccactgcactgagagtacgtcgggagaataaaggggctactgctgctccccaaagaaagtcagaggatgattctgctgtgcctcttgccaaagcagcacccaaatctggtccttctgttcctgtctcagtacaaactaaggatgatgtctatgaggctttcatgaaagagatggaagggctactgtgacagcttttgatgccagaaaaggcttctgttcacaacagtggccca

SEQ ID NO: 66 - DNA, 172 bp, Homo sapiens
tgagctccttgaagtccatggcggaacgggcagccatcagctctggcattgaggaccctgtgccaacgctgcacctgaccgagcgagacatcatcctgagcagtacatcagcacctccggcctcagcccagccgcccctgcagctgtcagaggtgaacataccgctgtcgct

SEQ ID NO: 67 - DNA, 412 bp, Homo sapiens
tagccttgttcagaatttactgcacataaaaaagggtatttcatccagaatagatcagttattgaagcagtgctgctaacatccattccctttcataccaccattttcaccctgtttcttcccctcctccagttctttggaaatttgtgatcgggggatcttagttgcttatttgttttgactcttgtgtgctgtgggcactggagtagagatttctggagaaaaaaaaacagtttatttcatcttgccttttgtgtttgagttatttttaatattttcctgtaaatattttgtaatattttacttgtaatgaaatggatcacaatgtcatttcctaatacaaggcaggatatgtgggaagaatatgtacaattatttgattaaaattatttcccactgacctaaactttca

SEQ ID NO: 68 - DNA, 550 bp, Homo sapiens
gtttattgtaatgtcatcgtcctccagcgccccatccacccagcaggtcctgtccctcagcacctcggcccccggctcaggttccaccaccacttcgcccgtcaccaccaccgtccccagcgtgcagcccatcgtcaagttggtctccaccgccaccaccgcaccccccagcactgctccctctggtcctgggagtgtccagaagtacatcgtggtctcacttcccccaacaggggagggcaaaggaggccccacctcccatccttctccagttcctcccccggcatcgtccccgtccccactcagcggcagtgccctttgtggggggaagcaggaggctggggacagtccccctccagctccagggactccaaaagccaatggctcccagcccaactccggctcccctcagcctgctccgtgatgctccacctgccagcccccggattcccacacatgcagacatgtacacacgtgcacgtacacacatgcatgctcgctaagcggaaggaagttgtagattgcttccttcatgtcactttctttttag

SEQ ID NO: 69 - DNA, 520 bp, Homo sapiens
aagccaggattctccggtctggaatttctgagtgagtcctttttttatggtgtcctccctctgtgaatgtacaggcggaactgtacgaacagctcccttccatccatttttaactctttcggaaataacacctcacagcagcttcgtgcttttgtacagacctttgtaacaagtgtacagaaaactcattttgtttgagaaacaggagttgatgaacccatcatgctggtttttctctgagcacaaagttttaggctgtacacagccagccttgggaatctcgttgagcgttcggcgtggatccacggggccaggccaccctgcgggaggccacacgcatccacttcggattcagtgggtgaagacagaactctgagagtctgcaggcggctcctgtgctttttatttctggctcttcggatgtcttctagacatttactatcactgcacctgaagaaaaaatcacttttaccttcctaatttaaaaagacaaaacagaaatgtacgttccttcgctagc

SEQ ID NO: 70 - DNA, 278 bp, Homo sapiens
agctgatttctatgctgcctacattaacattcttcttggagttttctacactgtttgtcgagatttgaaagagctcagacatctggcagtacttaattttcctaaatattgtgaacccgtggttaaaggagaagcaagtgaacgtgatactcgcaaactgtggagaaatattgaacctcatttgaagaaagctatgcagactgtttatctcagggaaatatcaagttcccagtgggaaaagctacagaaagatgacacagatccggggcaactgaaag

SEQ ID NO: 71 - DNA, 446 bp, Homo sapiens
gcacagcttgcaaaggatattgccaggagaagcaaaacttttaatccaggtgctggtttgccaactgacaaaaagagaggtgggccatctccaggggatgtagaagcaatcaagaatgccatagcaaatgcttcaactctggctgaagtggagaggctgaaggggttgctgcagtctggtcagatccctggcagagaacgcagatcagggcccactgatgatggtgaagaagagatggaagaagacacagtcacaaacgggtcctgagcagtgaggcagatgtataataataggccctcttggaacaagtcttgcttttcgaacatggtataatagccttgtttgtgttagcaaagtggaatctatcagcattgttgaaatgcttaagactgctgctgataattttgtaatataagttttgaaatctaaatgtcaattttctacaa

SEQ ID NO: 72 - DNA, 282 bp, Homo sapiens
ccgtggccagggtcagaaagtgcagaaggttatggtgcagcccatcaacctcatcttcagatacttacaaaatagatcgcggattcaggtgtggctctatgagcaagtgaatatgcggatagaaggctgtatcattggttttgatgagtatatgaaccttgtattagatgatgcagaagagattcattctaaaacaaagtcaagaaaacaactgggtcggatcatgctaaaaggagataatattactctgctacaaagtgtctccaactagaaatgatcaat

SEQ ID NO: 73 - DNA, 514 bp, Homo sapiens
caatgccacggactactggacgttccggaagatgttcaccatccagctggctctgataggcttcgcggaattcgtcctgcatttaaatagactcaaccccgagatgttacagatcgctcaggacactggcaaactgaatgttgcctactttcgatttgacataaacgacgcgactggagacctggatgccaaccgtcctgtcccatttcgactcacgcccaacatttctgagtttctgaccaccatcggggtctccggcccgttgacagcgtccatgattgcggtcgcccggtgcttcgcccagccaaactttaaggtggatggcattctgaaaacggttctccgggacgagatcattgcttggcacaaaaaaacacaagaggacacgtcctctcctctctcggccgccgggcagccagagaacatggacagccagcaactggtgtccctggttcagaaagccgtcaccgccatcatgacccgcctgcacaacctcgcccagttcgaaggcggg

SEQ ID NO: 74 - DNA, 414 bp, Homo sapiens
atagcttctgtataggcctaacctttattcatatggcatctcagaagtatgtgttacggagacatgctcttattgtacagggcttttcctttcttaatcgatacctcagtttacgtgggccctgccaggaatcattctacaatttgggccgtggccttcatcagttggggctgattcatcttgcaatccactattatcagaaggccctggagctccctccacttgtggtagagggtatagaacttgaccagttagacttacgaagagatattgcctacaacttgtctctcatctatcagagcagtgggaataccggaatggctcaaacgcttttgtatacctattgttctatataaagcaccgcaactgagaacagagcaatggcagctgctgtgtgaggaccagtgtcttctg

SEQ ID NO: 75 - DNA, 512 bp, Homo sapiens
agcaggatgtagagcgccacttctctctgggcgagttgaaggagctgtttatcctggatgaagctagcctcagtgacacacatgacaggttgcactgccgacgttgtgtcaacagccgtcagatccggccaccccctgatggttctgactgcacttcagacctggcagggtggaaccactgcactgataagtgggggctccgggatgaggtactccaggctgcctgggatgctgcctccactgctatcaccttcgtcttccaccagcattctcatgaggaacagcggggcctccgctgataaccagctggtctgggtgtagctcttagaggaaggagatagggaaaaggggctccttgctccacagggccctgttgaattttgttctctgggagaaaatcatcaagaagggctgcatgatgtttgcccaaaatttattttataagaaaaacttttttggttaaaaaaaagaataaaggtatgaaagggctggtgacagtcagggatgccccc

SEQ ID NO: 76 - DNA, 443 bp, Homo sapiens
gtgttggagtctcagttctcccagctgcttcatcagatcaattctacccgagactttgaaagcatccgattggctcatgaccacttcctgagcaatttgctggctcaatcctttatcctattgaaacctgtgtttcactgcctgaatgaaatcctagatctctgtcacagtttttgttcgctggtcagtcagaacctaggcccactggatgagcgtggagccgcccagctgagcattctcgtgaagggctttagccgccagtcttcactcctgttcaagattctctccagtgttcggaatcatcagatcaactcagatttggctcaactactgttacgactagattataacaaatactatacccaggctggtggaactctgggcagtttcgggatgtgaaaatttctggctcataaattgaaataacagccacgttcccaagg

SEQ ID NO: 77 - DNA, 511 bp, Homo sapiens
tggagacccctgaactcattgagctgaggaagaagaagattgaggaggcgatggacggaagtgagacacctcagctcttcactgtgttgccagagaagagaacagccactgttggaggggccatgatgggatcaacccacatttatgacatgtccacggttatgagccggaagggcccggctcctgagctgcaaggtgtggaagtggcgctggcgcctgaagagttggagctggatcctatggccatgacccagaagtatgaggagcatgtgcgggagcagcaggctcaagtagagaaggaggacttcagtgacatggtggctgagcacgctgccaaacagaagcaaaaaaaacggaaagctcagccccaggacagccgtgggggcagcaagaaatataaggagttcaagttttaggtcccctcacactagccctttttttggccctacgtctggatgcctgggcttcacacaagaaccacctctcccgcagttcccaaggacttgtcatt

SEQ ID NO: 78 - DNA, 494 bp, Homo sapiens
caaggcatctgttgctttgggtcctccacgactcttaggcccgcctcaacaacccaggcacctcctaggtaggctcaaaggtagacccgtttccaccgcagcaggtgaacatgaccgtgttttcaactgtgtccacagttcagatccctttccagattgcaacctggcctgcatcccagctccttcctgctcgtgtcttaacctaagtgctttcttgtttgaaacgcctacaaacctccatgtggtagctcctttggcaaatgtcctgctgtggcgttttatgtgttgcttggagtctgtggggtcgtactccctcccctcccgtccccagggcagatttgattgaatgtttgctgaagttttgtctcttggtccacagtatttggaaaggtcactgaaaatgggtctttcagtcttggcatttcatttaggatctccatgagaaatgggcttcttgagccctgaaaatgtatattgtgtgtctcatctgtgaa

SEQ ID NO: 79 - DNA, 536 bp, Homo sapiens
gcacagtgtctctagacttcatcagagctattgcaaggacggtgaactttgacataataaaatacttgtatgatttcttgtgaaaacaagcttcaaagccatatggacactgtgacaatgactaagccaagctgtgttcatccagctacttagctggccaaggagaggagttctttggctctattggatttgtccaaacaggtgctggcccagcatggaatctgatgaaaatattctgattggtctgggtggatgtgagcagaagactatttaccagggaccctggagtatttggaagcaacgtgttaattataaacagcagggtttgagcacaatctgttctactcttaatgatgttatcttaacactgaaattgcctgaaacccatttacttaggactacattttgctctgtgaactatcccctgcgctttgaacgtgccagcagcccttgtttatatgcccattcttttcacttcctctccacaggagcctctgcagtcgcttgccaaagcagattttcctaaggccactgtt

SEQ ID NO: 80 - DNA, 173 bp, Homo sapiens
  misc_feature (34)..(39): n is a, c, g, or t
gtggctcagctgtttcagacaactcaaggccaannnnnncagcagatccttcagacttttcaacagcctccaaaaccacagtctcctgcccttgacaatgctgtgatggctcaggttcaggctatcacagctcagttaaagacaactcctacacaaccatctgaacaaaaagc

SEQ ID NO: 81 - DNA, 508 bp, Homo sapiens
  misc_feature (64)..(64): n is a, c, g, or t
agtggtaattttctacctccatcatggcggaagctcatgagtgatcctgattctagtataattngacttctatcctgannagatttngctattngatttgaatgggaagaanatatgcatggcaaaggtgttgctctcttgccattcgtggatggagcgaagggctacgagctgccctagaacgagggtatacccagacctcactctcccaaggaaaggaggacccaaggaagaaaacaaggcctttgggagggtgatgtctatattatgtggggaaacatcacccactccatgacttcattttagagctgtaccagacaggttccacagagccagtggaggtaccccctgaactatgtcatgggattcaaggaaagtcttctttggatgaagaagccattcttccagatcaaatagtatgtgctcctgttcctatgttaaagggatctgacacagaacactgtagtcagtattaattttaacagacccacagtttgctgaagattac

SEQ ID NO: 82 - DNA, 497 bp, Homo sapiens
  misc_feature (109)..(109): n is a, c, g, or t
tgaggcaggtgatcgacttccagtggaaggtctgagaccaccactccttgtttttatcattagagaaactttaaaaatcagtttttgatgtttgtgtgttggctgtgcntgatatttgctgccctgccatcttccctaccccctctgatagacatgggtccagagggggtggncgtgccagccttgggttagcctcctccaggcaccagtggacacggannnggctttctgctctttgctgtctccagacagtagaggtgagccacnttccaagttagcgtgattgtcaccaggcccatcatgctgctcgagcttctctggctgcgtcctcactttcacatccctagctgaggaaacagcgagtcgcatcacgtcatggaaacatgaaaaattaagctgaaaggtagaaaatgggccgtaaattgctcttagcgggtctgtttggttaattgaggagtgcctgttatcttgggcttagatccgctctgagttcagtt

SEQ ID NO: 83 - DNA, 343 bp, Homo sapiens
tggtggtccaataactctacaatcagccttgtagaggtcattaaagacagaatcctgaaagtccgtgactacaaatacattttcaaattccggagaatccaaaccttcaaattcttccactgactccatctttacaaagcccactttaatgtcctttaaggcttttataagttcttcttgttttccagcttcttgaaccaatatcactcttgtttcaatctgaggcatctcttcttctacatatgaagtagatccaataagtaagttttccttggaaatctcagtaactttagaatcaaaaatggaagagtctgccaagctagtcctcccagtagtggatgtt

SEQ ID NO: 84 - DNA, 497 bp, Homo sapiens
tggctttaaccgtgaccggaggcctgtgcacctggatcaggcagccttcaggactttgggccatgtgatgccaagaggctcaggaactggcatttacagcaatgctgcaccaccacctgtgacttaccagggaaacttatacaggccgcttttgagaggacaagcccagattccaaaacttatgtcaaatatgaggccccaggattcctggcgaggtcctcctccccttttccagcagcaaaggtttgacagaggcgttggggctgaacctctgctcccatggaaccggatgctgcaaacccagaatgcagccttccagccaaaccagtaccagatgctagctgggcctggtgggtatccacccagacgagatgatcgtggagggagacagggatatcccagagaaggaaggaaataccctttgccaccaccctcaggaagatacaattggaattaagcttttgtaaagctttcccaaatcctttcatcattctaca

SEQ ID NO: 85 - DNA, 209 bp, Homo sapiens
ccgagacttagtctcgggccgccatggccagcgtccacgagagcctctacttcaatcccatgatgaccaatggggttgtgcacgccaatgtgttcggcatcaaggactgggtgacgccgtacaagatcgcggtgctggtgctgctgaacgagatgagccgcacaggcgagggcgccgtcagcctcatggagcggcggaggctcaaccag

SEQ ID NO: 86 - DNA, 539 bp, Homo sapiens
tctaccattcagctgccattcataatcatcaatacaagcagaaaaacagtcatagattgcagcatctccagtgacaagtttgagtatcttttcaattttgacaacacctttgagatccatgatgacatagaagtactaaagcggatgggaatgtcgtttggcctggagtcaggcaaatgctctctggaggatctgaaacttgcgaaatccctggtgccaaaggctttagaaggttatatcacagatatctccacaggaccttcttggttaaatcagggactacttctgaactctacccaatcagtttcaaatttagacctgaccactggtgccaccttaccccagtcaagtgtaaaccaagggttatgcttggatgcagaagtggccttagcaactgggcagttcctggccccaaacagtcaccagtccagcagtgcggcctctcactgctccgagtcccgaggcgagaccccctgttcgttcaatgatgaagatgaggaagatgatgaggaggattcctcctccccagaataaagaca

SEQ ID NO: 87 - DNA, 373 bp, Homo sapiens
aacataaagtgtctgagccctcgagatcctcatccctaagtctgagtaaaatggactttgatgatgaaagaacttggactgaccttgaagagaatttgtgtaaccatgatgttgttcttgggaatgaatccacttatgggacgccgcagacatgctaccctaataatgaaataggtatcctggacaaaacaataaaaaggaagattgcaccagtcaagaggggagaagacttgagcaagtccaggaggagcagaagtcctcctacatcggagctgatgatgaaattctttccttctttgaaaccaaaaccaaagtcagattcacacttgggaaatgaactcaagttaaacataagtcaagaccaaccacctgg

SEQ ID NO: 88 - DNA, 419 bp, Homo sapiens
aaggctttggcaatatggagtcttgccatgttgcccaggctggtcttgaactcctagcctcaagtgatccacccacctcagcctccgaaagtgctgggattataggcactaggcggcatgcctgggccctctactctgttctgaataaaaagtctctggggatggaccctaggtgattcataggcacactgaaatctgagaaccaggtacaggaaataaaattatttgaaatgcaaaccattgaattttatgactttttcattgcttttggtaagaggctggactgtggaggagatgaaaacttgaccaaaaatggatttctgtgagcaccacagaatttggtgaggtttagtaggactccggaggaataacattcgggaaggacaggatgtctgaactgtatgaccagtcctgtcctt

SEQ ID NO: 89 - DNA, 346 bp, Homo sapiens
taattttggattgcctgcccttggctgaaatacaggggtgcataccatcttgcagtggcttggctgacattgcctctttgtcctggcctctagttttcttttgatatttcatagctctccttagtttactctgcctggatagaaagttgaccactaactgcaggtttaagtactaaactgcagccttttctgtcgccagcaattaaagaccaccaatcttgtttgtccatctacatggtttgtcggggacatttaactcatggaggtgctttagatttcaacatcagatggttgaagctggaagtttaattatatgtagagtgagaaggcagttccagttttagca

SEQ ID NO: 90 - DNA, 436 bp, Homo sapiens
tagatgaacagcgcacagccacgataatagaggagttggcagatgccctgacctactgccatgacaagaaagtgattcacagagatattaagccagagaacctgctgctggggttcaggggtgaggtgaagattgcagattttggctggtctgtgcacaccccctccctgaggaggaagacaatgtgtgggacactggactacttgccgccagaaatgattgaggggagaacatatgatgaaaaggtggatttgtggtgcattggagtgctctgctatgagctgctggtgggatatccaccctttgagagcgcctcccacagtgagacttacagacgcatcctcaaggtagatgtgaggtttccactatcaatgcctctgggggcccgggacttgatttccaggcttctcagataccagcccttggagagactgcc

SEQ ID NO: 91 - DNA, 438 bp, Homo sapiens
gagcgtcgtatatggcgggaagtccaccatccgcgaccgctcctcgggcacggcctccagcgtggccttcaccccactccagggcctggagattgtgaacccacaggcggcagagaagaaggtggctgaggccaaccagaagtatttctccagcatggctgagttcctcaaggtcaagggcgagaagagtggccttatgtccacctgaatgactgcgtgtgtccaaggtggcttcccactgaagggacacagaggtccagtccttctgaagggctaggatcgggttctggcagggagaacctgccctgccactggccccattgctgggactgcccagggaggaggccttggaagagtccggcctggcttcccccaggaccgagatcaccgcccagtatgggctagagcaggtcttcatcatgccttgtcttttttaac

SEQ ID NO: 92 - DNA, 453 bp, Homo sapiens
gacgtgaagcaggtcatgccagaccaaagagtgatttactactatgcagctgcccagaccactcacacgacatacccggagggactggaagttttacatttttcaagtggacaaatagaaaaacattacccagatggaaggaaagaaatcacgtttcctgaccagactgttaaaaacttatttcctgatggacaagaagaaagcattttcccagatggtacaattgtcagagtacaacgtgatggcaacaaactcatagagtttaataatggccaaagagaactacatactgcccagttcaagagacgggaatacccagatggcactgttaaaaccgtatatgcaaacggtcatcaagaaacgaagtacagatccggtcggataagagttaaggacaaggagggtaatgtgtcaatggacacggagctgtgacgatcctcatgtgatcatgaa

SEQ ID NO: 93 - DNA, 516 bp, Homo sapiens
cccaacttcgatggcctggagagtaatccatacagaagccggaagcagcgccaggagtgggaggtgaaggccctgctagagaaggtacctgcagagcttatttgtctggacccacgagccctggccgaggtggatgtcatctccctggagcagggaaagaaggagcagatagagaggctgggctatgacccgcaggctaaggctcccttccagccaaagccaaagcagaagggccgcagctccacggcaagcctggtgaagaggaagaggaaggtcatggatgaggaacacagggacaaggtccggcagagccttcagcagcagcatcataaggaggcgaaggccaagcccacgggggcccggccatctgccctggacagatttgtgcgctgagccagactccagggttgcctgggaacagtctctccccaagatcacctgtagggaaatgagtgttccctggaacaaggaggtgggggcagtgtggccccttccccaactgggggtggacagctg

SEQ ID NO: 94 - DNA, 467 bp, Homo sapiens
gcaagtgccgggcttgatgagctcccaggtgcagatgggcggccacccgactgaggtcctgtgcctcatgaacatggtgctgcctgaggagctgctggacgacgaggagtatgaggagatcgtggaggatgtgcgggacgagtgcagcaagtacgggcttgtcaagtccatcgagatcccccggcctgtggacggcgtcgaggtgcccggctgcggaaagatctttgtggagttcacctctgtgtttgactgccagaaagccatgcagggcctgacgggccgcaagttcgccaacagagtggttgtcacaaaatactgtgaccccgactcttatcaccgccgggacttctggtagaggcggctgggggagggtgggggcagggctggctgggggcttctccccactcccgcccccccccttatccccctctgaagacgatgggcagaggagtgacagccgcagacac

SEQ ID NO: 95 - DNA, 438 bp, Homo sapiens
  misc_feature (204)..(204): n is a, c, g, or t
cgagcccatcttggctgacggggctatcctggacaaaggtcgtgccatgttcttagtggccaagtgccaggtggcttcagcagcttcctacgatcagccgaagaaagcagaagctctggaggctgccatcgagaacctcaatgaagccaagaactattttgcaaaggttgactgcaaagagcgcatcagggacgtcgtttactnccaggccagactctaccataccctggggaanacccaggagaggaaccggtgtncgatgctcttccggcanctgcancaggagctgccctctcatggggtacccttgataaaccatctctagagaggacanccctgctgggctgctgtgcagagtataagattttggacttgntcatgtcccctctctccctataaatgatgtatttgtgacaccctatcttgtcaataaacagc

SEQ ID NO: 96 - DNA, 528 bp, Homo sapiens
  misc_feature (300)..(301): n is a, c, g, or t
agagatgatgtttccttgactgagcatcttgagaaatcaagatttagttgacaattagacatgaggagaatagagagctagaagaccttgcataaactgattgaccaagagaatagatacactaatcatgtctacaggaacagaaaataaaagagacagagaagagataataaatctgatggtaaaaaaaaaaaaaggcaggaagattacgaatggcttctactctctgggtgtggtggcgcatgcctgtaatctcagcacttgagctggggaggtcaaggctgcagtgagcctaggtanngccactgcactccagcctggacacaagagtgagagagaccctgtctccnaaaaaaaatgatttgatcatagcctcatatatgatttgactgcccccttgtggtaatttacatttgtcaatggtttagggagacttgcctgtataccgggatatacaaatttatgcaagcacgaagacagtttaatttccagttttaaacttttgacttgtgtaaaaccttatcccct

SEQ ID NO: 97 - DNA, 108 bp, Homo sapiens
cctctccaaggagtaccggttacagtacttggcctctgaaacagtgctgaacttggcttttgcgcagctcattcttggaatcccagaacaggccttaagtcttctcca

SEQ ID NO: 98 - DNA, 310 bp, Homo sapiens
atgagcccacctccaaaaaactgaagacagaggacagcctcatgccagaggaggagttcctgcgcagaaacaagggtccagtgtccatcaaagtccaggtgcccaacatgcaggataagacggaatggaaactgaatgggcaggtgctggtcttcaccctcccactcacggaccaggtctctgtcattaaggtgaagattcatgaagccacaggcatgcctgcagggaaacagaagctacagtatgagggtatcttcatcaaagattccaactcactggcttactacaacatggccaatggcgcagtcat

SEQ ID NO: 99 - DNA, 247 bp, Homo sapiens
tggagttagatattttacccttacaagaagcaaatgctgagctgagtgagaaaagcggtatgttgcaggcagagaagaagctcttagaagaggatgtcaaacgttggaaagcacgtaaccagcatctagtaagtcaacagaaagatccagatacagaagaatatcggaagctcctttctgaaaaggaagttcatactaagcgtattcaacaattgacagaagaaattggtagacttaaagctgaaat

SEQ ID NO: 100 - DNA, 532 bp, Homo sapiens
gtatgcactcaatgcctgcagtgactttgtctccaaatggaaaatggctagcatgccaatcaatggacaaccaaatcttaatttttggagcacagaacagatttagattaaataagaaaaaaatttttaagggccatatggtagcaggctatgcttgtcaggtggacttttcaccagacatgagttatgtgatttcaggagatggaaatggaaaattaaacatttgggactggaagaccacaaaactctacagtcgatttaaagctcatgataaagtgtgtataggtgcagtgtggcatcctcatgaaacttctaaggtcataacatgtggttgggatggtctcattaaattgtgggattaatgagattaatccttaaactagctgggatcatttttgatccattgtcatatttatatttaattattaaatgtatctgatgataacttgatttacagataatgttgatgacattgaccctttgtttaaaaaaagaaactgtaaatttgacataatttcatttgcaacttcat

SEQ ID NO: 101 - DNA, 531 bp, Homo sapiens
ggcactgtaatggcgttgactggcgtcagaagctggactctcagcgaggggctgtcattgccacggagctgaagaacaacagctacaagttggcccggtggacctgctgtgctttgctggctggatctgagtacctcaagcttggttatgtgtctcggtaccacgtgaaagactcctcacgccacgtcatcctaggcacccagcagttcaagcctaatgagtttgccagccagatcaacctgagcgtggagaatgcctggggcattttacgctgcgtcattgacatctgcatgaagctggaggagggcaaatacctcatcctcaaggaccccaacaagcaggtcatccgtgtctacagcctccctgatggcaccttcagctctgatgaagatgaggaggaagaggaggaggaagaagaggaagaagaagaggaagaaacttaaaccagtgatgtggagctggagtttgtccttccaccgagactacgagggcctttgatgcttagtggaatgtgtgtctaacttgctctct

SEQ ID NO: 102 - DNA, 315 bp, Homo sapiens
  misc_feature (39)..(39): n is a, c, g, or t
gcgttttgtatttcagaccattgccctcttgaacatttnccgtanccctcaaaactnttcccagtctgctnacggtttgcnctgtaagttcatncaagttccttccccggttccctgggcttgcgtgtcagagctcagtgtccactccatctggtctgccgtgctagtgtcaaggaccgcgtttcactagaggtggcaaggagctttcgtcccactgaccccatggaaacctcttttggagatttgaactcccaccgtgtgttaaaagggaaaaagtaactggaaagggtgccctttaaaacagtctagagctgg

SEQ ID NO: 103 - DNA, 315 bp, Homo sapiens
  misc_feature (204)..(204): n is a, c, g, or t
ctagaattcgaaggctctctctttctagaggtgctacatagttggtaatgcttggaatggcaatagggtagaatgattaatcaaaggcatatcttctatatctgaagagtatccttccttcagggtttaatagactgagtcagatgggtctgatattaatcaaaattgtctcttctgaggaccgctgataagcattgacttgcngtcccctaaggaaatccgagcggctacaaagcgtttctttacttntcacttcaattaatgctnncgnttcgcttggtgagtgcgtactttttctacctgtacacattcctg

SEQ ID NO: 104 - DNA, 492 bp, Homo sapiens
ttacctctctggagacttcttgctggaatgaacagtgtgctcagggactatttggaactggatgtttttgaattattttatacttagagatattctgaattttttgagggccttttaacactccccgagctgattgtttgcaagtgtgtttgttccagagtgtggaagtataaagacatgggcatcacgtaaattggttttgtttgctattctgtgtgtcagaaccaacgagtgtaatggagagggcaggtcatctcttattgtttctaaaacaacttaaaaggtgtagattgggaagaggtgagtgatccagctttctccttttggattgaggctatgtacttggtgggggcaggggagggaatatattataatactattcagttgggataatgggaaaaacagagtatatagggtatctacccagcctagaaagcacaggaacaatacgtcatatatttggaacagttattgtctgtgccatgaccttca

SEQ ID NO: 105 - DNA, 499 bp, Homo sapiens
  misc_feature (52)..(52): n is a, c, g, or t
gtgctggagtccgaagctgggcaaccccaggctctgggaagcagtgggactntgcagntcccntgaagaagcagaagctgagggcagagagcgactttgtgaagtttgacacccccttcttaccaaagcccctgttcttcagnaagagccaagagcagcactgccacccaccctccaggccctgccgtccagctaaacaagacaccatccagctccaagaaagtcacctttgggctgaacagaaacatgactgccgaattcaagaagacagacaagagtatcttggtcagtcccacgggcccttctcgagtggccttcgaccctgaacagaagcccctccacggggtgctgaagacccccaccagctcacctgccagctcacccctggtggccaagaagcccctgaccaccacaccaaggagaaggcccagggctatggatttcttctgaggagcagcagagtcccttgtaaaagactgcttttgtacagaatgcgcta

SEQ ID NO: 106 - DNA, 566 bp, Homo sapiens
  misc_feature (87)..(87): n is a, c, g, or t
ggcctccgtaagatgcttgacaattttgactgttttggagacaaactgtcagatgagtccatcttcagtgcttttttgtcagttgtnggcaagctgcgacgtggggccaagcctgagggcaaggctataatagatgaatttgagcagaagcttcgggcctgtcataccagaggtttggatggaatcaaggagcttgagattggccaagcaggtagccagagagcgccatcagccaagaaaccatccactggttctaggtaccagcctctggcttctacagcctcagacaatgactttgtcacaccagagccccgccgtactacccgtcggcatccaaacacccagcagcgagcttccaaaaagaaacccaaagttgtcttctcaagtgatgagtccagtgaggaagatctttcagcagagatgacagaagacgagacacccaagaaaacaactcccattctcagagcatcggctcgcaggcacagatcctaggaagtctgttcctgtcctccctgtgcagggtatcctgtagggtgacctggaattcgaattctgtttcccttgta

SEQ ID NO: 107 - DNA, 411 bp, Homo sapiens
gaaattgcagacttcgaacaacagaaagcaaaagaattagctcgaatagaagagtttaaaaaggaggagatgaggaagctacaaaaggaacgtaaagtttttgaaaagtatactacagctgcaagaacttttccagataaaaaggaacgtgaagaaatacagactttaaaacagcaaatagcagatttacgggaagatttgaaaagaaaggagaccaaatggtcaagtacacacagccgtctcagaagccagatacaaatgttagtcagagagaacacagacctccgggaagaaataaaagtgatggaaagattccgactggatgtctggaagagagcagaagccatagagagcagcctcgaggtggaggaggagggcaagcttgcgaacacatctgttcgatttcaaaac

SEQ ID NO: 108 - DNA, 566 bp, Homo sapiens
tccactacaagtagcagccccagtgactgtatttactgagagcaccacctctgatgcttcggaacatgcctctcaatctgttccaatggtgactacatccactggcactttatctacaacaaatgaaacagcaacaggtgatgatggagatgaagtatttgtggaggcagaatctgaaggtattagttcagaagcaggcctagaaattgatagccagcaggaagaagagccggttcaagcatctgatgagtcagatctcccctccaccagccaggatcctccttctagctcatctgtagatactagtagtagtcaaccaaagcctttcagacgagtaagacttcagacaacattgagacaaggtgtccgtggtcgtcagtttaacagacagagaggtgtgagccatgcaatgggagggagaggaggaataaacagaggaaatattaattaaatggtctgtaaacaataacaactgtgaataagattatcaaatctgttttagtgtaatgattgtcaagtttaaaaacatttttatatataaactggtatactcatgtcaatattct

SEQ ID NO: 109 - DNA, 280 bp, Homo sapiens
ggggcaactgaaaggtatcagaggaagtattgagacagttaccggagatacttcttcagctaattatcaagatactaaagttaatactaaagagcattcagtcaggaaatagtgttataaaagagaatttacttttcaagctataatgctattttgattaatgatttttctttaactgaagctctaatttaatgggaggaaataaaagtttgaataccagctttctattttctaaatattggattatatcatgaaaatcaagcagtttctatttctttaa

SEQ ID NO: 110 - DNA, 558 bp, Homo sapiens
cacttagcatcatgttctcaaggctcatccatgttgtggcatgtatcagtactgcattcctttttatggctaaatgatgtttcattgtatgagtgtgtaccacattttatttatccattcagcaattaatggacaggaacaatggcttttaagtattaaattgtaagttcaacattaaatgtatccacagttattgataatatcaagattatacatggtgtgaacagaatgctgtgtcgaaatggtatgtaaattatttgtcagcatttcatgtaagtgattattttctaaggacccttctagccctggttttaagaaatatgtgaatgtagtattttcatcaataaagtttaatgcattaagcattagcttaaaatttgaatgaaggcagatgtgaagatatttgccacatgttgtaataatcatgttttgaaattatttcaatatgaagtatttgaaaaatgtcaatacataaaggaaaggaaatgagtataattaagtcaatatatttttaaagcaatttttataatttagcagacactgcatcttaatataagt

SEQ ID NO: 111 - DNA, 445 bp, Homo sapiens
gatgattgattctggagacaagctgaaacttgaccagactcatttagagacagtaattccagcaccaggaaaaagaattctagttttaaatggaggctacagaggaaatgaaggtaccctagaatccatcaatgagaagactttttcagctactatcgtcattgaaactggccctttaaaaggacgcagagttgaaggaattcaatatgaagacatttctaaacttgcctgagtttgaaaatttgttaacaatacattaaaatcttaaagcatcaaattggtgttcgccaaggcattatgagactctactgtgttagggtatattcttttgtataaaacaaacaggtttttgaaaatattactgtatagttgttcagctaaactttgagaagaatttaattatgtctcatgaggtatcaaactatgtaattttgtccttgttatt

SEQ ID NO: 112 - DNA, 512 bp, Homo sapiens
gtaccggttacagtacttggcctctgaaacagtgctgaacttggcttttgcgcagctcattcttggaatcccagaacaggccttaagtcttctccacatggccatcgagcccatcttggctgacggggctatcctggacaaaggtcgtgccatgttcttagtggccaagtgccaggtggcttcagcagcttcctacgatcagccgaagaaagcagaagctctggaggctgccatcgagaacctcaatgaagccaagaactattttgcaaaggttgactgcaaagagcgcatcagggacgtcgtttacttccaggccagactctaccataccctggggaagacccaggagaggaaccggtgtgcgatgctcttccggcagctgcatcaggagctgccctctcatggggtacccttgataaaccatctctagagaggacatccctgctgggctgctgtgcagagtataagattttggacttgttcatgtcccctctctccctataaatgatgta

SEQ ID NO: 113 - DNA, 548 bp, Homo sapiens
taaaaaggaactccaggtctctctttttcaaacactggtgctgctaatgtttaatgagggagaggagttcagtttagaagagatcaagcaggcaactggaatagaggatggagagttaaggagaacactgcagtcattagcctgtggcaaagctagagttctggcgaaaaatccaaagggcaaagacattgaagatggtgacaagttcatttgtaatgatgatttcaaacataaacttttcaggataaagatcaatcaaatccagatgaaagaaacggttgaagaacaagcaagcactacagaaagagtatttcaagacagacagtatcaaattgatgctgcaattgttcgaattatgaagatgagaaagacacttagccacaatctccttgtttcagaagtgtacaaccagttgaaatttccagtaaagcctgctgatcttaagaagagaatagaatctttaattgaccgggactacatggaaagagataaagaaaatccaaaccagtacaactatattgcatagaatgttggccttgcagcatttg

SEQ ID NO: 114 - DNA, 253 bp, Homo sapiens
cccccaactatgaccatgtggtcctgggcggtggtcaggaagccatggatgtaaccacaacctccaccaggattggcaagtttgaggccaggttcttccatttggcctttgaagaagagtttggaagagtcaagggtcactttggacctatcaacagtgttgccttccatcctgatggcaagagctacagcagcggcggcgaagatggttacgtccgtatccattacttcgacccacagtacttcgaatttga

SEQ ID NO: 115 - DNA, 515 bp, Homo sapiens
  misc_feature (27)..(28): n is a, c, g, or t
gcttgtacgtacatatgtgaactcatnnggaaatattgtgtgtttaatgcaaatgatatattgaattgtttagcaattngttttctttgcttaacgatgtttttgagatctgtgcatgttacttaatgtagctcaatccatcttctgtaattgctgtatagattgtcatcatatgattaccacattttacttacgcatttcttttgtgatggacattaagactgtttttaggttttgctattacaaaatactacacaggagcatcactatgcctgtgtgaaagtatatgtatgaaagtttacctagggttgattcctagaagtggaattgcaaagtcataggatatttatatattggtttttaataatacttccaaattgccctcctgtactatttactcagtatttttcttgaggttgatctgaggtctaacattgttatcctatatcattttcatcccaagtagtgatatctgtgaaatcacaggtttgatgtgtgctaattatgtattcttc

SEQ ID NO: 116 - DNA, 322 bp, Homo sapiens
tttggcttctcagtagctaaggggaaggctgatgtcaggagagggagagggggctgaggaggtagtgctgtaggcccagggggtcagggaaagggaggggggcatgtgagggatggaaatgacctcctggcaccaggctcacccacccaaggccccctgccccagcactgaatcccagcgctgccctgaggcccccagccactccctccagcagcctggttcaccacacaaactctgcctggaccccattgtctgtctgcttcccacctgccctccccaccccctgcccctcgggcaccagcctgcatatgtgttcactttt

SEQ ID NO: 117 - DNA, 399 bp, Homo sapiens
ttgggttaccggtaaggctcatctttctgtgagattgtttccataaatggtcgagcctttgtctctttttctgcccacctctgtcattaaccagcgatagatttagaatgggtttcaaagtgtggttttattcttggcagtttcatataactttaattattaatcagaccactaaattctgtgtggtaggtttctctctgttccctgtatcctaataacatctgtggaaattccctttaccaatttgataagagatcattgtttagtttattgagcaacattaatttagcacatagtcacttagaaaaattttagcaaaggcttatttttaaaccagggattggtgaactttcccgcccttgggccaaatctggctttctgcctacttaggggcttcag

SEQ ID NO: 118 - DNA, 460 bp, Homo sapiens
gggatactgagggcagtcctgtggctgaggggcacagattgaactgctgaactagttggaggtctagatgaggtgctttacgcatcagctgccttagacagcttctagaaaggagcgagcgctacttcttaagtacttaagtgacatttagataatttatagtaaaactgaaattattattagccaatgcattggtgcatagaatttactagggctacttctggaagcccccaatagaatagcatttccatgtgcattaaatactttgccagcactgcctttgccagcatcctaaatctggagttttaccaagaaggaaactgtatctttaggttaatccaagctatgcatttcatatagctttttcatttaaaacaaggcaaagaaacaaattcctatgaccaaattgcttgcctacagttccctgcagtaattgtatgatctcacccagtgtgcaatt

SEQ ID NO: 119 - DNA, 520 bp, Homo sapiens
attcttcttgcaatctcctgaggattatctgccccatttttaaaacgaggtggaatacccaaggtcatgtagccagtgagtgctctggaaagccaaagcagctcatcccttcctggggaccacactgctctgctccaccagaccacactatgaaataggaataagtgctcctgttgcaggactgctgggaaaacaggtggggtgggacttaagtcaccataattttgaagacttgcatgcagagggctccaggaattgtagacattaaggaatttcactttcagttctacccactacttaagtacttgtcatgtactcttagaggaggccagtaatgatcagaaccattttactttaaaattaataatattgtattagagaatatattaaatggttatattgggttatgttaggatatatacttgaatggaaatacatgtactattagcaatcatatttcatttatccctgtaattagacaagaaagcataatatagctctactcatgggtacacatacc

SEQ ID NO: 120 - DNA, 565 bp, Homo sapiens
gtttctcttccttgaaccagtatttcccaagattgagtgacagcccaggagaggatgtgggtctcatgcagagagctgggatcttcttggccattaaagtatattgttcacccccaccccgcgagaaccaagctcaggagttgcctgcctctgcacacatgctgagtgtgctgtttgtgtatatggcaggaccgtccctatggggcatgtgtgagctccgcagctgggtcaggctcctcggtccaggtttacttcatcccgcctggacgtgatttggctttgactgtctctcctgcagcccaaagcacttcctccctgtggttgctgtagctgtctcattggagcagtgcctctccaagtttgaggatttgaacaaagaactgggactggtgacttgttaatgaacagttcagagggcagagggccatcatctcagcttgtggagacctttctttccctggatgctgcttctcagctaactccctctctcttcgtgtgtgtactcggccttcagggtttccaccgatttttacaccttcttcccaccacgatagcttggctttaa

SEQ ID NO: 121 - DNA, 516 bp, Homo sapiens
ggtctcagacccaactaagctaagcaaacagaagaagcaacagcgtcttgaacccttgtacaaccgctatgaggaacccaatgcctggagaatatctcgagctttccgacggcgctgaaaggcaagattgttcctttgcctctccagcagcagtagccagggcttggacttatcgatgacaggctggtcctgaggatacagctgtcccgtgactgactgtcttaactgagcattttctcaactcgactctcatttcttccctgctggtaaaatagaaacagggatttaaacctggctttggcaagagcctgcagcctccatcaccccaagtccttgggcccagttgggagctcatatctaacacagagacacattgcatcaacttcaagaaagggacaatttgtgcagctccaggatgggaaggtggagtgggtgagcatcttgtgcagggacatggtgagtgccctgatgccccagctagcaggagctactgtgctcatctaaagtgtttgcccc

SEQ ID NO: 122 - DNA, 213 bp, Homo sapiens
gtgagtatgaaagcgggccctggaggttgtctttgtaaagggggctgacttggtaactggtgttaacgacgagaatcccattggccattttgattcccctcaggctctctctctgagggctgatggctctagactgtgtcatggccaggagtctggtggtgatgaaggcacaagcaccaaggtagcttgtgtggcatcatgatccatttagaa

SEQ ID NO: 123 - DNA, 535 bp, Homo sapiens
  misc_feature (46)..(46): n is a, c, g, or t
taagtcaactaggtttacagtcccttatttttaatgcctaagtttngacagcaggaagaaaacaattttttaaaaattnctcattacatagacgcacaagaatatgtcacataaagaaaatgtgtttagaatactggttttctatttacgcatgatattttcctaagtaaaattgccaagtggacttggaagtccagaaaggaaaataatttaaattaatgctggtgatcttaacaatattttgtaaaatgatgcttcccccttctccatggtctagtcaattttgtacaattaggtatctgactttacaagtttgttatcctttctaatttttactgaactgaaagcacaaagaagactacacagaaaatctggaaacagttgcaggtgttgggaggaagatgaaatcgagctgtcttttaacttttgtatgtgttttatcagaatttgctggactatgctggcaaggactttgtttacgatcaaattgtactagtgtctgcagggtttgtcagtactcgtcaaagccaagtcc

SEQ ID NO: 124 - DNA, 538 bp, Homo sapiens
accaccatcctggacgaggaaccgatcgtgaatagggggctggcagctgccctgctcctgtgtcagaacaaagggctgctggagaccacagtgcagaaggtggcccgggtgaaggcccccaacaagtcgctgccctcagccgtgtactgcatcgaggataagatggccatcgatgacaagtacagccggagggaggaataccgaggcttcacacaggacttcaaggagaaggacggctacaaacccgacgttaagatcgaatacgtggatgagacgggccggaaactcacacccaaggaggctttccggcagctgtcgcaccgcttccatggcaagggctcaggcaagatgaagacagagcggcggatgaagaagctggacgaggaggcgctcctgaagaagatgagctccagcgacacgcccctgggcaccgtggccctgctccaggagaagcagaaggctcagaagaccccctacatcgtgctcagcggcagcggcaagagcatgaacgcgaacaccatcaccaagtgacagcgcc

SEQ ID NO: 125 - DNA, 295 bp, Homo sapiens
actgtgcctggccatgtaatagagacttttaatataggagggtgtaccagaagcaccagtttcctgtggcaaacagaattattcctgctgtatttgtaatctggtgccacgaggtagcccagatcccttcagctctgatggaagagcattgcttcagccgtaaatggacacctgcagaaaccttgcaccgatggatagtctccctcagctccgtgccatcgctgcagaggctgttatggacatcactgcagcccagtggctctctctcctggtctccaccatatgagttggcttc

SEQ ID NO: 126 - DNA, 167 bp, Homo sapiens
aggaaagaagcacgttccctcagctcttaaggaggctgacagtttaatgagaagagacacatgaggctttcgagccatgagcccaggaagtaagttggtttttctagtagggatgggagtaataagagctggtgaataatggagccatagatctgagttcaaatccc

SEQ ID NO: 127 - DNA, 507 bp, Homo sapiens
  misc_feature (170)..(170): n is a, c, g, or t
ggaattagttctgtccactgtggaggggagaggaaataatgctgtaaatgttgagttacagaaagtccaatgtcaaatatagtttttttgtttcctttcaaatgtattacagactgtgccaaaacagttaccaattcacactgtcaatattaaagtataccatagtatanaaannagtcagtacttgctgttaattttaatatttctgatttaacagttagttattaagtggtacttcattgctgttttagccaacgttttaaaaataatttgggagtttgactattttggcttacgtactcatttccttttctctgctaaaaatgttttgcttgtgtgcgttcctgatttttgtcttgtataatcttgatctttgaaaaccctcaaacatgtattaaattgttgtaactttttttcattagagggaagacattaaggggattggggacatttgtttcacacatctgcagtaatatgagttaactaatatttaacaagctctttctt

SEQ ID NO: 128 - DNA, 387 bp, Homo sapiens
gaaaggattacaaccctctgctggcgcggcagggccaggacgtagcgccacctcctaacccagttccacagaggacgtcccccacaggcccaaaaaacatgcagacctctggccggctgagcaatgtggcccccccctgcattctccggaagaatcctccatcagcccgaaatggcggccatgagactgatgcccaaattcttgaactcaaccaacagctggtggacttgaagctgacagtggatgggctggagaaggaacgtgacttctacttcagcaaacttcgtgacatcgagctcatctgccaggagcatgaaagtgaaaacagccctgttatctcaggcatcattggcatcctctatgccacagaggaaggattcgcacccc

SEQ ID NO: 129 - DNA, 412 bp, Homo sapiens
aatctgatgaaagctatactccaagcaagatctcagtcagagtaggaaataattttcacaacctacaagaaattcggcaacttgagttggtggaaccaagtggctggattcatgttcccttaactgacaatcataagaagccaactcgttcattcatgatacagattgctgttctagccaatcacctgaatggaagagacacccatatgagacaaattaaaatatacacaccagtagaagagagctccattggtaaatttcctagatgtacaactatagatttcatgatgtatcgttcaataaggtgactttaaaatgagacgaaaatcattaaacgtatctttgttttatcctgtattcaaataatatatcatgtacctttattgaacaaggcatccgttatatctaattt

SEQ ID NO: 130 - DNA, 407 bp, Homo sapiens
gaaaggattacaaccctctgctggcgcggcagggccaggacgtagcgccacctcctaacccaggtgatcagatcttcaacaaatccaagaaactcattggcacagcagttccacagaggacgtcccccacaggcccaaaaaacatgcagacctctggccggctgagcaatgtggcccccccctgcattctccggaagaatcctccatcagcccgaaatggcggccatgagactgatgcccaaattcttgaactcaaccaacagctggtggacttgaagctgacagtggatgggctggagaaggaacgtgacttctacttcagcaaacttcgtgacatcgagctcatctgccaggagcatgaaagtgaaaacagccctgttatctcaggcatcattggcatcctctat

SEQ ID NO: 131 - DNA, 566 bp, Homo sapiens
  misc_feature (330)..(330): n is a, c, g, or t
gctttccaattgggatatcctgtgatatgattggcaggctgtccgagtagttacacttaataaaatttgggttcgaaagcagattcctggaagttcaaaaataactaaaacagccccggataggttagaaagtgaacttaaatcattctcagaattagaaaataagaagttattttttatcttcaaagataaaaagggggccgggcacggtggctcacgcctgtaatcccagcactttggaaagccgaggcaagtggatcacgaggtcgagagattgagaccatcctggccaacatggtggaaccccgtctctactaaaactacaaaaanttagccaagatcacgccattgcactccagcctggagacagtgagacgccgtctcaaaaaaaaaaaaanaaagataaaaagagttttgagcaagctcaaagacccgtgtgccagcagtcagatgccccgttgggtgcacaggctaangcagcccggcccaatctggaaaccagtcaggcttttgccagcccctaatctaactgattggnacatgttggtggatacccccaactttgg

SEQ ID NO: 132 - DNA, 531 bp, Homo sapiens
ggctgaaagtgttaactgttccatacttttagcacaatgtgctgcataaggttacctgtgtacagagttttactttagattaactaaatattgcctgggttcagtttttatttccattctgaaatgcttcctttttattgtttgaaactgaaaataaacaattgttgaacccttttgattttacctcattttaaaactgttttaatttattatttggcttgttcttaatattagtcactaaaagcagtgggagcattgtcttatgaaatgcttaggaatcattttatatagtacatgtacaacattaaacgtgtttaaaaaagaaaaaggtaccagcgatcacttgtcccttgccattttttcttgtaattatgttagacaaatcttggcggcggggggatcaaaacataattgttttaattctacagctgtaggagctttgtattgctgaactttcatctggaaaagtttcacagtgacatttttaaaagagaatttttttatctgccgaattctaccagtgtaaccttt

SEQ ID NO: 133 - DNA, 439 bp, Homo sapiens
tagaatgggtgagtcctaccccagcccccagccatggggaagggaagccaagccaggcacactgcgccggagcccgtgctgtcagctctggaaaagaacaggtaaagtgcaaggagaatccagtaagtaaaaatataccaatgactttgtcaaatacacagctgctggctgtcaggagcaggtggctggctggggcgggtggcagcagcaccctgggaagtgttgggcgacacagcagagagacaacggaaataaatagggtgggtgtggacaggggtcccaccaactgggccagcaccacccaggacgggcttctgcctgctttccggccccatgcccccaagcccccctcgcctggctccccagtgctgcagcactgacacaaagcacccggccgaccgtgttaggaaaggactataatgtgggagtggagcaggga

SEQ ID NO: 134 - DNA, 537 bp, Homo sapiens
tgagcctgtgcgttttgcatactgggttggtttgctggggctgcggtgacagcatatgccgcgagctgggctttaacagagatgtgtgctctcacagctttgcaggcgggggtctgagatcagggtgtcgcgggtggggggtcactgctgaggccgtgaggggaatctgctcaggcctgtccctggcttctgggggctgctggtggtattttcagttccttggtgtgtggatacttcgccccatctctgccttcacctgtgtcctccctgtgtgggtgctggtgtccaaaatttccccttttcgtagtgacaccagctgtgttggattggggcccaccctgctccagcatggcctaatcttaactaattacatttgcaaggatcttatgtccacaaaagtcacagtctgaggtgctgggggttaggacttcaatatataaattttgcggttacacaattcaatccatgacagaatccaaaggtttactctggttataaaaacagtacaataaaatattgtttatagccttccctgta

SEQ ID NO: 135 - DNA, 303 bp, Homo sapiens
  misc_feature (39)..(42): n is a, c, g, or t
ggtttccagtgtttaacactgtatacaacagtgacgacnnnntntntntggggncccccncggncancngnaanactatttgngcagagtttgccatcctgngaatgctgctgcagagctcggaggggcgctgtgtgtacatcacccccatgnaggccctgncagagcaggtatgacgtggcgctgtgtcatgtgaatttcccaagaagcatttcatctgtgattccgtatgaaggctttctaagccctgaaatttgcagggtcatttcctcagtttgtgtattaaagaaaagctgccccagc

SEQ ID NO: 136 - DNA, 444 bp, Homo sapiens
cttcccccagtgattgctggttgaattcttatatggacaggtttcccttcccccagtatcgcacatggttctagttagaatcctgttagatagtgagcatctgctgttagctagacactgttgaatcaatacagtgaaacagacaggtaagcaggtggttttaatgcctcattctaagtgctatttaaattggatcttgaaagatgaataaggcctgccttaagttctgctaaaggcaatgttgttattaaggacgggtgaggaaggaccaagaagtctggctcctgcttttctacatgcctgtgaaggagacttttcatgaaactgaataaaagaaatcctttccgagatagaggagatttgtaggtgaatgcagaagtgtatccagctttgaaccatgcattccatctatattcctcctgtctgaactcatgctcttttgat

SEQ ID NO: 137 - DNA, 327 bp, Homo sapiens
tcttttttcaagtcccttgtgggcaaggatgtggtcgtggaactaaagaatgacctgagcatctgtggaaccctccattctgtggatcagtatctcaacatcaaactaactgacatcagtgtcacagaccctgagaaataccctcacatgttatcagtgaagaactgcttcattcggggctcagtggtccgatacgtgcagctgccagcagatgaggtcgacacacagttgctacaggatgcggcaaggaaggaagccctgcagcagaaacagtgatggctcctcctcctcttcccctccctctttcattggtgacccataacccca

SEQ ID NO: 138 - DNA, 199 bp, Homo sapiens
agggcactaaggcacagtatctggcagccaaggccctaaagaagcagtcatggcgattccacaccaagtacatgatgtggttccagaggcacgaggagcccaagaccatcactgacgagtttgagcagggcacctacatctactttgactacgagaagtggggccagcggaagaaggaaggcttcacctttgagtaccg

SEQ ID NO: 139 - DNA, 307 bp, Homo sapiens
tcatcctgtgaaagtggtttctctatggaaagctttgtttgcttcctacaaatacatgcttattccttaagggatgtgttagagttactgtggatttctctgttttctgtcttacaagaaacttgtctatgtaccttaatactttgtttaggatgaggagtctttgtgtccctgtacagtagtctgacgtatttccccttctgtcccctagtaagcccagttgctgtatctgaacagtttgagctctttttgtaatatactctaaacctgttatttctgtgctaataaacgagatgcagaacccttg

SEQ ID NO: 140 - DNA, 280 bp, Homo sapiens
aggcaagagctcagtgatccaggtgttccagcagctgggctgtgcggtgattgacgtggacgtgatggcccggcacgtcgtgcagccaggataccctgcccaccggcgcatcgtagaggtcttcggcactgaggtcttgctggagaacggcgacataaatcgcaaggtcctgggggacctgatctttaaccagcctgaccggcggcagctgctcaacgccatcacccaccccgagattcgcaaggagatgatgaaggagacgttcaagtacttcctccgg

SEQ ID NO: 141 - DNA, 499 bp, Homo sapiens
  misc_feature (116)..(116): n is a, c, g, or t
aatattgttttgtgtgactgaatgtgttagctcatgcctgtaattccagcactttgggaggctgaggcaggaggatcacttgaggctgggagttcaagaccagcctgggcaacatngcnagacccnntntntannaaaaaaggnattatgnggtgnanttantccaatgtgnggnantntntngntgnganncctgntcntcccgttgatcaccagggttgaatttattaaattaggcatattaattcattgaagttgactttttagtatcctgctttaagttgggagttatgagttgcagaaacgaattgctgaaatggaaactcaaaaggaaaaaattcatgaagataccaaagaaattaatgagaagagcaatatactatcaaatgaaatgaaagctaagaataaagatgtaaaagatacagaaaagaaactgaataaaattacaaaatttattgaggagaataaagaaaaatttacacagctagatttggaagat

SEQ ID NO: 142 - DNA, 345 bp, Homo sapiens
agttaggtcagtgtctcagctgctctatcgggcctataggtttcttaggcatgtttaagaagctgccactaaggatatggatatgctgaacagcttagagcttctcattgaaatttaaccctaacagctccactcttgtctgttttatttggtttatggctttataaaacatcatttgacttttcagttttcactgcaaaaaaactcaaaagtttgaaaatcagaactgatgcctttggtttcatcatctttaaaatatctgattctttccaacatcctaactataaaaacagaaggactttattgccaatagtctaaattaaaaatccacctagtaaataccag

SEQ ID NO: 143 - DNA, 515 bp, Homo sapiens
agctttaattcgtgccttgtttcagaacacagaaagaagagcagctgcccttgctaaaattaaatagctccatcttcttaagaaagctatgtcttgaatatgtggattcttcccttggcataattactcccttaaagacttctttgaatcgcccattggttttggtgaaccagtacatcttggaagtttgactttacagaagaacgtctacctcctggcctgtacgaggctttgtttaagaactgtttattaagataaattgtcaagtaaagcacctcaattcattgactttctagccatcttcctttgattagctaacaaactgtcaggcagcattatttcatgctgcttccagagcctctgggagctatatacattgtaaatgcaggccctagctttggaacgaggaattgggagattccaggagtcagggtagagaatttctgagcaaatcggagatattttaggggtgtggaggaggggaagggaggaatgggccaccatatttggcttac

SEQ ID NO: 144 - DNA, 433 bp, Homo sapiens
  misc_feature (26)..(26): n is a, c, g, or t
acacccagccagtaatctttagcttntagaaacaatcaganttccttaaganttttgcaattaggtttagaggagctcacttgctttttcaaatatgggttggatatgtccaaaaaaagagttttgcctctacaatgaaaaatgatttttaccagattatggaaaggaagattcataaaaatgtgcctttaaaaagcttttttaaagtgcaagttcaccaatttgacttttgaaaatacgttcattttaggaattgattttttaaggaaagttgtaaacacagcaaagcacagaattacactggttcagacttgcatcttagcaccaaaatccactatacaaatgcagacagcataaagtaacctagttncgctttaaatttgttgcttattttattctcccttataaatgtcattggtcttttgttagaaca

SEQ ID NO: 145 - DNA, 413 bp, Homo sapiens
tcacctctagaatagccacccaaagaccttcctgaggctgcctcagaagcaccacttgctgttttgaatgactctactagtatgagaaggatgtgaaggtggttggctggttgggctttaacttcctgggattcataatttttaagcttggaagatagctgctgttcccatgatgggcacatttcctgagaagcttgaatgactgatgagcatagagcacccctgccttcctcaggaaacctgaccggcaggggctctctggcttcctgaaagcttcacctcttccctcgtttatatctcaactgtaagggcattttcaagcttctgttcatggaatgagcaactcagactgtctggagcttgctgagtacaaacacaccaccactaagtttcagaactttccttaggacttg

SEQ ID NO: 146 - DNA, 476 bp, Homo sapiens
gtgccgagaactaggacctcgtccccttctctatcccttcccctgatccatctcgtctctgttctccttcccttttccgttcccgaagccggaaggagccgaggtacccacggaaaaagtcgaagctgtccccggagagtgaggccttcacgaagcggtggcggaaggagccgaagttctctgatcggaggcgtgagcaagtggcatctccggaaagagccgaaacacggactcgagcttaatcccaggaggggcccgagggcgagatccggaaatctccggaaagagccgaaggccgggacggttaggattgtcggaagtggccgattgcttggacagggccggcggagaagatcggagcaagtccgtggaagaagccaaagactgggacggattgaattgttggaagaacccgaactcgcagaggggactgggcgcagtggcacacgaggacacacggaaacctccgaacgttg

SEQ ID NO: 147 - DNA, 504 bp, Homo sapiens
acccggtctaaatccaaatgcttctccagccatccaggagtggctgtccttttcagtcttgtcttttatataggtagctgagggggaagatttagaagccttgcactcactaaatagattaaacagagcaggcttgtttgttgaattgctccaaagtccaacagacacacactgagcaggtgttttacactcacattccctttttgccccttaaatagaaagtgcaggtaaaggtttatacaacaagaaagcacattgaaaataatttgatactctaacaatccattaacatgtgtaggggttacggtgaggatcatgtgttgtattcgaaaaacggggagagggatgcttaattggccctcgcttgctatttttttctcatttcttcacaataggaccgtctttggcagcagcaaaatgtatttcagtatggcagtctttcctctcttacattattggtaagattatactaacaaaatgtttccccttgtacaattatgctgt

SEQ ID NO: 148 - DNA, 499 bp, Homo sapiens
  misc_feature (27)..(27): n is a, c, g, or t
gtctggtatttcaggctggactccctngcngctngctngcacngtnaacccatngttccngtaagtcccacaccaacactctgcggcctgctgttcccacaatcagccggtctccagacactgagagggtatatacnttttcagnctgagagaaggtnccagcattancaaggagttctgggatcccacagtttaactgtctgatcccaacttccagtgaccatcacattcacttctggacagtattcaacacatctgataggggcatcatgggtcccaacaagattttcttgatcagtgttcaaatcatgcattttcaattgatgatctagtcctccactccaggcatgcgttggatcgtagaaggcgcagtccaggacggcgccggtgtgctggtacttgagccgcatggagttggccggcacatcgtagagacgcacggacgtgtcccaggaggagacaagcaggaactgggaggtgttggggctgaacttcacgg

SEQ ID NO: 149 - DNA, 529 bp, Homo sapiens
  misc_feature (147)..(147): n is a, c, g, or t
ttcaagtattcctattgtactggagaagctgggaaggagattgttaactctgaggagtgtattataaatgagataactggggaagaatctgtgaaaaaacctcaaaccctcatggagctgcatcaagaaaaactgaaagaggaaaanaanaagaagaaaaagaaaaagaagaagcatcgaaagagcagttcagatagtgatgatgaagaaaagaagcatgaaaaattgaaaaaggcactgaacgcagaggangcccgccttcttcatgtcaaggagaccatgcagattgatgagaggaagcggccttacaatagcatgtatgaaactcgagaacctactgaagaggaaatggaggcatatagaatgaaacgtcagaggccagatgaccccatggcctctttccttggacagtagcaactagtcagaagaccatccaagatagatgcagctgatacattcttttcagcttcttattgatgattgtagatagaaaaatccttgtttattcttcttgctgcctggctttaat

SEQ ID NO: 150 - DNA, 314 bp, Homo sapiens
  misc_feature (133)..(133): n is a, c, g, or t
aaaatgaatgtgaatctgcagatacacagaaagtaagctaggatgaagaaaaggtgttagggaagttaacagctgagatgccaccagagccaagtgtttgagagttttgtgtctcaatacctaggctcacatntgcttttnagtcattgtncttccttattcagcagctgggagaggtaggaaattagagccaggaggaatgtttgacgttacgtcattaatctcagacatcttgtagattaggaaaagtgacttggtcgaggtcatacacctatatagtgacaagtaagaagctagaggagtgccgagcgcag

SEQ ID NO: 151 - DNA, 507 bp, Homo sapiens
  misc_feature (48)..(49): n is a, c, g, or t
tatcctaatatttatagccagcagctgttactttgtttgtaaaatttnnaaaaaancnaaacctgaagtnngtttattgaaagaattataaggatagcttctagggatattagtaatagattgccatgatccngaagcctcttctcagaacactgtgaagataatactgacagagtagaatcagtgaaaacagcctaacaaaacctctgacatcagtatatcaacttttaacagcccactcactggcttttctaaactaccaaaaaccacctgtaggatactgcattaagtcagcatctcagaaacagtggtgtgagtaactgagtcaaattgtcaagtactttggatatacatagtgtcgagctttagattggtatgaaattaaacagcaatgcaaatagatttaattcctatttactttaagaatgaaaaacaatgttcattttcctacctaaacagggtggttcaacataaaggctgatgttgtgtccgttttgtattttatct

SEQ ID NO: 152 - DNA, 362 bp, Homo sapiens
ggataaactaacctgttgattcaatattatttgactccttttttactaccgatgaccaaatgaagcagtgtaattaatggaaatagttgagtggactttttctcagtggttaacatgcccattttaaagagtaatacttacctttaagaagaatgttgttgaactctttgcatgttatttagtatgatgtgcagaaaacacttaagaacgtacctggtcttcatgaattcctctttggaactgggaaagagatccctgtggctattaaaaaggggggagggttcttacacaccattaattatgaagcaaaaggtttatttgcttaaaatgtcatttaaagatacttaaactgcatgcaaact

SEQ ID NO: 153 - DNA, 429 bp, Homo sapiens
aaagcaaatatagttcatgacctctagcaactgttgaaaactgctctttagggatgacatgctggcccttttttttttgttgttgccaaggctgaagtgcagtggcaccatcacagctcactgcagcctcgaactcccaggttcaacccttcctcctgcctcagccttcccagtagctgggactacagatgtacaccatcatgcctagctcatttttaaaaaaattttttatggcattgtatttatcttctctttataaccaggggttgaccagccacagaacttgtaaagttttttatatttttaaaaggttgtaagaaatagtagtagttggctggtccccgctgctctcctgcattatagtatacttctgttcacctagtttgctagagagaggcagtatagtgtgtatagtgatttccaaacttt

SEQ ID NO: 154 - DNA, 539 bp, Homo sapiens
tgttcgaaaacgtcggcaggttctaaaagatctagttaaagttattcaacaggagtcttacacatataaagacccaattacagaatttgttgaatgtttatatgttaactttgactttgatggggctcagaaaaagctgagggaatgtgaatcagtgcttgtgaatgacttcttcttggtggcttgtcttgaggatttcattgaaaatgcccgtctcttcatatttgagactttctgtcgcatccaccagtgtatcagcattaacatgttggcagataaattgaacatgactccagaagaagctgaaaggtggattgtaaatttgattagaaatgcaagactggatgccaagattgattctaaattaggtcatgtggttatgggtaacaatgcagtctcaccctatcagcaagtgattgaaaagaccaaaagcctttcctttagaagccagatgttggccatgaatattgagaagaaacttaatcagaatagcaggtcagaggctcctaactgggcaactcaagattctggcttctact

SEQ ID NO: 155 - DNA, 162 bp, Homo sapiens
  misc_feature (38)..(38): n is a, c, g, or t
agcttgcatggccttgtactgcattggggtgatgtgcntcaaagcctgggggtggcacgtcccagtatttacggaccttcttcttcttctcgtggcggggggaacgaatcagtccaccgtgctcctctttagcgcctctggtcaaaggtttgctgcgtcgtc

SEQ ID NO: 156 - DNA, 305 bp, Homo sapiens
tccgtgtttcctaacgtggagtgtatgggtctaagagagcctgctgtcctccctgccttccaccttggagaggaggctggacgcatcagcagtggccagggcaggtcgcaaaatctcccagcctagagaccacacctgaaacggctgaagccagcttgcacaagggctgctgtccctctgcggcaggcagagctggtgggggcaggggtcacagagcagtcatagacaccatggaccagggcaggagaagggcagatggcacatgggcacaacagggccttgtccttagagcactggggggtcat

SEQ ID NO: 157 - DNA, 371 bp, Homo sapiens
gaaagttcctgccagcagtttgacaagctgcggaagcgggatgccttcctcgagcagttccgtaaggaggacatgttcaaggacaactttgatgagatggacaggtctagggaggttgttcaggagctcattgatgagtaccatgcggccacccagccagactacatttcctggggcacccaggagcagtgatttccctccccactactccttctccttctagatggtaaccacagcctcgaccatgcctgctccctctgacccagcttcacctcatggacaacccttcttggttcatctccagcccgtgagctggtcctgcttcctcccttccatgccctaacttttaatatgcttgttcagctctaata

SEQ ID NO: 158 - DNA, 479 bp, Homo sapiens
gcagaagaaagtcttcccacaaccccattttatttcatattgggaaaacacaggcaacagcaggatgaaaaactaaacgaaactttagagaatgagctggtacaactacccttaacagaaaacatacccgcaattagtgagcttcttcacactccagcccatgtcctgccatctgctgctttcctgtgctccatgtttgtaaattcattgctgctgtctaaagagactaagagtgctaaggaaattcctgaagatgtagatatggaagaagaaaaagaaagtgaagattcagatgaagaaaatgattttaccgaaaaagtccaggatacaagtaacacaggtttaggagaagacattatacatcagttgtcaaaatctgaagaaaaagaactgagaaaatttaggaaaatagactacagctggatagctgccctttaagccttggagatggggaggatccttggactttgtgtttttga

SEQ ID NO: 159 - DNA, 567 bp, Homo sapiens
ggatgcccctgaagaggttcgtaaccgtgacttcaggagagagttggaagaaagagagagagctgctgcaagagagaaaaatagggatcgtccaacccgagaacatacaacctcctcttcagtgtcaaaaaagccacggttagaccagattcctgccgccaaccttgatgcagatgaccctctaacagatgaggaagatgaagattttgaagaagaaagtgatgatgatgatactgcagctcttcttgcagaactggaaaaaattaaaaaagaaagagctgaagagcaggccaggaaggaacaagaacaaaaagctgaagaagagaggattcgtatggaaaacattctgagcggaaaccctctccttaatctcactggcccatcccagcctcaggccaacttcaaagttaaaagaaggtgggatgatgacgttgtcttcaagaactgtgcaaaaggtgtagatgaccagaagaaagacaaaagatttgtaaatgacacactgcgatctgaatttcacaaaaagttcatggagaaatatattaaatagtacagttttatgtgcttaat

SEQ ID NO: 160 - DNA, 437 bp, Homo sapiens
gttggctcagtgtatgctggggacaaagaaaaactaacaagccgacctgcctttatgataaattctagtgtgcttacaagggatgacttcctgaggtgtgatctgtccaccttgaagaactccacaactgaagaaggggagctgtgagaacgtggattgttctacaacttgcacagggtaacagaggaagtggctgaggcctagagtcacgttttccagttcccttcgcaaactatatttcttggaacgcgaaaggaagctttacctatttcatagaagacctggaatccataacctcagaaggcaatattattgatagaaaatgtggaaggatcaggaagttcttagattcttggatgacagatgcatgttgatgccctatggagatgtccttgtgttttgaggtcactgaggtaggaagacctgtctactcttgg

SEQ ID NO: 161 - DNA, 351 bp, Homo sapiens
cacagcagggcggggtaggaccccagcccctcccaaaacagcctctccttctcccatagacccctttcttctccccttccccacggtaggaacatagcgtgtttatattttatggccaaactattttgaattttgttgtccggccctcagtgccctgccctctcccttaccaggaccacagctctgttccttcggcctctggtcctctctggtcccctcctgggtttcttacgtagttgatttttcctctttagtctcccccgacctgcgcccagccccgtggcccctgcccctctcctactctctgtggcagtttcatatttgctaagacgaatttgctcattaaacatt

SEQ ID NO: 162 - DNA, 255 bp, Homo sapiens
attgtcctgcagaggttcattcccctgaccctttccccacattggtaagagtagctgggttttctaagccactctctggaatctctttgtgttagggtctcgatttgaggacattcatttcttcagcagcccattagcaactgagagcccagggatgtcctacaggatagtttcatagtgacaggtggcacttggctaatagaatatggctgatattgtcattaatcattttgtaccttgacatgggttgtctaa

SEQ ID NO: 163 - DNA, 357 bp, Homo sapiens
  misc_feature (83)..(84): n is a, c, g, or t
atagtgaattgttcccaatgttgaaatggacgtgtaagcctttgagctagcttggagtcgaatacactatttttcactcacannanntattcatctttgtatttaatactatagctctgtcaatatcacatgaggcagtttttcaaatacgtataaacagaggttgcttattattaaaggaaagacaaagtgggactctttatgatgtcatgaccatgataactaagcacctaagaaaattatttaaaatagttatgtggtaggcagaaagacaaataatttagttttttacttttcaccagcatgtatcttagctacctaaactgaaacatgggaggctgggcttaattcaaaata

SEQ ID NO: 164 - DNA, 385 bp, Homo sapiens
gcttgtattcaggttcattggcttttgctggatgatccacctaaagaagttacctaatttggccttttaaaaaaggtgttagtgtttattatagctactttcaaggaaagtttgaatatgattctagtctctaaagttcttcacgttttctgacattccctggagggtgactggggaagaattgctccagggtagaagaaccaggcccaagactttaccattctgatctagagacaaaggatactcaatgaggagcttttttcccctcttggaacaggtaaaatgctttttcttattaatataattataaaacagtattttatgtaacagctattcccatattctaggagtggcctaagaaatgcgtgtttcagtgactagatta

SEQ ID NO: 165 - DNA, 481 bp, Homo sapiens
  misc_feature (169)..(172): n is a, c, g, or t
gtaaaaaggaactccaggtctctctttttcaaacactggtgctgctaatgtttaatgagggagaggagttcagtttagaagagatcaagcaggcaactggaatagaggatggagagttaaggagaacactgcagtcattagcctgtggcaaagctagagttctggcgannnntccaaagggcaaagacattgaagatggtgacaagttcatttgtaatgatgatttcaaacataaacttttcaggataaagatcaatcaaatccagatgaaagaaacggttgaagaacaagcaagcactacagaaagagtatttcaagacagacagtatcaaattgatgctgcaattgntcgaattatgaagatgagaaagacacttanccacaatctccttgtttcagaagtgtacaaccagntgaaatttccangtaangcntgctgatcttaagangannntagaatctttaattgaccgggactaca

SEQ ID NO: 166 - DNA, 508 bp, Homo sapiens
gcagaagatgggcctccagaactcctgtttattcatggaggacacactgctaagatttcagattttagctggaaccccaatgagccttgggtcatttgctcagtgtctgaggataacatcatgcagatatggcaaatggctgaaaatatttacaatgatgaagagtcagatgtcacgacatccgaactggagggacaaggatcttaaacccaaagtacgagaaatgtttctgttgaatgtaatgctacatgaatgcttgatttatcaagcgccaaaaaggcattgtatagtaggaaatgtaagtggggtggcttatggcttctttatcctctgattctagcactttcaagtgagctgttgcgtactgtatcatattgtagctattagggaagagaagaatgttgcttaagaaagaacatcaccattgattttaaatacaagtagcagggtattgcctttgattcaactgttttaagtcctcattttctcaaactaagtgcttgctgtt

SEQ ID NO: 167 - DNA, 328 bp, Homo sapiens
  misc_feature (124)..(124): n is a, c, g, or t
tggggtgtgggattttcccagtatgtgtccctgcaccaggctgtgggctctgctgccgagggaccttgatggcccccacttcacctccaggtcccagcactcagcagggcaggggctcagtgcngaaactattttttttgaatgggcttctcaagttctaatactgggaaattcctgctgcttgcaaacactctggaaccaaccnacctgggtttcagcccagtncagctgggngactctaggcaagtcactcgaacctctgtgtctcaattaacttatctgtaaaaatggggggaagaccacctacctaatgcagttgttatgaaga

SEQ ID NO: 168 - DNA, 544 bp, Homo sapiens
atgtttccttgggtcagtggttttgaggtccagtagctaggcttttctcttttgtccttcctgttggaatgaaaacatttcgattttccttcatctgtgactggtgccatagacacaggtttatagttttaacttacagtattgtttgaaatttacctgtttttcttgtcaaacctgagcactcctcctgctgaagtttcttatttaattccagagtactgtcctctactctaaggcattacttttaagggtattatgaaggcagtttttcaaaggatatgaccagttggggtaattcaaattaaaaaggaaaagatttgtttggagtaactggtgtctctaagggggatttttagtgtcaagtatggcggctctttcacccctccattgagagcccttgttattcagagctccaagactagacctggctaacaaacataggagacaaagttaggaaacattgatacaagctttgtacagagatttgtacatttgtgtaataggccttttcatgctttatgtgtagctttttacctgtaacctt

SEQ ID NO: 169 - DNA, 199 bp, Homo sapiens
agttcacccctcaaatcctggggtgcaccccccaactcccatgcccccaatgctgaggcccccacttccctccgaaggcccagggaacatacctccccctcccccaaccaactgagaagctgctccctcccccagcaagcccagcgccaggtgctcttgccttttcccactgagagaaggctgctcttttgtactgccc

SEQ ID NO: 170 - DNA, 503 bp, Homo sapiens
agattgaagccaatgctgggcaactgtacctgacaggggtggtggtactgcacaaggatgtcaacgtggtagtagtggaagggggccccaaggcccagaagaaatttaagcgtcttatgctgcatcggataaagtgggatgaacagacatctaacacaaagggagatgatgatgaggagtctgatgaggaagctgtgaagaaaaccaacaaatgtgtactagtctgggagggtacagccaaagaccggagctttggagagatgaagtttaaacagtgtcctacagagaacatggctcgtgagcatttcaaaaagcatggggctgaacactactgggaccttgcgctgagtgaatctgtgttagagtccactgattgagactactgcaagcccttgcctctcctcccttgcctttgtctcttcagtcctctcacttattctatttcccaaccccctcccacttgtttgtgtgatctcagaactgtgccaagcagacactgggac

SEQ ID NO: 171 - DNA, 458 bp, Homo sapiens
  misc_feature (77)..(77): n is a, c, g, or t
ggaatgaggaacacccatctccttggccctctccaccctgaagagttagttattaaaataattggcaagctcttgcnaatgtcagtcatccattgttcagaatggaatagcaataatacatccctggctgccctgggcttggccaggattactcactgaaggcctcagggttactggcacacactttcttttcctaataatcccatcccctcagctttcctaaggctagagtgaatttcgtgttcctttagtttacataagatggtgaacttggcaaaagctatcattaaacagaagctaagagaaagcctatgtcgtggaatccagaatgggtattgccattcactgctgtccacagaagctgtcttgaatttctttctgtgtcttttctttttttttctttaagactgttgtttaccagactgggctctgtggaacacaggtgtcctgggagatgg

SEQ ID NO: 172 - DNA, 201 bp, Homo sapiens
ggctggcatccctgtagagccagaggggccacccagggcagtgacattccagatatgttgggctcacctcatccttgctgtgagactggagttccatggggacatgaagtcagtacaccgcagagctgctcagctgctctacctctcgctgacttttttgttgcacatatacattttctttcaattagcatttatttcagc

SEQ ID NO: 173 - DNA, 334 bp, Homo sapiens
ccctgtccagactcgaggcagtggtaacactgcacagtgctatgtggcttctctttgaggatttttgggttttgtaactaaattcttgctgccctcatactttttatgtattagaatcatattcgtattgcccttttaaaacattgggatcctccaaaggcctgccccatgtatttaacagtaatacaggaagcatggcaggcaccatgcaaaccaaggatggatggtgcagtccctgtgtcagtgggcggtggtttcctgctggcctggaatcactcatcacctgattgattggctctgtggtcctgggcaggtgcctcataggtgtgtggat

SEQ ID NO: 174 - DNA, 251 bp, Homo sapiens
ggcctattctaggtagttccaaatagtatttttgttgtcaaactttaaaatttatattaatttgcaaatgtatgtctctgagtaggacttggacctttcctgagatttattttatccgtgatgtattttttttaattcttttgatacagagaagggtctttttttttttaagtatttcagtgaaaacttggtgtaagtctgaacccatcttttgaaatgtattttcttcattgcaggtccacctaatcatc

SEQ ID NO: 175 - DNA, 550 bp, Homo sapiens
gaagaccctttaaagcagtgaatctgaaacaattttcacacccttaagtggttgatacgtacctattttaggtattttgaggtatttaccataaactaaatttagaaattttttagattcacttgaagtaaacattacaaacattggatacggtggggttttctttagattttacttgagagaaggtgagtacaaagcaatttgcagttgttgtaatgacaagattactgcgcaagtgtgaatccaaacagtatagcttttaaattttaaagcatttggtaaattatcgctgagtttttttctgttgccaatagcaaactgcttttccattaatggagaattcatgcctttcaagcattttaaatatgacaatatttataaatgtatggtttggaggaatcgtttaaattctctttcctaattttctttcttttgaagatagattctttcaacaagtaatttgtagtaatgactgtgttgacttcaattttggagcgcagtagctatgttaaagatgaactatttggtctcattgaagccaacacagaac

SEQ ID NO: 176 - DNA, 130 bp, Homo sapiens
ctccgaaggcccagggaacatacctccccctcccccaaccaactgagaagctgctccctcccccagcaagcccagcgccaggtgctcttgccttttcccactgagagaaggctgctcttttgtactgccc

SEQ ID NO: 177 - DNA, 501 bp, Homo sapiens
gcagcttggagtgctaactggaagatcaaaatcatgtctcttgctgataacctaagagcattaagctctgagtccagtgaggtcatagcagtgtatgctccttgcccttacggagtgtctgtttttagaaatttagattttaaaaggcgtgggacatacgaccaggccctatagccacataaatataaatttcatagaaaaagaataaaagcggagatatattttttgacacagaggcacccaaagaaatacaaacattgcctagctgctgccatttctgtaactgcccagaagggtgacagatttctgaaggggaaaggattcagatatgaccttttctttagtcccaaccactagttttaacaaatgtgaattattgaaatgtgaagggacaaaaagaatcatacatttaaactgtcttgttcagcataccaatattgtatgttacaaatcatcatttctaaatctggattgattctgttgtgtttttgactgtttcta

SEQ ID NO: 178 - DNA, 516 bp, Homo sapiens
  misc_feature (26)..(26): n is a, c, g, or t
aggctcgtgagccatttgtttctttngctggttatagttgctaattctaaagctgcttcagactgcttcatgaggaggttaatctacaattaaacaatatttcctcttggccgtccattattttctgaagcagatggttcatcatttcctgggctgttaaacaaagcgaggttaaggttagactcttgggaatcagctagttttcaatcttattagggtgcagaaggaaaactaataagaaaacctcctaatatcatttntgtgactgtaaacaattatttattagcaaacaattgatcccagaagggcaaattgtttgagtcagtaatgagctgagaaaagacagagcatatctgtgtatttggaaaaataattgtaacgtaattgcagtgcatttagacaggcatctatttggacctgtttctatctctaaatgaatttttggaaacattaatgaggtttacatatttctctgacatttatatagttcttatgtccatttcagttgaccagccg

SEQ ID NO: 179 - DNA, 328 bp, Homo sapiens
gcctgcactagggcaaaggccagtaggaatagattggaggtgttaaggtgtgaactgttaaggtaagatgataacttaatgactgattattggatgtggagggtgactgagaggatagaatgagtacccatgaatagccatgattcctaccctgtcccagtcatctctttccttatccatctctgaaacaatctgcttacatcctcctcagcaactggaattcctcaagttagttagacattctgtgtgctgtgtggtctctcactgcccccccactccccacccctccacaagccattgattcattcatccagttcaataaatcttg

SEQ ID NO: 180 - DNA, 511 bp, Homo sapiens
ggcagacgtggaaggactttgaggtccggcatggcaatgaggacaccatcaaggaaatgctgcgtatccggcgcagcgtgcaggccacgtacaacacgcaggtcaacttcatggcctcgcagatgctcaaggtctcgggcatcccgggcaccgtgtctgacctggcccctgggcagagtggcatggacgacatgaagctgctggaacagcgggcagagcagctggcggctgaggcggagcgtgaccagcccttgcgcgcccagagcaagatcctgttcgtgaggagtgacgcctcccgggaggagctggcagagctggcacagcaggtcaaccccgaggagatccagctgggcgaggacgaggacgaggacgagatggacctggagcccaacgaggttcggctggagcagcagagcgtgccagccgcagtgtttgggagcctgaaggaagactgacccgtccctcccccatcccccctccccacccccatccccaatacagctacgtttgt

SEQ ID NO: 181 - DNA, 285 bp, Homo sapiens
  misc_feature (236)..(236): n is a, c, g, or t
aaatgatctcagtatcctctttcttgtatttttcttaattcaggatctgggccttttgggttctgcagccgtatgttgcaaatattttcctacttttacttgacttttgacttaggatgtcttgttagagaagttcctaatttaggtgcagtccaatgaatcaatcttcttctttattgtagcccttttgatgtttaaatttcccctattccagggttataaactcctatgttgtnttctacaattgcagtgttcaatatagtaccagtaactacaggtggctac

SEQ ID NO: 182 - DNA, 537 bp, Homo sapiens
  misc_feature (77)..(77): n is a, c, g, or t
ttcacaaatgatatcacctccttgggaaactgttagttaataccttacctttagaaaaggcatagtaatcatagccngtnngttttntgangttgggcantngntatancntgnggnanccacatttggaagtcctntncanantntnctnactttaacttcattatgaaggacacctgtaagtggcatgtttaataaaagataccagattaaaaggcaatgtactatcttggaaagagccagacatctgagttttaatctcagttttagccctctgatgtagaactattgagggttatagactggtatataatgttcttggtaagaagtacttgataaatagtattggttataactaacaaacctgaacaaactgctttncttacccacaaggaaaaagaaagtattggtctttggttattcactaaggcaagtggatgagtttttcatcagtaagcttaaattattagggctgtttgatcagtatccatatttcataagccttactgtataagaaactgtattacatctacttat

SEQ ID NO: 183 - DNA, 444 bp, Homo sapiens
tgctcactcgtgctgagggtcacatgggctctgaacctcgggatcaggatgctgagaagaagaagaagccccgcgatgtggcccgcagagacttggcctttgaagtccctgagcggggcagtcgacctgcctccccagctgccaagctgcccgcctcaccctcaggctcagagggtctctccagtgtgtccagcagccccacctccagtcccaagaccaaagtgaccacagtgacctctgcccagaagtccagtcagattggaagttctcagctgctgaagagacatgtgcagcggacagaagctgtgctgacccacaaacaagctcaagttcccatttcatcagaaccaccagaggaaggagagaaagaggatcttagggttcagctgaagcgacaccatccctcgagtccccttcctgtctactcttggtttcaccactaga

SEQ ID NO: 184 - DNA, 281 bp, Homo sapiens
  misc_feature (34)..(34): n is a, c, g, or t
gcctggcacagcgttcaggtgttccgtgtccccntctcctttccctctccccatctcacccctggtctgggtgtgggggtgcagctgtgagtagcacagacaggacccctgccccgtggcgtggacattcttgttggggccgggtcaaagagacagtcaacaggtgaactctgtcctgcgtctagcggtgctaagtcaacaccaagaagaaaaagaaagggggtggcggtgaggcagcattaggtgctgatttaactaaggcacgtggatactcggggggc

SEQ ID NO: 185 - DNA, 558 bp, Homo sapiens
ccggctccattttacttgtttgatgaaattgaccaggctctggatgctcagcacagaaaggctgtgtcagatatgattatggaacttgctgtacatgctcagtttattacaactacttttaggcctgaactgcttgagtcagctgacaaattctatggtgtaaagttcagaaataaggttagtcatattgatgtgatcacagcagagatggccaaagactttgtagaagatgataccacacatggttaattggaaaatactacctactggtttgggagatgtatatagtaatatgattctcatacccaggaactgtaaatttaaacctaaatatttggccaatagttttcagacttaaagcatcatagtccttttatatttgtctttgtattttataagatactctgtaatgtcatgtttgtactgatagtttaagaatttaatttcctgtacaactttttgtaaaatgttctgctcctattttaaatgttttgaaacatgctaaatattctttcctaattattttatcacttatactaccttttttatagcttcaat

SEQ ID NO: 186 - DNA, 489 bp, Homo sapiens
  misc_feature (345)..(348): n is a, c, g, or t
agaagagtctgatgctgttactttgcgatcctgctcttggtttccactgtccaggccatacaactctgtctactcccattagtatttaccaacaggtgttaaaggaaagctgaacaagcagcctactcaccgatctgctaggtggtcttccatgttcatggtggcttctgcagtttcattgagagtaacattgctgttaatacagatagatccagtagtagagacatcatcggtccaaaagactttgcatctcattagttgtccatagtgactaccaggaggtggctggcatctataacgtgtgggacgtttttatgtaaagaactgcctgtgtttttttttttnnnnaaccaaagacactgaccatagattgacttatacttttataagtctaattgaaatacttggggtactatgaaaggactgttccttgagtggctacgattagaaaatcaggactaacaaacttttctttgtctggaagcatat

SEQ ID NO: 187 - DNA, 160 bp, Homo sapiens
gtatcgcagtgttgggtaagactttgaacaagcttgttctcaggctttgataagtagtgctgtttgccagctgtatattatccctaaaaataagtaataaggtatatatggtacatattttgacatgcatatacatatttgcatcctgactaggctgccc

SEQ ID NO: 188 - DNA, 469 bp, Homo sapiens
aaatcatgtcgtgacacgtttccctgtctgtgtcttttcagaggctggctagtatttcactgagtagatgtatgaagatgtatttcaccaccttctgttaggtagatagctgggttctattttggtttttgatattttaaataatgctctggtgaacacttgtttattcttgtgtacctctgggagcatttctccaggccagagaataagtagaggatgtgtacctctaatatctgggcagctgctcactaactgcccttcaaaaagtttttgctactttacaattctagccacggtgatgaaaatatgtttcatattttgtggaaatcaaaattttaactttattaatctgggtgaaaaatgaaattgttttaatgtgcattttcctgattacttaagaagttttatgtcttttatgaaatgtttgtcatactctttgaattatagtggctttgtatattcagatgtt

SEQ ID NO: 189 - DNA, 556 bp, Homo sapiens
gggagttaggaccaccaatggattgtggaaaatggagccatgacaagaacaaagccactgactgagatggagtgagctgagacagataagagaataccttgtctcacctatcctgccctcacatcttccaccagcaccttactgcccaggcctatctggaagccacctcaccaaggaccttggaagagcaagggacagtgaggcaggagaagaacaagaaatggatgtaagcctggcccataatgtgaacataagtaatcactaatgctcaacaatttatccattcaatcatttattcattgggttgtcagatagtctatgtatgtgtaaaacaatctgttttggctttatgtgcaaaatctgttatagctttaaaatatatctggaactttttagattattccaagccttattttgagtaaatatttgttacttttagttctataagtgaggaagagtttatggcaaagatttttggcactttgttttcaagatggtgttatcttttgaattcttgataaatgactgtttttttctgcctaatagtaactggtta

SEQ ID NO: 190 - DNA, 517 bp, Homo sapiens
ttctctcgtgggtaacgctgtagccaggcaggaccagcctcttctgggagacccctctccccacgtagggtttgtgtagtgctcccacatcctgcttattgcctgccacccctgcttctcgcctggacctcttggtattccgtgtacaccatccttgctgtttcttgcctctgtgccttcaacctgctgctcctggcctgggataccttttattttcttttatttcttcttccttttttttttttttttttttttttaacctacaactagctctcagttcaggcactgtctaaagccccaggctgggttaggtggtctaggataccaactccccctcaacattttaccttaatccaacagtacagtaattagccgaaacttgcctggtttttcctactagactgtaagccctctagggacagggacagtgtcttattcatctctgtgttcttagtgcagagcctggcccgctgttggtgtttaataaagtgtgttgatctgaaatgccccagaccaa

SEQ ID NO: 191 - DNA, 358 bp, Homo sapiens
gctgcacagacgtgctcagcagggctacaggtgctcaagccctattggggatgggtggggagtggggcagcggcgtttgccaccttaagaattggggccaaagccactgatgtttatttgacagtgacactgcactgggtacttaaagaaattatttcccgttgtaattataattactgcttattaaggaaaatatgggaattttagaaagaatcaagtttgccacccaaatgctaccactgttaatcttttggtgttaaatgttccccctagacatttctgtgcatagatttttggtgtgtttacatagtcgttattctgtatatacaattttatgtcccttttgtacttaacgtat

SEQ ID NO: 192 - DNA, 573 bp, Homo sapiens
gttaacacgtattctcatggtgagggaggtacatgaagaacttgccaaagccaaatctgaagactctgatgttgaattatcagattaaaacggaagtgaggttcttattttcatacatattggtatgcaccaaactgtgaatgcatccagctgttggaaaatgatgtataagtctaagtcctcttgacttgaccataagatcatggaaaacagatgacttgtgaaccccacagtgtggatgtgcaaatgaaaattgaaggaaagaatatgaactgagaaatgttctttggcagtgatatagttcttagacatcttcagaatgactaatttctccgagtggtgcataatcttattttgtttgggagtaacaaatcgtggaatatttttaaggaaaactgttgtataaaactttaccatagtaaccttagaccttagagaggtagctttggagtgaaactttggctgcaataggctactttggcaagccctccgtaaaagtcagaggagagatcagtacagagctaagagtgacatcaaatgaggactgtgggacccagatttgaagacccaata

SEQ ID NO: 193 - DNA, 409 bp, Homo sapiens
gtagatcccttcagttcaaaacataatgtgattgtgggcagaaatggatctggaaaaagtaactttttttatgcaattcagtttgttctcagtgatgagtttagtcatcttcgtccagaacagcggttggctttattgcatgaaggtactggtcctcgtgttatttctgcttttgtggagattatttttgataattcagacaaccggttaccaatcgataaagaggaagtttcacttcgaagagttattggtgccaaaaaggatcagtatttcttagacaagaagatggtcacgaaaaatgatgtgatgaacctccttgaaagcgctggtttttctcgaagcaatccttattatattgttaaacaaggaaagatcaaccagatggcaacagcaccagattctcagagat

SEQ ID NO: 194 - DNA, 534 bp, Homo sapiens
gacatctcctcatgtaattcaggcagttatgggagccctagagggcctgagagttgctattggaccatgtagaatgttgcaatattgtttacagggtctgtttcacccagcccggaaagtcagagatgtatattggaaaatttacaactccatctacattggttcccaggacgctctcatagcacattacccaagaatctacaacgatgataagaacacctatattcgttatgaacttgactatatcttataattttattgtttattttgtgtttaatgcacagctacttcacaccttaaacttgctttgatttggtgatgtaaacttttaaacattgcagttcagtgtagaactggtcatagaggaagagctagaaatccagtagcatgatttttaaataacctgtctttgtttttgatgttaaacagtaaatgccagtagtgaccaagaacacagtgattatatacactatactggagggatttcatttttaattcatctttatgaagatttagaactcattccttgtgttt

SEQ ID NO: 195 - DNA, 455 bp, Homo sapiens
atctgattccagaattgccctgaagtctggctatggaaaatatcttggtataaattcagatggacttgttgttgggcgttcagatgcaattggaccaagagaacaatgggaaccagtctttcaaaatgggaaaatggctttgttggcctcaaatagctgctttattagatgcaatgaagcaggggacatagaagcaaaaagtaaaacagcaggagaagaagaaatgatcaagattagatcctgtgctgaaagagaaaccaagaaaaaagatgacattccagaagaagacaaaggaaatgtaaaacaatgtgaaatcaattatgtaaagaaatttcagagcttccaagaccacaaacttaaaataagtaaagaagacagtaaaattcttaaaaaggctcggaaagatggatttttgcatgagacgcttctggacaggagagccaaattgaaagccg

SEQ ID NO: 196 - DNA, 522 bp, Homo sapiens
gaccttgttgcccttgaaacttgaaaatagggattctggggtgaggatacaaagacattgtcttgcatatccataagcaggtcttagagcattattccaaactctagctgtttcagtagttctatgaggattgcaagtcataggtgtgtgtggcatatcagtccatctccctcatctccattctcagtttcttccccacaaaatttggaatcaaagcttttatgacgtttgccaattgcagaacttcttcagctaaggttaatttgacgctatgataaaactgagagatgtcaaaaagcctcttagaaattttaatcttgaaagacttttcagggtatctcattttttaggtgggggtggcaggtgtatttcttttttaacaaataaaaggcatttaagtaaaactaaaatgaaaaaagtaggccttctgacattgtgtacttggtggttctgtccctctgcctgtaacaaatctcatttttgttaccaagaactgtatgaaagaagtaaatccaccccgat

SEQ ID NO: 197 - DNA, 225 bp, Homo sapiens
acaaggtatatttctctcacataacccaccccaccatttatatcactcaacttgagttatggaaattatcacttctgtatcccttctgtggattgttcattatgtcgttttgtaatttgagagattttccccctcaacaagaaaacatcgattattttccctggttttaaatgtgatatgtgctcagtgcaaaaatttccagggtttgaagctgaatttactagt

SEQ ID NO: 198 - DNA, 570 bp, Homo sapiens
ccttcgcaacgttgactgtctttagctttctaatagaagtttaagaaaagtttccgtttgcacaagaaaataacgcttgggcattaaatgaatgcctttatagatagtcacttgtttctacaattcagtatttgatgtggtcgtgtaaatatgtacaatattgtaaatacataaaaaatatacaaatttttggctgctgtgaagatgtaattttatcttttaacatttataattatatgaggaaatttgacctcagtgatcacgagaagaaagccatgaccgaccaatatgttgacatactgatcctctactctgagtggggctaaataagttattttctctgaccgcctactggaaatatttttaagtggaaccaaaataggcatccttacaaatcaggaagactgacttgacacgtttgtaaatggtagaacggtggctactgtgagtggggagcagaaccgcaccactgttatactgggataacaatttttttgagaaggataaagtggcattattttattttacaaggtgcccagatcccagttatccttgtatccatgtaatttc

SEQ ID NO: 199 - DNA, 517 bp, Homo sapiens
  misc_feature (77)..(77): n is a, c, g, or t
gtttctgggtccttgaaatcacctgttcccagatcagatattccagagcctgaaagggaacaaaaacgccgcaaaantgatactcacccttctccatcacattcctccacagtaaaggacagtctcatcgaactcaaggaatcttcagcaaagctctacattaatcatactcctccaccactgtccaagagtaaggagagagaaatggacaagaaagatttggacaagtcaagggaaagatccagagaaagagagaaaaaagatgaaaaggacaggaaagagcggaaaagggatcactcaaacaacgaccgtgaagtgccaccggacttaaccaagagacgtaaagaggagaatggaacaatgggggtttcaaaacataaaagtgaaagtccttgtgaatctccttatccaaatgagaaagacaaggaaaaaaataagtcaaaatcttcaggcaaagaaaaaggcagtgattcatttaaatctgagaagatggataaaatctcctccggtggcaaaa

SEQ ID NO: 200 - DNA, 545 bp, Homo sapiens
ttactatttgtgtcatacctgccttctaatgagaaaacgcctttacatagccttgtttcaatagtggaggagtgacccactttcttttctttccccgcacataaactttaattggttgtagccatagacacctatttgatttagcatgtgggggatagggtgcacatccatcatctgttagttgtcgtaaagatagattgtaggtagaattgaggtcccttttgtacccttcccagtgctcttcaacttctttaattagggaattaaattcacaaattcagttttcttttttttgagactgaggcttgcactccagcctgggggacagagcaagactctgtctcaaacaaaaaaaaaaaaaaggaaaagataagaaaaacaagtgtttatatgaagtattttctcagaaaaagagtaacccaaatacttttcaagtccatgtggcttgattaatctttaataaataagaatattggtgatttagtaaaaatggatattctacctagctttgttaatcaaataaactcatattatctctgttacaa

SEQ ID NO: 201 - DNA, 315 bp, Homo sapiens
ttgggctgtgttggaatgggcctgcagcccaacaaacaagggaactaggaccgacagtgacttcaccagcttgctaggtcagaatgagagactggtgggtctgtctacctgtttcttctacaagatccctatttgactgtaaaagtagctaatactcacatgttctccaatcccaggtagccatggtagagttgggtagagttgagcagccgccccaggatccaaatgtggtgtctgaaatggaaagaactaaggcaaccaggaaggcactgatctgccttataagcacagtcatctgaaagtcaggcctgctgc

SEQ ID NO: 202 - DNA, 339 bp, Homo sapiens
atgaccgtcgccgtgagagggatgaccggcgtgatctaagagaaagacgagatctaagagacgacagggaccgaagaggacctccactcagatcagaacgtgaagaagtaagttcttggagacgtgctgatgacaggaaagatgaccgggtggaagagcgggaccctcctcgtcgagttcctcccccagctctttcaagagaccgagaaagagaccgagaccgagaaagagaaggtgaaaaagagaaggcctcatggagagctgagaaagatagggaatctctccgtcgtactaaaaatgagactgatgaagatggatggaccacagtacgacgttaag

SEQ ID NO: 203 - DNA, 332 bp, Homo sapiens
gttctgacccctggaaagacaccaattggcacaccagccatgaacatggctacccctactccaggtcacataatgagtatgactcctgaacagcttcaggcttggcggtgggaaagagaaattgatgagagaaatcgcccactttctgatgaggaattagatgctatgttcccagaaggatataaggtacttcctcctccagctggttatgttcctattcgaactccagctcgaaagctgacagctactccaacacctttgggtggtatgactggtttccacatgcaaactgaagatcgaactatgaaaagtgttaatgaccagccatctgg

SEQ ID NO: 204 - DNA, 340 bp, Homo sapiens
aaaatcaacgtctcttagtggcccttagagagcttggggaaaccagagaaagagaagaacaagaaacaacttcatccaaaatcactgagcttcagctcaaacttgagagtgcccttactgaactagaacaactccgcaaatcacgacagcatcaaatgcagcttgttgattccatagttcgtcagcgtgatatgtaccgtattttattgtcacaaacaacaggagttgccattccattacatgcttcaagcttagatgatgtttctcttgcatcaactccaaaacgtccaagtacatcacagactgtttccactcctgctccagtacctgttattgaatc

SEQ ID NO: 205 - DNA, 487 bp, Homo sapiens
  misc_feature (110)..(110): n is a, c, g, or t
tacaaactaaccaaggcatcggtacattgccttgaaacaggcgaatatactcacatcaggaatatcttgattgtgctaacaaaaatacttccttggtacccaaaagtttngaatctgggtcaagcttnggaaagaagagtacacaaaatctgccaagaagaaaaagagaagaggccagatctatatgcatnggctatgggctactctgggcagttgaaaagtagaaagtcatacatgatacctgaaaatgagtttcatcacaaagacccccctccgaggaatgcagttgccagtgtgcaaaatgggcctggtggtgggccttcttcatcatcaataggaagtgcatctaaatcggatgaaagcagtactgaggagactgataaatcaagggagagatctcagtgtggtgtgaaagctgttaataaagcttctagtaccacacctaaagggaattcaagcaatggaaatagtggctctaacagcaaca

SEQ ID NO: 206 - DNA, 392 bp, Homo sapiens
  misc_feature (262)..(262): n is a, c, g, or t
cagccagtttaattgttcctttgtcatcaatcaagagattttgaggttttaagtctctgtgaagaactcttctagagtgacaaaacacaatcccctgtaggatttggtataaataactcttaacaagtgaagaatccatgtactgaccaggagggatagaatccaagtatttcttcagatccatggaaagaaactcaaagatgagatataacctggaatcctgcataagcacatcctgaagactgactatatttggatgacnaagttcctttaatagagaaatttcccgaattgcagtactaggaaccccttcctcttcactttctagtctgatttttttcatggctaccacttgacctgtagttttgtgtctacccttatacacaactcca

SEQ ID NO: 207 - DNA, 326 bp, Homo sapiens
  misc_feature (236)..(236): n is a, c, g, or t
ggcaacatggcaacaggaatggaagaggcagcaggagctacaatgcagaaaagccatggattaataggaactgaagcgccgggagccatgaagctgcaggacccatgaggcagaaaaagccatgggctagcatcgaggggggcagaaagaagttagtcagtagcagtaggaggagtataaatacagccagaaaggagttgagtcaccaatttgggaagcactagagaagggagcancagatgcctgcagctgagggggtgacaagataagccaggctctagagctgctttggatcatgaaccattttcaagtttctgttcttccat

SEQ ID NO: 208 - DNA, 448 bp, Homo sapiens
gtttacagggtctgtttcacccagcccggaaagtcagagatgtatattggaaaatttacaactccatctacattggttcccaggacgctctcatagcacattacccaagaatctacaacgatgataagaacacctatattcgttatgaacttgactatatcttataattttattgtttattttgtgtttaatgcacagctacttcacaccttaaacttgctttgatttggtgatgtaaacttttaaacattgcagatcagtgtagaactggtcatagaggaagagctagaaatccagtagcatgatttttaaataacctgtctttgtttttgatgttaaacagtaaatgccagtagtgaccaagaacacagtgattatatacactatactggagggatttcatttttaattcatctttatgaagatttagaactcattccttgtgttt

SEQ ID NO: 209 - DNA, 458 bp, Homo sapiens
ggaggatatcgaacgccaagttagagaattgaaaacaaaaatttcagctatgaaagaagaaaaagaacagcttagtgctgaaagacaagagcagattaagcagaggactaagttggagcttaaagccaaggatttacaagatgaactagcaggcaatagtgaacaaaggaaacgtttattaaaagagaggcagaagctgcttgaaaaaatagaagaaaagcagaaagaactggcagaaacagaacccaaattcaacagtgtgaaagagaaagaagaacgaggaattgctagattggctcaagctacccaggaaagaacggatctttatgcaaagcagggtcgaggaagccagtttacatcaaaagaagaaagggataagtggattaaaaaggaactcaagtctttagatcaggctattaatgacaagaaaagacagattgctgctatacataaggatt

SEQ ID NO: 210 - DNA, 535 bp, Homo sapiens
  misc_feature (425)..(425): n is a, c, g, or t
aatgctttactctgactatgtgctattgggttttatttccagaaaatatagttctccttttttctgcatgaaggatacatcgtggtgccacatgctttaagcaatttaaacaagagagataagaggaaaatgcaaccaccacatctgacttgcccaatgtagactttcctctattagattgaagtacacaacctaatatgatatattattttgtagtatctcagactttgtaaataaataccattatttttatatggaaattttatagaagagctatttctgtatacgtaattactcctgattttctgaaattgcttctggtagataacagacaagtcctaagcagtgttccactaagggtggttccaggcctgcctgccgtggagttgactgggggaattttacagttttgcgatcctaggatncgtcccagacgctcagtcagaagtgctggaggtggggcctgggaagctgtatttgtaatgaactctggtgttttttgtccattaaagtgtatctttgtccatcctataag

SEQ ID NO: 211 - DNA, 540 bp, Homo sapiens
tctttcctttcttatcaggagacaatcagcattacaacacctccttgcttgccgctgcagcagcagcagtttcagatgatcaagacctcctacactcgtctcggtttttcccgtatacctcctcacagatgtttcttgatcagttaagtgcaggaggcagtacttctctgccaaccaccaatggaagcagtagtggcagtaacagcagcctggtttcttccaacagcctaagggaaagccatagccacaccgtcacaaacaggagcagcacggacacggcatccatctttggcatcataccagacattatttcattggactgattcccaggccctgctgctcccatccccaccccagatcgaatgaacttggcagaaagaagagaactttgtgctctgttttaccttactctgtttagaaaagtatacaagcgtgttttttttcctttttttagggaaaaaattaaaagaaatgtacagagaacaaaactatattttcagttttacttttgtatataaatctaagactgcctgtgtgata

SEQ ID NO: 212 - DNA, 499 bp, Homo sapiens
aagtcgtctatttctttctagttgcatcaacttgcacactggtgtctaactatatgtggtattcggaacttgtaattcttattgagcagccattgcctatattttctcagctcctcactgatttctttatatgagctcagctgacaagcaaatgcagctattttgtttaccctctcttcataccggaccatcaacaacagtgttctaactcatccctgatggtctgtgagatgtagactattacacaagattcaagttactcgtaagcaacttttagatagagttggtcctgttaggaggagactcttgatgtcaccttcagtatcttgaaagcgggtcccctccccgaggctcttaattctttgaaaacttgatgctgtttcagctgaaaaattagcaagactgttaaaaaaaaaaagttgaggggagctgtttaagaaactgaaaagtaattgcaaactacattggataattgtgactttcagttgttgttctgtat

SEQ ID NO: 213 - DNA, 399 bp, Homo sapiens
ttcttactccataccttgttcgatatggaggacaaataattggattgtctgataagtctgccaataaactatccagaaatagcaagtgtaatagtccccactatacgaattttatggtttgtataaacactaacattttccccttctgtagttgtatgaaaaaacaaatattgttagcatagtagataaattgttatgaaataccagaaaaaaaaatctgtatcttttactgagaacacccaatacccagataaatgactgtatcaggatttcatttgcatgttagtccacagagttgcccagaaccctaaatttattcataagagaaaatattgattaattattggtcattcctcataagtgtagctgttgatgtgtgcgtctgattattgctttttt

SEQ ID NO: 214 - DNA, 396 bp, Homo sapiens
  misc_feature (71)..(74): n is a, c, g, or t
tggatgggctgagactcctcgaacagatcgaggtggagattctattggtgaaacaccgactcctggagccnnnnanngnnnnnnacggtgggatgaaacaccagctagtcagatgggtggaagcactccagttctgacccctggaaagacaccaattggcacaccagccatgaacatggctacccctactccaggtcacataatgagtatgactcctgaacagcttcaggcttggcggtgggaaagagaaattgatgagagaaatcgcccactttctgatgaggaattagatgctatgttcccagaaggatataaggtacttcctcctccagctggttatgttcctattcgaactccagctcgaaagctgacagctactccaacacctttgggtgg

SEQ ID NO: 215 - DNA, 500 bp, Homo sapiens
  misc_feature (446)..(446): n is a, c, g, or t
ttaatagctgacctcccaaatctgacaggatagacactgccacgtgcaaggcctgccagcccctcagacgcacaaaatgcgtaaaacaaatgcatcctttcctggctaagcgagtattactctcttagccctgcaccaaacctccaatctagccacatttaactcttcatttcttagacccgcagagtgtcttcctgcctctgagctgtgagtgttgttccctttgcccgggatgctcttgtttttaataccagttcaagtcccactctctcagtgaagcactcccttccccactatagcctttagtgaaccctcgtttcttgcttctttattatctgtactgttgtccacttggcaattgttcaggcctctgtgttgttactgatttttgtatgtatatatatatatatgtcttgtttttccaactagattgtgagctccttaanggcagagccatgaattatacctctttgtatccccagtgccttgcatacagtaag

SEQ ID NO: 216 - DNA, 515 bp, Homo sapiens
  misc_feature (82)..(82): n is a, c, g, or t
agtggttttggtcatgtgtccacaggagaaactaaccattcagttgtcttaattttagttcgttctaccctgtgaggagttngtttccatcagttgttgactttccaaaatgttgcattaagtaatagttgtcactctgttggtctcatggtcaatatcaatcagactttcatgatctctactaattattagtagagtcctgtactatgtctgtaactactaagtttaaagaaaagcacatagtcacttcatctctttttttcttagcctacgctcactccccaacccatcccaacattgacatgctatctgtggacaaatagcagttctcagaatctagtcaagttgccatcatcccccttgccttggccgttcatagtaggtatgcatatgtttgtttctgtacagtactgtgtgtgtgtgtgtatatatatatacatctgtatgcacacatctttgataaaatagctatttgactagcagggttaaagtggcttttaattacttcgtgagtg

SEQ ID NO: 217 - DNA, 545 bp, Homo sapiens
  misc_feature (27)..(27): n is a, c, g, or t
gaaaaatcggattctttggcagatttncntttgagtcaagtgtctgaaatggagtgaaaatatatcctaactaaattaatgtggaaagagcatttttttagacaatttcaattttaaacacataaaactttcaagatcttcaggactttttaaagcacatttgaaattattttagtaagaattttgttttatcaatagatgttgaattctgttttttaattaaatacaaagcttagatttcagaaagagagggaaaatagctggtggtcccagagtgtgctgctgttaattgtttaacaaaggggaaaatgtacataaacagataaagttaccataaattccatgaacttaaatctgtgattcattgccttaaaactttctctcttagaatttccataccgcatgccaaaccagtaaaatggcttttaaaaatgtatagtagacaatgtcagtttgtataaaagtaccaagtgaaaatatttattacatgcattggaaaaaaattgtttacctattgaatgttacctgtttatgtagagctcttt